(19) United States
(12) Patent Application Publication
(10) Pub. No.: US 2026/0238781 A1
(43) Pub. Date: Aug. 13, 2026

(54) CODING METHODS, APPARATUSES, AND STORAGE MEDIUMS USINGTEMPLATE-BASED CODING AND ADAPTIVE FILTERING

(71) Applicant: BEIJING DAJIA INTERNET INFORMATION TECHNOLOGY CO., LTD., Beijing (CN)

(72) Inventors: Xiaoyu XIU, San Diego, CA (US); Hong-Jheng JHU, San Diego, CA (US); Che-Wei KUO, San Diego, CA (US); Changyue MA, San Diego, CA (US); Ning YAN, San Diego, CA (US); Wei CHEN, San Diego, CA (US); Xianglin WANG, San Diego, CA (US); Bing YU, Beijing (CN); Qi HUANG, Beijing (CN)

(73) Assignee: BEIJING DAJIA INTERNET INFORMATION TECHNOLOGY CO., LTD., Beijing (CN)

(21) Appl. No.: 19/638,721

(22) Filed: Apr. 3, 2026

Related U.S. Application Data
(63) Continuation of application No. PCT/US2024/048914, filed on Sep. 27, 2024.
Application No. PCT/US2024/048914 is a continuation-in-part of application No. PCT/US2024/036027, filed on Jun. 28, 2024.
(63) Continuation of application No. PCT/US2024/049996, filed on Oct. 4, 2024.
(60) Provisional application No. 63/524,335, filed on Jun. 30, 2023.
(60) Provisional application No. 63/542,153, filed on Oct. 3, 2023.
(60) Provisional application No. 63/542,518, filed on Oct. 4, 2023.
(60) Provisional application No. 63/609,272, filed on Dec. 12, 2023.

(51) Int. Cl. H04N 19/117; H04N 19/105; H04N 19/176; H04N 19/70; H04N 19/80

(52) U.S. Cl. CPC H04N 19/117; H04N 19/105; H04N 19/176; H04N 19/70; H04N 19/80

(57) ABSTRACT

A method for video encoding, a method for video decoding, and apparatuses thereof are provided. A template-based coding scheme is applied to derive one or more coding parameters associated with a video block from a video frame based on a template of the video block. Reference-picture-resampling (RPR) prediction samples for the video block are generated based on the one or more coding parameters. The RPR prediction samples are filtered by using a filter to generate filtered RPR prediction samples for the video block. The filter is adaptively determined based on the template of the video block.

### CROSS-REFERENCE TO RELATED APPLICATIONS

This application claims priority to and the benefit of PCT Application No. PCT/US2024/048914 filed on Sep. 27, 2024, which is based upon and claims priority to U.S. Provisional Application No. 63/524,153 filed Oct. 3, 2023. PCT/US2024/048914 is also a continuation-in-part of PCT Application No. PCT/US2024/036027, filed Jun. 28, 2024, which further claims priority to U.S. Provisional Application No. 63/524,335 filed Jun. 30, 2023. This application further claims priority to and the benefit of PCT Application No. PCT/US2024/049996 filed on Oct. 4, 2024, which is based upon and claims priority to U.S. Provisional Application No. 63/542,518, filed on Oct. 4, 2023, and U.S. Provisional Application No. 63/609,272, filed on Dec. 12, 2023. The contents of all above applications are incorporated herein by reference in their entireties for all purposes.

### TECHNICAL FIELD

This application is related to video coding and compression. More specifically, this application relates to video processing apparatuses and methods for video coding.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Implementations of the present disclosure provide a method for video decoding. The method may include applying, by a decoder, a template-based coding scheme to derive one or more coding parameters associated with a video block from a video frame based on a template of the video block. The method may also include obtaining, by the decoder, reference-picture-resampling (RPR) prediction samples for the video block based on the one or more coding parameters. The method may further include filtering, by the decoder, the RPR prediction samples by using a filter to generate filtered RPR prediction samples for the video block. The filter is adaptively determined based on the template of the video block.

Implementations of the present disclosure provide a method for video encoding. The method may include obtaining, by an encoder, RPR prediction samples for a video block from a video frame based on one or more coding parameters. The method may also include filtering, by the encoder, the RPR prediction samples by using a filter to generate filtered RPR prediction samples for the video block. The filter is adaptively determined based on the template of the video block. The method may also include processing, by the encoder, the one or more coding parameters using a template-based coding scheme to generate one or more syntax elements based on the template of the video block. The method may further include generating, by the encoder, a bitstream based on the filtered RPR prediction samples and the one or more syntax elements.

Implementations of the present disclosure also provide an apparatus for video coding. The apparatus may include a memory configured to store a bitstream and a processor coupled to the memory. The processor may be configured to perform a method for video decoding and video encoding disclosed herein.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIG. 4A is a block diagram illustrating how a frame is recursively partitioned into multiple video blocks of different sizes and shapes in accordance with some implementations of the present disclosure.

FIG. 4B is a block diagram illustrating how a frame is recursively partitioned into multiple video blocks of different sizes and shapes in accordance with some implementations of the present disclosure.

FIG. 4C is a block diagram illustrating how a frame is recursively partitioned into multiple video blocks of different sizes and shapes in accordance with some implementations of the present disclosure.

FIG. 4D is a block diagram illustrating how a frame is recursively partitioned into multiple video blocks of different sizes and shapes in accordance with some implementations of the present disclosure.

FIG. 4E is a block diagram illustrating how a frame is recursively partitioned into multiple video blocks of different sizes and shapes in accordance with some implementations of the present disclosure.

FIG. 5 illustrates positions of spatial neighbors for a merge mode in accordance with some implementations of the present disclosure.

FIG. 6 illustrates candidate pairs for redundancy check in accordance with some implementations of the present disclosure.

FIG. 7A illustrates a temporal motion vector predictor (TMVP) derivation process in accordance with some implementations of the present disclosure.

FIG. 7B illustrates a diagram of candidate positions for a temporal candidate in accordance with some implementations of the present disclosure.

FIG. 8 illustrates example template-based coding schemes in accordance with some implementations of the present disclosure.

FIG. 9 illustrates a process of adaptive filtering for the RPR in accordance with some implementations of the present disclosure.

FIG. 10 illustrates a generation of prediction template samples for the RPR in accordance with some implementations of the present disclosure.

FIG. 11 is a flow chart of an exemplary method for video coding based on template-based coding schemes in accordance with some implementations of the present disclosure.

FIG. 12A shows a flow chart of an exemplary method for video encoding based on template-based coding schemes in accordance with some implementations of the present disclosure.

FIG. 12B shows a flow chart of an exemplary method for video encoding based on template-based coding schemes in accordance with some implementations of the present disclosure.

FIG. 13 shows a flow chart of an exemplary method for video decoding based on template-based coding schemes in accordance with some implementations of the present disclosure.

FIG. 14 illustrates uni-prediction motion vector (MV) selection according to a merge index of a Geometry Partition Mode (GPM) in accordance with some implementations of the present disclosure.

FIG. 15 shows a flow chart of another exemplary method for video encoding in accordance with some implementations of the present disclosure.

FIG. 16 shows a flow chart of another exemplary method for video decoding in accordance with some implementations of the present disclosure.

FIG. 17 shows one example where dₓ and d_{y} are the horizontal and vertical values of the MV in accordance with some examples of the present disclosure.

FIG. 18 shows an example where one MV has one fractional value and interpolation filters are applied to generate the corresponding prediction samples at fractional sample positions in accordance with some examples of the present disclosure.

FIG. 19A shows an example of a diamond filter shape in accordance with some examples of the present disclosure.

FIG. 19B shows an example of a diamond filter shape in accordance with some examples of the present disclosure.

FIG. 20 shows a subsampled 1-D Laplacian calculation applied for gradient calculations in all the directions in accordance with some examples of the present disclosure.

FIG. 21 is a diagram illustrating local illumination compensation (LIC) for uni-prediction in accordance with some examples of the present disclosure.

FIG. 22A is a diagram illustrating the generation of the LIC template prediction samples for affine mode in accordance with some examples of the present disclosure

FIG. 22B is a diagram illustrating the generation of the LIC template prediction samples for affine mode in accordance with some examples of the present disclosure.

FIG. 23 is a block diagram of video encoding with the adaptive filtering for bi-prediction in accordance with some examples of the present disclosure.

FIG. 24 is a block diagram of video decoding with the adaptive filtering for bi-prediction in accordance with some examples of the present disclosure.

FIG. 25 is a diagram illustrating the adaptive motion compensated filtering based on the bi-prediction samples of template in accordance with some examples of the present disclosure.

FIG. 26 is a diagram illustrating the adaptive motion compensated filtering based on the uni-prediction samples of template in accordance with some examples of the present disclosure.

FIG. 27 is a diagram illustrating of the OBMC process for the CUs that are coded without sub-block motion compensation in accordance with some examples of the present disclosure.

FIG. 28 is a diagram illustrating of the OBMC process for the CUs that are coded by sub-block modes in accordance with some examples of the present disclosure.

FIG. 29 is a diagram illustrating of the template-based OBMC in accordance with some examples of the present disclosure.

FIG. 30A is a diagram illustrating of different sizes of non-adjacent neighbor blocks in accordance with some examples of the present disclosure.

FIG. 30B is a diagram illustrating of different sizes of non-adjacent neighbor blocks in accordance with some examples of the present disclosure.

FIG. 31 is a diagram illustrating the template and its corresponding reference samples used for the cost calculation of the non-subblock merge mode in the ARMC in accordance with some examples of the present disclosure.

FIG. 32 is a diagram illustrating the template and its corresponding reference samples used for the cost calculation of the subblock merge mode in the ARMC in accordance with some examples of the present disclosure.

FIG. 33 is a diagram illustrating refinement positions along k×π/8 diagonal angles (reflected by dots with three different patterns) around one base candidate (reflected by the star in the center) in accordance with some examples of the present disclosure.

FIG. 34 is a diagram illustrating that adaptive MC filtering is applied at the generation of the prediction samples of the current block but bypassed at the calculation of the template costs for different merge/MMVD candidates in accordance with some examples of the present disclosure.

FIG. 35 is a diagram illustrating that adaptive MC filtering is applied both at the generation of the prediction samples of the current block and the calculation of the template costs for different merge/MMVD candidates in accordance with some examples of the present disclosure.

FIG. 36 is a diagram illustrating Merge candidate selection for AMVP-merge mode when there is at least one merge candidate is associated with adaptive motion compensated filtering in accordance with some examples of the present disclosure.

FIG. 37A is a diagram illustrating selected samples for the derivation of the adaptive filter coefficients for adjacent/non-adjacent inter CUs in accordance with some examples of the present disclosure.

FIG. 37B is a diagram illustrating selected samples for the derivation of the adaptive filter coefficients for adjacent/non-adjacent inter CUs in accordance with some examples of the present disclosure.

FIG. 37C is a diagram illustrating selected samples for the derivation of the adaptive filter coefficients for adjacent/non-adjacent inter CUs in accordance with some examples of the present disclosure.

FIG. 38 is a flowchart illustrating a method for video decoding in accordance with some examples of the present disclosure.

FIG. 39 is a flowchart illustrating a method for video decoding in accordance with some examples of the present disclosure.

FIG. 40 is a flowchart illustrating a method for video decoding in accordance with some examples of the present disclosure.

FIG. 41 is a flowchart illustrating a method for video decoding in accordance with some examples of the present disclosure.

FIG. 42 is a flowchart illustrating a method for video decoding in accordance with some examples of the present disclosure.

FIG. 43 is a flowchart illustrating a method for video encoding in accordance with some examples of the present disclosure.

FIG. 44 is a flowchart illustrating a method for video encoding in accordance with some examples of the present disclosure.

FIG. 45 is a flowchart illustrating a method for video encoding in accordance with some examples of the present disclosure.

FIG. 46 is a flowchart illustrating a method for video encoding in accordance with some examples of the present disclosure.

FIG. 47 is a flowchart illustrating a method for video encoding in accordance with some examples of the present disclosure.

FIG. 48 is a diagram illustrating a computing environment coupled with a user interface, according to some implementations of the present disclosure.

FIG. 49 is a block diagram of an encoder in accordance with some examples of the present disclosure.

FIG. 50 is a block diagram illustrating an exemplary video encoder in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may include steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

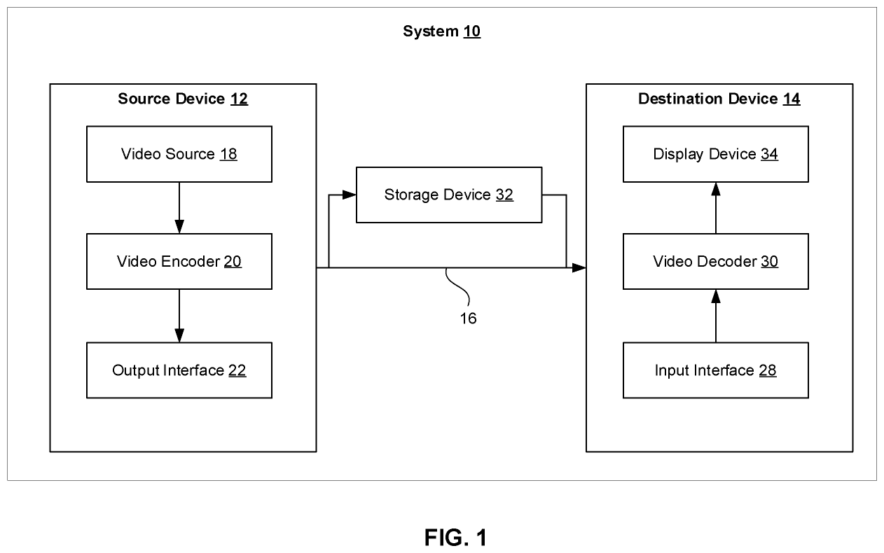

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter. The encoded video data may comprise a sequence of pictures, each of which may comprise one or more sample arrays, for example, luma (Y) only for monochrome; luma and two chroma in YCbCr or YCgCo domain; or green, blue, and red in GBR (also known as RGB) domain. For convenience of notation and terminology in this application, in some embodiments, variables and terms associated with each set of three sample arrays may be referred to as luma and chroma, where the two chroma arrays may be referred to as Cb and Cr, regardless of the actual color representation method in use. The video data may be in a chroma format of 4:0:0, 4:2:0, 4:2:2, or 4:4:4, but the present application is not limited thereto.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

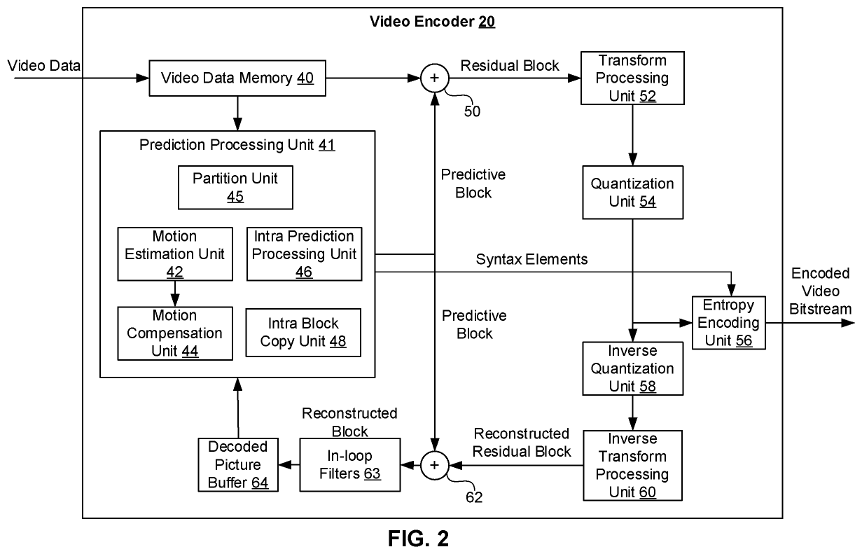

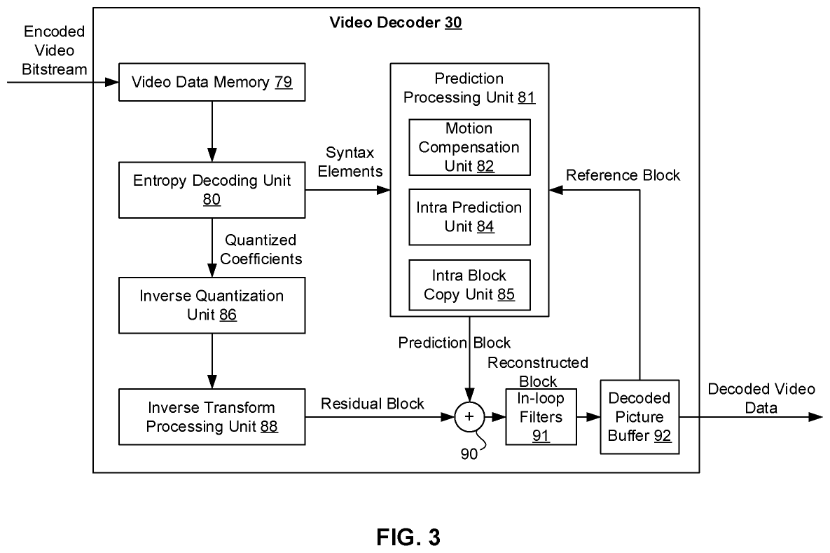

In some implementations, at least a part of components of the source device 12 (for example, the video source 18, the video encoder 20 or components included in the video encoder 20 as described below with reference to FIG. 2, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component and two chroma components (which may represent Y, Cb and Cr in YCbCr domain; Y, Cg and Co in YCgCo domain; or G, B and R in RGB domain for convenience of notation and terminology in this application as described above) according to any other of the luma component and the two chroma components to modify said any component based on the selected offset. Further, it should also be illustrated that a first component mentioned herein may be any of the luma component and the two chroma components, a second component mentioned herein may be any other of the luma component and the two chroma components, and a third component mentioned herein may be a remaining one of the luma component and the two chroma components. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In the current VVC and AVS3 standards, motion information of the current coding block is either copied from spatial or temporal neighboring blocks specified by a merge candidate index or obtained by explicit signaling of motion estimation. The focus of the present disclosure is to improve the accuracy of the motion vectors for affine merge mode by improving the derivation methods of affine merge candidates. To facilitate the description of the present disclosure, the existing affine merge mode design in the VVC standard is used as an example to illustrate the proposed ideas. Please note that though the existing affine mode design in the VVC standard is used as the example throughout the present disclosure, to a person skilled in the art of modern video coding technologies, the proposed technologies can also be applied to a different design of affine motion prediction mode or other coding tools with the same or similar design spirit.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

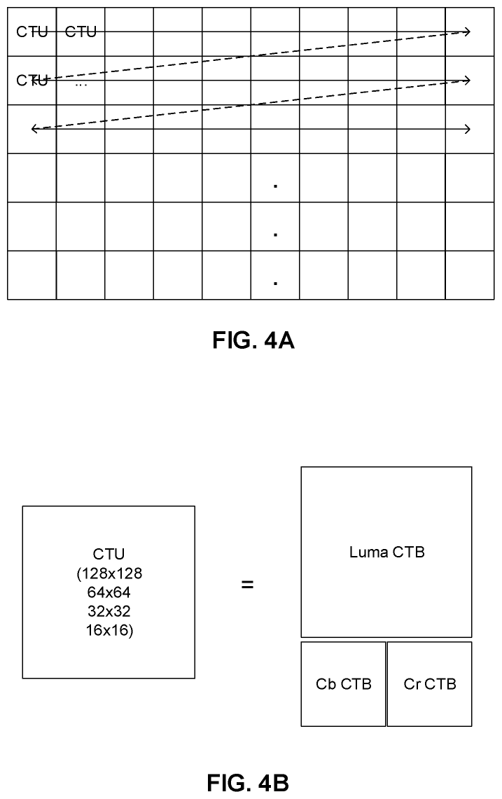

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

A brief description of an inter advanced motion vector prediction (AMVP) mode is provided herein. In general, the motion information signaling in the VVC and the ECM is kept the same as that in the HEVC standard. Specifically, an inter prediction syntax, i.e., inter_pred_idc, is signaled to indicate whether the prediction signal is from a first reference picture list, a second reference picture, or both. The first reference picture list can be, for example, the reference frame list “List 0” (also referred to as “L0”). The second reference picture list can be, for example, the reference frame list “List 1” (also referred to as “L1”). For each used reference picture list, a corresponding reference frame is identified by signaling a reference picture index ref idx_lx (e.g., x=0, or 1) for the corresponding reference picture list. A corresponding motion vector (MV) is represented by a motion vector predictor (MVP) index mvp_lx_flag (e.g., x=0, or 1) which is used to select a MVP, followed by a motion vector difference (MVD) between the corresponding MV and the selected MVP (e.g., MVD=MV−MVP). Additionally, a control flag mvd_l1_zero_flag is signaled at a slice level. When the control flag mvd_l1_zero_flag is equal to 0, the MVD associated with the reference picture list L1 (L1 MVD) is signaled in a bitstream. Otherwise (when the control flag mvd_l1_zero_flag is equal to 1), the L1 MVD is not signaled and its value is inferred to be zero at the encoder and decoder.

A brief description of an inter merge mode is also provided herein. In the VVC, a regular inter merge candidate list is constructed by including one or more of the following five types of MVP candidates in order: (1) spatial MVPs from spatial neighbor CUs; (2) temporal MVPs from collocated CUs; (3) history-based MVPs from a first-in-first-out (FIFO) table; (4) pairwise average MVPs; or (5) zero MVPs. For each CU coded in the merge mode, an index of the best merge candidate is transmitted from the encoder to the decoder.

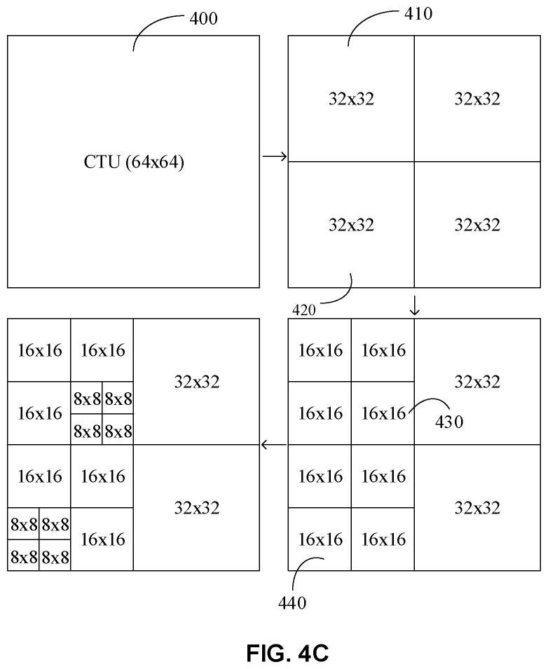

In some implementations, the derivation of MVPs from spatial candidates (for example, CUs neighboring a current CU 501 in FIG. 5) in VVC is the same as that in HEVC except that positions of the first two spatial candidates are swapped. A maximum of four spatial candidates are selected from spatial candidates located at positions depicted in FIG. 5, including a top position B0, a left position A0, a top-right position B1, a bottom-left position A1, and a top-left position B2. The derivation is performed in an order of CUs at the positions B0, A0, B1, A1, and B2 subsequently. A CU at the position B2 is considered only when one or more CUs at the positions B0, A0, B1, and A1 are not available (for example, the one or more CUs belonging to other slices or tiles and therefore being unavailable) or are intra coded.

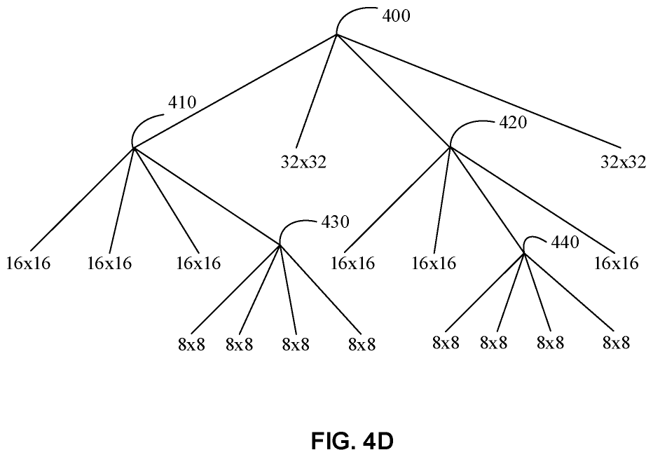

After a CU at the position B0 is added as a candidate to a merge candidate list, the addition of the remaining candidates to the merge candidate list is subject to redundancy check, which ensures that candidates with the same motion information are excluded from the merge candidate list to improve coding efficiency. To reduce computational complexity, not all possible candidate pairs are considered in the redundancy check. Instead, only pairs linked using a line with an arrow in FIG. 6 are considered. For a candidate pair including a first candidate already added to the merge candidate list and a second candidate not added to the merge candidate list yet, the second candidate is added to the merge candidate list only if the first candidate in the pair used for the redundancy check does not have the same motion information as that of the second candidate. Spatial MVPs derived from the candidates in the merge candidate list are added to an MVP candidate list.

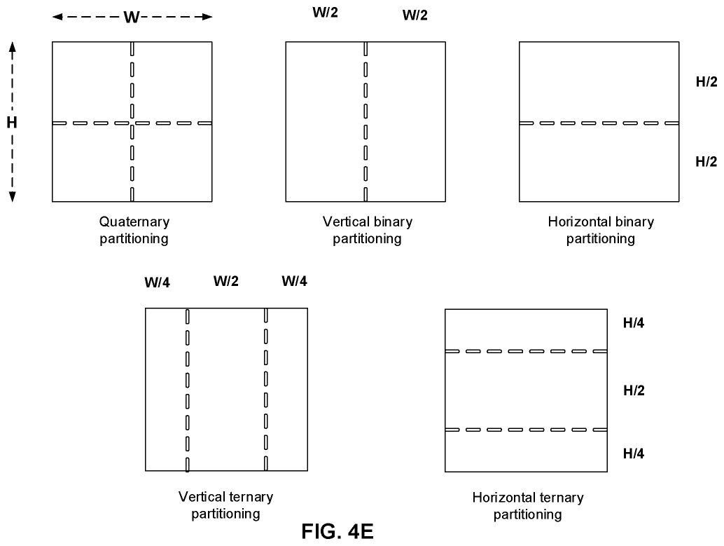

In some implementations, during the derivation of MVPs from temporal candidates, only one temporal candidate is added to the merge candidate list. Particularly, in the derivation of an MVP from this temporal candidate, a scaled motion vector is derived based on a collocated CU (e.g., col_CU 701 in FIG. 7A) because the temporal candidate belongs to a collocated picture (e.g., col_pic 702 in FIG. 7A) for a current CU (e.g., curr_CU 703 in FIG. 7A). The scaled motion vector is added as a temporal MVP candidate to the MVP candidate list. A reference picture list and a reference picture index to be used for the derivation of the collocated CU are explicitly signaled in a slice header. The scaled motion vector is obtained (i.e., scaled) from a motion vector of the collocated CU using Picture Order Count (POC) distances, i.e., tb and td, as illustrated in FIG. 7A, where tb denotes a POC difference between a reference picture (e.g., curr_ref 705 in FIG. 7A) of the current picture (e.g., curr_pic 704 in FIG. 7A) and the current picture, and td denotes a POC difference between a reference picture (e.g., col_ref 706 in FIG. 7A) of the collocated picture (e.g., col_pic 702) and the collocated picture. A reference picture index of the temporal candidate is set to be equal to zero.

A position for the temporal candidate (i.e., the collocated CU) in the current CU 703 is selected between positions C₀ and C₁, as depicted in FIG. 7B. If a CU at the position C₀ in the collocated picture is not available, or is intra coded, or is outside of the current row of CTUs, a CU at the position C₁ in the collocated picture is used as the collocated CU for the derivation of the temporal MVP candidate. Otherwise, a CU at the position C₀ in the collocated picture is used as the collocated CU for the derivation of the temporal MVP candidate.

A brief description of a Geometry Partition Mode (GPM) is provided herein. In VVC, the GPM is supported for inter prediction. The GPM is signaled using a CU-level flag as a type of merge mode. Other merge modes may include the regular merge mode, the MMVD mode, the CIP mode, and the subblock merge mode. A total number of 64 partitions are supported by the GPM for each possible CU size W×H (e.g., W=2m, H=2n, with m, n∈{3, 4, 5, 6}) excluding 8×64 and 64×8.

When the GPM is used, a CU is split into two parts (e.g., two partitions) by a geometrically located straight line (e.g., a splitting line). The position of the splitting line is mathematically derived from angle and offset parameters of a specific partition. Each part of the CU obtained by the geometrical partitioning is inter-predicted using its own motion vector, and only uni-prediction is allowed for each partition. That is, a uni-prediction motion constraint is applied such that each part has one motion vector and one reference index. The uni-prediction motion constraint is applied to ensure that only two motion-compensated predictions are needed for each CU, like that of the bi-prediction method.

If the GPM is used for the current CU, then a geometric partition index indicating a partition mode of the geometric partitioning (e.g., indicating an angle and an offset of the geometric partitioning) is signaled. The partition mode may also be referred to as a split mode herein. Two merge indices (one merge index for each partition) are further signaled.

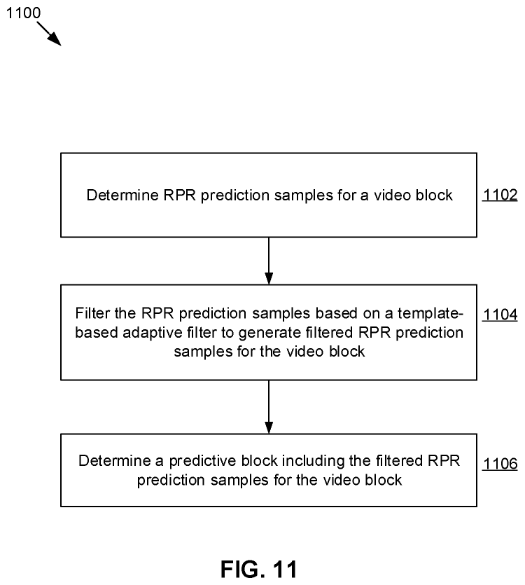

A uni-prediction candidate list is derived directly from a merge candidate list constructed according to the extended merge prediction process described above. Using n as an index of a uni-prediction motion vector in the uni-prediction candidate list, an LX motion vector of an n^{th} merge candidate in the merge candidate list is used as the n^{th} uni-prediction motion vector for the GPM (e.g., X being equal to a parity of n, X=0 when the parity of n is even (e.g., LX=L0), X=1 when the parity of n is odd (e.g., LX=L1)). These uni-prediction motion vectors for the GPM are marked with “x” in FIG. 14. In a case that a corresponding LXmotion vector of the n^{th} merge candidate in the merge candidate list does not exist, an L(1−X) motion vector of the same n^{th} merge candidate is used as the n^{th} uni-prediction motion vector for the GPM.

A brief description of reference picture resampling (RPR) is also provided herein. The VVC standard and the emerging ECM standard support fast spatial resolution switching within one bitstream. Such capability is referred to as RPR or adaptive resolution switch (ARC). In real-time video applications, allowing the resolution to be changed within a coded video sequence without the requirement of inserting a picture that supports random access, or Intra Random Access Point (IRAP) picture (e.g., an IDR picture, or an CRA picture etc.), can not only adapt the compressed video data to dynamic communication channel conditions, but also avoid the burst of bandwidth consumption due to the relatively large size of IDR or CRA pictures.

RPR high-level signaling is also provided herein. For example, according to an example RPR design, in the sequence parameter set (SPS), two syntax elements pic_width_max_in_luma_samples and pic_height_max_in_luma_samples are signaled to specify the maximum width and the maximum height of the coded pictures that refer to the SPS. Then, when the picture resolution is changed, a new picture parameter set (PPS) needs to be set when the related syntax elements pic_width_in_luma_samples and pic_height_in_luma_samples are signaled to specify the different picture resolutions of the pictures referring to the PPS. There is bitstream conformance such that the values of pic_width_in_luma_sample and pic_height_in_luma_sample may not exceed the values of pic_width_max_in_luma_samples and pic_height_max_in_luma_samples, respectively. The following Table 1 illustrates the RPR-related signaling in the SPS and PPS.

TABLE 1
the RPR signaling in the SPS and PPS

| | Descriptor |
|---|---|
| seq_parameter_set_rbsp( ) { | |
| ... | |
| pic_width max in luma_samples | ue(v) |
| pic_height_max_in_luma_samples | ue(v) |
| ... | |
| } | |
| | Descriptor |
| pic_parameter_set_rbsp( ) { | |
| ... | |
| pic_width_in_luma_samples | ue(v) |
| pic_height_in_luma_samples | ue(v) |
| ... | |
| } | |

A RPR process is also provided herein. Specifically, when there is a resolution change within a bitstream, a current video frame (e.g., a current picture) may be associated with one or more reference frames (e.g., reference pictures) in different sizes. According to an example RPR design, when picture resolution changes, all MVs to the current picture are normalized to the sample grid of the current picture instead of that of the reference pictures. This can make picture resolution changes transparent to the MV prediction process.

When the picture resolution changes, the MVs are scaled according to a resolution ratio between the current picture and the corresponding reference pictures. Additionally, the samples in a reference block (from the corresponding reference picture) associated with a current video block are up-sampled or down-sampled during the motion compensation of the current video block to generate a predictive block for the video block. In the VVC, a scaling ratio between the width of the reference picture and the width of the current picture and/or a scaling ratio between the height of the reference picture and the height of the current picture can be limited to a range of [1/8, 2].

In the example RPR design, different interpolation filters can be applied to interpolate reference samples when the current picture and its reference picture are in different resolutions. The reference samples may be samples in the reference picture. Specifically, when the resolution of the reference picture is equal to or smaller than that of the current picture, default 8-tap or 6-tap interpolation filters can be used to generate luma prediction samples of regular inter blocks and affine blocks, respectively, and default 4-tap interpolation filters can be used to generate chroma prediction samples of both regular inter blocks and affine blocks, as shown in Table 2 to Table 4 described below. However, the default motion interpolation filters do not present strong low-pass characteristics. When the resolution of the reference picture is higher than that of the current picture, using the default motion interpolation filters may lead to non-negligible aliasing, which becomes more severe when the down-sampling ratio is increased. Correspondingly, to improve the inter prediction efficiency of the RPR, different down-sampling filters can be applied when the reference picture has a higher resolution than that of the current picture. For instance, when the down-sampling ratio is equal to or greater than 1.5:1, corresponding 8-tap, 6-tap and 4-tap down-sampling filters as shown in Table 5 to Table 7 below can be used to generate the corresponding luma and chroma prediction samples of regular inter blocks and affine blocks.

TABLE 2
the RPR up-sampling filters used
for luma prediction of regular inter blocks

| Fractional | interpolation filter coefficients | | | | | | | |
|---|---|---|---|---|---|---|---|---|
| position | P0 | P1 | P2 | P3 | P4 | P5 | P6 | P7 |
| 1 | 0 | 1 | −3 | 63 | 4 | −2 | 1 | 0 |
| 2 | −1 | 2 | −5 | 62 | 8 | −3 | 1 | 0 |
| 3 | −1 | 3 | −8 | 60 | 13 | −4 | 1 | 0 |
| 4 | −1 | 4 | −10 | 58 | 17 | −5 | 1 | 0 |
| 5 | −1 | 4 | −11 | 52 | 26 | −8 | 3 | −1 |
| 6 | −1 | 3 | −9 | 47 | 31 | −10 | 4 | −1 |
| 7 | −1 | 4 | −11 | 45 | 34 | −10 | 4 | −1 |
| 8 | −1 | 4 | −11 | 40 | 40 | −11 | 4 | −1 |
| 9 | −1 | 4 | −10 | 34 | 45 | −11 | 4 | −1 |
| 10 | −1 | 4 | −10 | 31 | 47 | −9 | 3 | −1 |
| 11 | −1 | 3 | −8 | 26 | 52 | −11 | 4 | −1 |
| 12 | 0 | 1 | −5 | 17 | 58 | −10 | 4 | −1 |
| 13 | 0 | 1 | −4 | 13 | 60 | −8 | 3 | −1 |
| 14 | 0 | 1 | −3 | 8 | 62 | −5 | 2 | −1 |
| 15 | 0 | 1 | −2 | 4 | 63 | −3 | 1 | 0 |

TABLE 3
the RPR up-sampling filters used
for luma prediction of affine blocks

| Fractional | interpolation filter coefficients | | | | | |
|---|---|---|---|---|---|---|
| position | P0 | P1 | P2 | P3 | P4 | P5 |
| 1 | 1 | −3 | 63 | 4 | −2 | 1 |
| 2 | 1 | −5 | 62 | 8 | −3 | 1 |
| 3 | 2 | −8 | 60 | 13 | −4 | 1 |
| 4 | 3 | −10 | 58 | 17 | −5 | 1 |
| 5 | 3 | −11 | 52 | 26 | −8 | 2 |
| 6 | 2 | −9 | 47 | 31 | −10 | 3 |
| 7 | 3 | −11 | 45 | 34 | −10 | 3 |
| 8 | 3 | −11 | 40 | 40 | −11 | 3 |
| 9 | 3 | −10 | 34 | 45 | −11 | 3 |
| 10 | 3 | −10 | 31 | 47 | −9 | 2 |
| 11 | 2 | −8 | 26 | 52 | −11 | 3 |
| 12 | 1 | −5 | 17 | 58 | −10 | 3 |
| 13 | 1 | −4 | 13 | 60 | −8 | 2 |
| 14 | 1 | −3 | 8 | 62 | −5 | 1 |
| 15 | 1 | −2 | 4 | 63 | −3 | 1 |

TABLE 4
the RPR up-sampling filters used
for chroma prediction of inter blocks

| Fractional | interpolation filter coefficients | | | |
|---|---|---|---|---|
| sample | P0 | P1 | P2 | P3 |
| 1 | −1 | 63 | 2 | 0 |
| 2 | −2 | 62 | 4 | 0 |
| 3 | −2 | 60 | 7 | −1 |
| 4 | −2 | 58 | 10 | −2 |
| 5 | −3 | 57 | 12 | −2 |
| 6 | −4 | 56 | 14 | −2 |
| 7 | −4 | 55 | 15 | −2 |
| 8 | −4 | 54 | 16 | −2 |
| 9 | −5 | 53 | 18 | −2 |
| 10 | −6 | 52 | 20 | −2 |
| 11 | −6 | 49 | 24 | −3 |
| 12 | −6 | 46 | 28 | −4 |
| 13 | −5 | 44 | 29 | −4 |
| 14 | −4 | 42 | 30 | −4 |
| 15 | −4 | 39 | 33 | −4 |
| 16 | −4 | 36 | 36 | −4 |
| 17 | −4 | 33 | 39 | −4 |
| 18 | −4 | 30 | 42 | −4 |
| 19 | −4 | 29 | 44 | −5 |
| 20 | −4 | 28 | 46 | −6 |
| 21 | −3 | 24 | 49 | −6 |
| 22 | −2 | 20 | 52 | −6 |
| 23 | −2 | 18 | 53 | −5 |
| 24 | −2 | 16 | 54 | −4 |
| 25 | −2 | 15 | 55 | −4 |
| 26 | −2 | 14 | 56 | −4 |
| 27 | −2 | 12 | 57 | −3 |
| 28 | −2 | 10 | 58 | −2 |
| 29 | −1 | 7 | 60 | −2 |
| 30 | 0 | 4 | 62 | −2 |
| 31 | 0 | 2 | 63 | −1 |

TABLE 5
the RPR down-sampling filters used for luma
prediction of regular inter blocks when down-
sampling ratio is equal to or greater than 1.5:1

| Fractional | interpolation filter coefficients | | | | | | | |
|---|---|---|---|---|---|---|---|---|
| sample | P0 | P1 | P2 | P3 | P4 | P5 | P6 | P7 |
| 0 | −1 | −5 | 17 | 42 | 17 | −5 | −1 | 0 |
| 1 | 0 | −5 | 15 | 41 | 19 | −5 | −1 | 0 |
| 2 | 0 | −5 | 13 | 40 | 21 | −4 | −1 | 0 |
| 3 | 0 | −5 | 11 | 39 | 24 | −4 | −2 | 1 |
| 4 | 0 | −5 | 9 | 38 | 26 | −3 | −2 | 1 |
| 5 | 0 | −5 | 7 | 38 | 28 | −2 | −3 | 1 |
| 6 | 1 | −5 | 5 | 36 | 30 | −1 | −3 | 1 |
| 7 | 1 | −4 | 3 | 35 | 32 | 0 | −4 | 1 |
| 8 | 1 | −4 | 2 | 33 | 33 | 2 | −4 | 1 |
| 9 | 1 | −4 | 0 | 32 | 35 | 3 | −4 | 1 |
| 10 | 1 | −3 | −1 | 30 | 36 | 5 | −5 | 1 |
| 11 | 1 | −3 | −2 | 28 | 38 | 7 | −5 | 0 |
| 12 | 1 | −2 | −3 | 26 | 38 | 9 | −5 | 0 |
| 13 | 1 | −2 | −4 | 24 | 39 | 11 | −5 | 0 |
| 14 | 0 | −1 | −4 | 21 | 40 | 13 | −5 | 0 |
| 15 | 0 | −1 | −5 | 19 | 41 | 15 | −5 | 0 |

TABLE 6
the RPR down-sampling filters used for luma
prediction of affine blocks when down-
sampling ratio is equal to or greater than 1.5:1

| Fractional | interpolation filter coefficients | | | | | |
|---|---|---|---|---|---|---|
| sample | P0 | P1 | P2 | P3 | P4 | P5 |
| 0 | −4 | 17 | 42 | 17 | −5 | −1 |
| 1 | −5 | 15 | 41 | 19 | −5 | −1 |
| 2 | −5 | 13 | 40 | 21 | −4 | −1 |
| 3 | −5 | 11 | 39 | 24 | −4 | −1 |
| 4 | −5 | 9 | 38 | 26 | −3 | −1 |
| 5 | −5 | 7 | 38 | 28 | −2 | −2 |
| 6 | −4 | 5 | 36 | 30 | −1 | −2 |
| 7 | −3 | 3 | 35 | 32 | 0 | −3 |
| 8 | −3 | 2 | 33 | 33 | 2 | −3 |
| 9 | −3 | 0 | 32 | 35 | 3 | −3 |
| 10 | −2 | −1 | 30 | 36 | 5 | −4 |
| 11 | −2 | −2 | 28 | 38 | 7 | −5 |
| 12 | −1 | −3 | 26 | 38 | 9 | −5 |
| 13 | −1 | −4 | 24 | 39 | 11 | −5 |
| 14 | −1 | −4 | 21 | 40 | 13 | −5 |
| 15 | −1 | −5 | 19 | 41 | 15 | −5 |

TABLE 7
the RPR down-sampling filters used for chroma prediction
of inter blocks when down-sampling ratio is equal to or
greater than 1.5:1

| | interpolation filter | | | |
|---|---|---|---|---|
| Fractional | coefficients | | | |
| sample | P0 | P1 | P2 | P3 |
| 0 | 12 | 40 | 12 | 0 |
| 1 | 11 | 40 | 13 | 0 |
| 2 | 10 | 40 | 15 | −1 |
| 3 | 9 | 40 | 16 | −1 |
| 4 | 8 | 40 | 17 | −1 |
| 5 | 8 | 39 | 18 | −1 |
| 6 | 7 | 39 | 19 | −1 |
| 7 | 6 | 38 | 21 | −1 |
| 8 | 5 | 38 | 22 | −1 |
| 9 | 4 | 38 | 23 | −1 |
| 10 | 4 | 37 | 24 | −1 |
| 11 | 3 | 36 | 25 | 0 |
| 12 | 3 | 35 | 26 | 0 |
| 13 | 2 | 34 | 28 | 0 |
| 14 | 2 | 33 | 29 | 0 |
| 15 | 1 | 33 | 30 | 0 |
| 16 | 1 | 31 | 31 | 1 |
| 17 | 0 | 30 | 33 | 1 |
| 18 | 0 | 29 | 33 | 2 |
| 19 | 0 | 28 | 34 | 2 |
| 20 | 0 | 26 | 35 | 3 |
| 21 | 0 | 25 | 36 | 3 |
| 22 | −1 | 24 | 37 | 4 |
| 23 | −1 | 23 | 38 | 4 |
| 24 | −1 | 22 | 38 | 5 |
| 25 | −1 | 21 | 38 | 6 |
| 26 | −1 | 19 | 39 | 7 |
| 27 | −1 | 18 | 39 | 8 |
| 28 | −1 | 17 | 40 | 8 |
| 29 | −1 | 16 | 40 | 9 |
| 30 | −1 | 15 | 40 | 10 |
| 31 | 0 | 13 | 40 | 11 |

Although the RPR functionality is supported in the VVC and the ECM, its coding performance is not optimal. This is because the temporal neighboring pictures in different resolutions may present statistical characteristics. For example, when a video block is predicted from a reference frame with a larger resolution than that of a current video frame, prediction samples of the video block may usually have obvious aliasing artifacts because of the Nyquist-Shannon sampling theorem. Therefore, the efficiency of some inter coding tools, which aim at exploring the correlation between the temporal frames with the same resolution, may not be equally efficient for the RPR.

On the other hand, template matching (TM) based approaches have become an important topic in the recent development of video coding technologies. Specifically, by exploiting the computational capabilities at the decoder, the methods utilize the correlation between a video block and its neighboring reconstructed samples to model complex signal redundancies that exist in inter prediction. For example, an example TM-based scheme (also referred to as TM-based motion vector derivation) performs a distortion-guided search between a template (i.e., adjacent reconstruction samples) and reconstructed samples in the reference pictures in order to obtain inter prediction samples without the transmission of motion information.

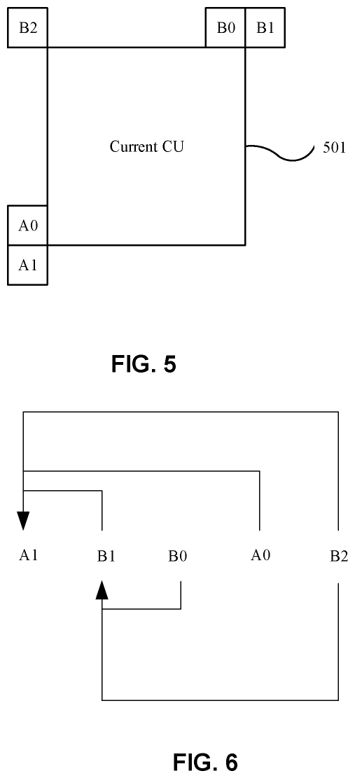

Consistent with some aspects of the present disclosure, the coding efficiency of motion compensated prediction in the RPR can be improved with the application of template-based coding schemes. Specifically, with reference to FIG. 8, template-based coding schemes 800 may include a template-based adaptive filtering scheme 802, a template-based MVD prediction scheme 804, a template-based reference index prediction scheme 806, a template-based merge index reordering scheme 808, and a template-based GPM split mode reordering scheme 810. For example, when prediction samples for a video block of a current video frame is predicted from at least one temporal reference frame having a resolution different from that of the current video frame, template-based adaptive filtering scheme 802 may be applied to improve the quality of the prediction samples. Filter coefficients of a template-based adaptive filter in scheme 802 can be derived based on template samples of the video block to reduce the signaling overhead. In another example, template-based MVD prediction scheme 804 and template-based reference index prediction scheme 806 may be applied to reduce the signaling overhead of the motion information associated with reference pictures that are in different resolutions compared to the current video frame. In yet another example, template-based merge index reordering scheme 808 may be applied to reduce the signaling overhead of the merge mode when the candidates in the merge candidate list are associated with reference pictures with different resolutions.

As discussed above, compared to the regular motion compensated prediction, prediction samples obtained from temporal reference frames with varying resolutions may present different characteristics statistically (e.g., these prediction samples can be referred to as RPR prediction samples). Such difference may lead to poor quality of the RPR prediction samples when compared to prediction samples obtained from the regular motion compensation (i.e., prediction samples generated from temporal reference frames with the same resolution as the current video frame).

Consistent with some aspects of the present disclosure, template-based adaptive filtering scheme 802 can be applied to enhance the RPR prediction samples for the video block. For example, the RPR prediction samples may be filtered based on a template-based adaptive filter to generate filtered RPR prediction samples for the video block. Then, a predictive block (also referred to as a prediction block) can be generated to include the filtered RPR prediction samples for the video block.

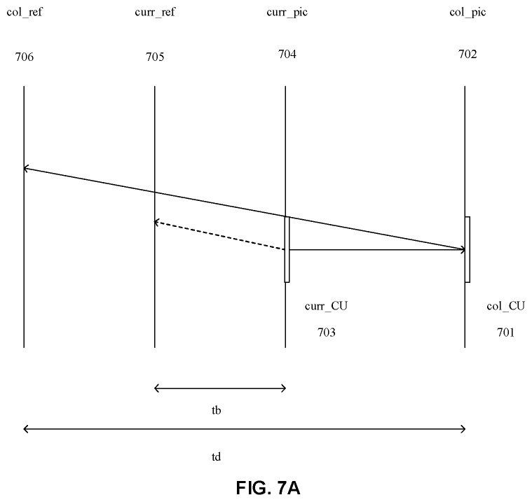

In some implementations, the RPR prediction samples for the video block can be determined based on one or more reference frames and one or more motion vectors associated with the video block. At least one of the one or more reference frames has a resolution different from a resolution of the video frame. Additionally, template samples of the video block may be determined. For example, template samples in a template of the video block may include (a) reconstructed samples above the video block and/or (b) reconstructed samples on the left of the video block (e.g., as depicted in FIG. 9, which is described below). Then, prediction template samples corresponding to the template samples may also be determined from the one or more reference frames based on the one or more motion vectors.

For example, a uni-prediction scheme can be applied to determine the RPR prediction samples for the video block. The RPR prediction samples may include uni-prediction samples determined from a reference frame based on a motion vector associated with the reference frame. The reference frame may be a reference picture from a first reference picture list L0 or a second reference picture list L1, and may have a resolution different from that of the video frame. Then, prediction template samples may include uni-prediction template samples, which include (a) reconstructed samples above the RPR prediction samples and/or (b) reconstructed samples on the left of the RPR prediction samples (e.g., as depicted in FIG. 9).

As described above with reference to the RPR process in view of Table 2-Table 4, a RPR up-sampling filter can be applied to generate the uni-prediction samples and the uni-prediction template samples if a resolution of the video frame is greater than the resolution of the reference frame. Alternatively, with reference to the RPR process in view of Table 5-Table 7, a RPR down-sampling filter can be applied to generate the uni-prediction samples and the uni-prediction template samples if the resolution of the video frame is smaller than the resolution of the reference frame.

In another example, a bi-prediction scheme can be applied to determine the RPR prediction samples for the video block. Specifically, first RPR uni-prediction samples for the video block can be determined from a first reference frame in the first reference picture list L0 based on a first motion vector. Second RPR uni-prediction samples for the video block can be determined from a second reference frame in the second reference picture list L1 based on a second motion vector. Then, the RPR prediction samples may include bi-prediction samples, which are determined to be a weighted sum of the first RPR uni-prediction samples and the second RPR uni-prediction samples (e.g., a RPR prediction sample=w₀*a first RPR uni-prediction sample+w₁*a second RPR uni-prediction sample, where w₀ and w₁ are weighting coefficients).

Subsequently, first uni-prediction template samples may be determined, which include (a) reconstructed samples above the first RPR uni-prediction samples and/or (b) reconstructed samples on the left of the first RPR uni-prediction samples. Second uni-prediction template samples may be determined, which include (a) reconstructed samples above the second RPR uni-prediction samples and/or (b) reconstructed samples on the left of the second RPR uni-prediction samples. Then, the prediction template samples may include bi-prediction template samples, which are determined to be a weighted sum of the first uni-prediction template samples and the second uni-prediction template samples (e.g., a bi-prediction template sample=w₀*a first uni-prediction template sample+w₁*a second uni-prediction template sample).

In the bi-prediction scheme, the first reference frame may have a resolution different from that of the video frame. Alternatively, the second reference frame may have a resolution different from that of the video frame. Alternatively, each of the first and second reference frames may have a resolution different from that of the video frame. The resolution of the first reference frame may be the same as or different from the resolution of the second reference frame, which is not limited herein. As described above with reference to the RPR process in view of Table 2-Table 7, a RPR up-sampling filter or a RPR down-sampling filter can be applied to generate the first uni-prediction samples (as well as the first uni-prediction template samples), depending on whether the resolution of the video frame is greater than or smaller than the resolution of the first reference frame. Similarly, a RPR up-sampling filter or a RPR down-sampling filter can be applied to generate the second uni-prediction samples (as well as the second uni-prediction template samples), depending on whether the resolution of the video frame is greater than or smaller than the resolution of the second reference frame.

In some implementations, the template-based adaptive filter may be a linear filter. For example, the RPR prediction samples can be filtered by the template-based adaptive filter according to the following expression:

$${P}_{rpr}^{′} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} f ( i , j ) \times {P}_{rpr} ( x - i , y - j ) . \qquad ( 1 )$$

In the above expression (1), Pᵣₚᵣ(x,y) denotes a RPR prediction sample for a sample position (x,y); P′ᵣₚᵣ(x,y) denotes a filtered RPR prediction sample obtained by applying the template-based adaptive filter to the RPR prediction sample Pᵣₚᵣ(x,y); and f(i,j)'s denote a set of filter coefficients of the template-based adaptive filter that are applied to a H×L neighboring region of each individual prediction sample, where

$$- \frac{H - 1}{2} \leq i \leq \frac{H - 1}{2} ,$$

$$and$$

$$\frac{L - 1}{2} \leq j \leq \frac{L - 1}{2} .$$

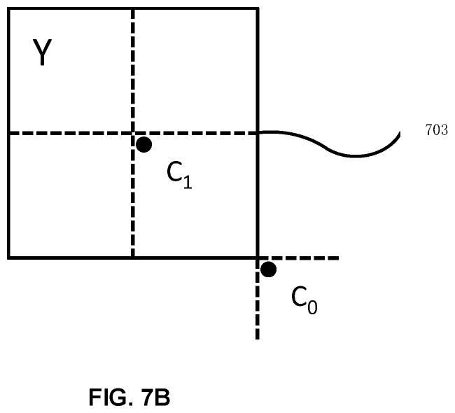

In some implementations, the set of filter coefficients can be determined based on the template samples and the prediction template samples. For example, with reference to FIG. 9, a template 904 of a video block 902 in a video frame is illustrated. Template samples in template 904 may include reconstructed samples above video block 902 and reconstructed samples on the left of video block 902 (i.e., neighboring reconstructed samples on top of video block 902 and neighboring reconstructed samples on the left of video block 902). RPR prediction samples 906 (e.g., RPR uni-prediction samples) and prediction template samples 908 (e.g., uni-prediction template samples) from a reference frame are also illustrated in FIG. 9 for video block 902. For example, prediction template samples 908 may include reconstructed samples above RPR prediction samples 906 and reconstructed samples on the left of RPR prediction samples 906. For example, prediction template samples 908 may be corresponding RPR prediction samples of the template samples based on the RPR-based motion compensation. Up-sampling or down-sampling may be applied to generate prediction template samples 908, depending on whether the resolution of the reference frame is smaller than or greater than the resolution of the video frame (e.g., as illustrated below in FIG. 10).

With reference to FIG. 9, the set of filter coefficients f(i,j)'s can be determined by filter derivation 910, which minimizes the difference between the template samples of template 904 and prediction template samples 908 to reduce the signaling overhead. For example, filter coefficients f(i,j)'s can be determined by the following expression:

$${f}^{*} = arg min {\sum }_{x} {\sum }_{y} {\vert T ( x , y ) - {T}_{rpr}^{′} ( x , y ) \vert}^{2} = arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} f ( i , j ) \times {T}_{rpr} ( x - i , y - j ) ) - T ( x , y ) ]}^{2} . \qquad ( 2 )$$

In the above expression (2), T(x,y) denotes a template sample of template 904 for a sample position (x,y); and Tᵣₚᵣ(x,y) denotes a prediction template sample 908 corresponding to T(x,y). In the above expressions (1) and (2), only scaling factors are considered in the filtering process. It is contemplated that an offset term and one or more non-linear terms can also be introduced into the template-based adaptive filter to improve the coding efficiency. It is also contemplated that various template-based adaptive filters with different sizes and shapes may be applied to provide different trade-offs between coding performance and complexity. A larger-size filter can make the prediction template samples better approach to the template samples but at the expense of increased computational complexity.

Also referring to FIG. 9, after deriving the filter coefficients, adaptive filtering 912 can be applied to filter RPR prediction samples 906, so that filtered RPR prediction samples 914 can be generated. For example, the above expression (1) can be applied to generate filtered RPR prediction samples 914.

It is noted that FIG. 9 is illustrated based on an assumption that there is a single motion vector associated with the video block (i.e., uni-prediction). Consistent with some aspects of the present disclosure, template-based adaptive filtering scheme 802 of FIG. 8 can also be applied in a scenario where there are two motion vectors associated with the video block (e.g., bi-prediction).

In some implementations, template-based adaptive filtering scheme 802 can be applied in a bi-prediction scenario based on (a) RPR bi-prediction samples of the video block and (b) bi-prediction template samples of the video block. For example, the RPR bi-prediction samples and the bi-prediction template samples of the video block can be determined based on the first and second motion vectors from the first and second reference frames, respectively, as described above in more detail. Then, the set of filter coefficients f(i,j)'s can be determined based on the template samples and the bi-prediction template samples (e.g., by minimizing the difference between the bi-prediction template samples and the template samples as illustrated in the above expression (2)). Next, the derived filter coefficients f(i,j)'s can be applied to filter the RPR bi-prediction samples of the video block, as illustrated in the above expression (1), to generate filtered RPR bi-prediction samples of the video block.

In some implementations, template-based adaptive filtering scheme 802 can be applied in the bi-prediction scenario based on one or more of the following: (1) first RPR uni-prediction samples of the video block in a first prediction direction; (2) second RPR uni-prediction samples of the video block in a second prediction direction; (3) first uni-prediction template samples of the video block in the first prediction direction; and (4) second uni-prediction template samples of the video block in the second prediction direction. Without loss of generality, in the description hereinafter, the first prediction direction may refer to a prediction direction associated with the first reference picture list L0, whereas the second prediction direction may refer to a prediction direction associated with the second reference picture list L1. It is contemplated that the first prediction direction can also be the prediction direction associated with the second reference picture list L1, whereas the second prediction direction can be the prediction direction associated with the first reference picture list L0.

Specifically, the template-based adaptive filter may include a first filter for the first prediction direction and a second filter for the second prediction direction. The first RPR uni-prediction samples of the video block may be filtered based on the first filter to generate first filtered RPR prediction samples. The second RPR uni-prediction samples of the video block may be filtered based on the second filter to generate second filtered RPR prediction samples. The first filtered RPR prediction samples and the second filtered RPR prediction samples can be combined to generate the filtered RPR prediction samples.

The set of filter coefficients of the template-based adaptive filter may include a first set of filter coefficients for the first filter and a second set of filter coefficients for the second filter. The first set of filter coefficients and the second set of filter coefficients can be determined based on the template samples, the first uni-prediction template samples, and the second uni-prediction template samples, as described below in more detail.

For example, two adaptive filter operations can be applied in a unilateral manner as follows: (a) the first set and the second set of filter coefficients can be separately derived, and then applied to the first RPR uni-prediction samples and the second RPR uni-prediction samples to generate first filtered RPR uni-prediction samples and second filtered RPR uni-prediction samples, respectively; and (b) a weighted sum (e.g., an average) of the first and second filtered uni-prediction samples can be generated as filtered RPR prediction samples for the video block. For example, the following expression can be applied to generate the filtered RPR prediction samples:

$${P}_{rpr}^{′0} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{0} ( i , j ) \times {P}_{rpr}^{0} ( x - i , y - j ) \qquad ( 3 )$$

$${P}_{rpr}^{′ 1} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{1} ( i , j ) \times {P}_{rpr}^{1} ( x - i , y - j )$$

$${P}_{rpr}^{bi} ( x , y ) = {w}_{0} * {P}_{rpr}^{′ 0} ( x , y ) + {w}_{1} * {P}_{rpr}^{′ 1} ( x , y )$$

In the above expression (3), f₀(i,j)'s and f₁(i,j)'s denote the first set of filter coefficients for the first filter and the second set of filter coefficients for the second filter, respectively.

$${P}_{rpr}^{0} ( x , y ) and {P}_{rpr}^{1} ( x , y )$$

respectively denote a first RPR uni-prediction sample and a second RPR uni-prediction sample for a sample (x,y) of the video block before the first filter and the second filter are applied.

$${P}_{rpr}^{′ 0} ( x , y ) and {P}_{rpr}^{′1} ( x , y )$$

respectively denote a first filtered RPR uni-prediction sample and a second filtered RPR uni-prediction sample for the sample (x,y) of the video block.

Different filter derivation methods may be used to estimate the first set of filter coefficients f₀(i,j)'s and the second set of filter coefficients f₁(i,j)'s. In a first filter derivation method, the two sets of filter coefficients can be determined separately. Specifically, the first filter derivation method may include: (a) generating the first uni-prediction template samples and the second uni-prediction template samples, respectively, by performing operations like those described above; (b) determining the first set of filter coefficients f₀(i,j)'s based on the template samples and the first uni-prediction template samples, e.g., by minimizing the difference between the template samples and the first uni-prediction template samples as illustrated in the expression (2); and (c) determining the second set of filter coefficients f₁(i,j)'s based on the template samples and the second uni-prediction template samples, e.g., by minimizing the difference between the template samples and the second uni-prediction samples as shown in the expression (2).

In a second filter derivation method, an iterative scheme can be applied to alternatively determine the first set of filter coefficients f₀(i,j)'s and the second set of filter coefficients f₁(i,j)'s. For example, the second filter derivation method may alternatively optimize one of the first and second filters for one of the first and second prediction directions, while keeping another one of the first and second filters in another one of the first and second prediction directions unchanged. The second filter derivation method may include steps 1-6 described below.

In step 1, given a starting prediction direction L⁽⁰⁾, initial filter coefficients

$${f}_{{L}^{( 0 )}}^{( 0 )}$$

can be derived for the starting prediction direction by minimizing the difference (or distortion) between the uni-prediction template samples T_{L}_{⁽⁰⁾} associated with the starting prediction direction and the template samples T of the video block (e.g., as shown in the expression (2)).

In a first example, the starting prediction direction is the first prediction direction associated with the first reference picture list L0, e.g., L⁽⁰⁾=0. The uni-prediction template samples T_{L}_{⁽⁰⁾} is T₀, which are the first uni-prediction template samples in the first prediction direction. The initial filter coefficients

$${f}_{{L}^{( 0 )}}^{( 0 )} are {f}_{0}^{( 0 )} ,$$

which are initial filter coefficients for the first filter, derived by minimizing the difference between the first uni-prediction template samples T₀ and the template samples T of the video block.

In a second example, the starting prediction direction is the second prediction direction associated with the second reference picture list L1, e.g., L⁽⁰⁾=1. The uni-prediction template samples T_{L}_{⁽⁰⁾} is T₁, which are the second uni-prediction template samples in the second prediction direction. The initial filter coefficients

$${f}_{{L}^{( 0 )}}^{( 0 )} are {f}_{1}^{( 0 )} ,$$

which are initial filter coefficients for the second filter, derived by minimizing the difference between the second uni-prediction template samples T₁ and the template samples T of the video block.

In step 2, based on the initial filter coefficients

$${f}_{{L}^{( 0 )}}^{( 0 )} ,$$

the filtered uni-prediction template samples

$${T}_{{L}^{( 0 )}}^{( 0 )}$$

are calculated. An iteration parameter k is set to be 1 (e.g., k=1). For example, the filtered uni-prediction template samples

$${T}_{{L}^{( 0 )}}^{( 0 )}$$

can be generated by filtering the uni-prediction template samples T_{L}_{^{(o)}} using the initial filter coefficients

$${f}_{{L}^{( 0 )}}^{( 0 )} .$$

For instance, following the first example above, the filtered uni-prediction template samples

$${T}_{{L}^{( 0 )}}^{( 0 )}$$

are the first filtered uni-prediction template samples

$${T}_{0}^{( 0 )}$$

in the first prediction direction. For instance, following the second example above, the filtered uni-prediction template samples

$${T}_{{L}^{( 0 )}}^{( 0 )}$$

are the second filtered uni-prediction template samples

$${T}_{1}^{( 0 )}$$

in the second prediction direction.

In step 3, a target prediction direction is selected to be L^{(k)}=1−L^{(k-1)}. Target template samples T^{(k)} of the video block can be calculated by subtracting the filtered uni-prediction

$${T}_{{L}^{( k - 1 )}}^{( k - 1 )}$$

from the template samples T of the video block. For example,

$${T}^{( k )} = T - {T}_{{L}^{( k - 1 )}}^{( k - 1 )} .$$

For example, if L^{(k-1)}=0, then L^{(k)}=1, indicating that the target prediction direction is the second prediction direction. Then,

$${T}^{( k )} = T - {T}_{0}^{( k - 1 )} .$$

In another example, if L^{(k-1)}=1, then L^{(k)}=0, indicating that the target prediction direction is the first prediction direction. Then,

$${T}^{( k )} = T - {T}_{1}^{( k - 1 )} .$$

In step 4, the filter coefficients

$${f}_{{L}^{( k )}}^{( k )}$$

for the target prediction direction L^{(k)} are derived by minimizing the difference (or distortion) between the uni-prediction template samples T_{L}_{^{(k)}} in the prediction direction L^{(k)} and the target template samples T^{(k)}.

For example, if L^{(k)}=1, indicating that the target prediction direction is the second prediction direction, the filter coefficients

$${f}_{{L}^{( k )}}^{( k )}$$

are filter coefficients

$${f}_{1}^{( k )}$$

for the second filter and obtained by minimizing the difference between the second uni-prediction template samples T₁ and the target template samples T^{(k)}. In another example, if L^{(k)}=0, indicating that the target prediction direction is the first prediction direction, the filter coefficients

$${f}_{{L}^{( k )}}^{( k )}$$

are filter coefficients

$${f}_{0}^{( k )}$$

for the first filter and obtained by minimizing the difference between the first uni-prediction template samples T₀ and the target template samples T^{(k)}.

In step 5, based on the filter coefficients

$${f}_{{L}^{( k )}}^{( k )} ,$$

the filtered uni-prediction template samples

$${T}_{{L}^{( k )}}^{( k )}$$

can be calculated. For example, the filtered uni-prediction template samples

$${T}_{{L}^{( k )}}^{( k )}$$

can be generated by filtering the uni-prediction template samples T_{L}_{^{(k)}} using the filter coefficients

$${f}_{{L}^{( k )}}^{( k )} .$$

In step 6, the iteration parameter k is incremented by 1 (e.g., k=k+1). The method returns to step 3.

Iterations in the second filter derivation method may be terminated when a termination condition is satisfied. For example, when the number of iterations reaches a threshold, the second filter derivation method may be terminated. It is contemplated that different number of iterations may be applied to the second filter derivation method. In general, more iterations may lead to a smaller distortion between the template samples and the prediction template samples (i.e., better coding gain) which may come at the expense of higher computational complexity.

It is contemplated that linear terms and/or non-linear terms can be included in the template-based adaptive filter. In practice, filters with different lengths may be applied for varying the trade-off between coding performance and computational complexity. A longer filter can make the prediction template samples better approach to the template samples but at the expense of increased computational complexity. In one example, a 2-tap linear model (i.e., one scaling factor and one offset) can be used in the template-based adaptive filter.

Consistent with some aspects of the present disclosure, template-based MVD prediction scheme 804 can be applied to reduce the signaling overhead. In the VVC and its preceding standards, instead of directly signaling the motion vectors, the MVDs can be transmitted in a bitstream. The MVDs can be coded by the equal probability (EP) mode and take up a large portion of the bitstream. Template-based MVD prediction scheme 804 disclosed herein can be applied to improve the MVD coding efficiency for the RPR scenario.

On the encoder side, a basic idea of scheme 804 is to sort the possible combinations of MVD signs and most significant suffix bins of an MVD according to template costs, and then an index of the true MVD value is coded with a context model and signaled to the decoder. For example, for a motion vector associated with the video block, an MVD can be determined based on the motion vector and an MVP (e.g., MVD=motion vector−MVP). A template-based MVD reordering scheme may be applied to generate a reordered MVD candidate list. Then, an MVD index of the MVD in the reordered MVD candidate list can be determined and signaled to the decoder.

To apply the template-based MVD reordering scheme to generate the reordered MVD candidate list, initially, a list of MVD candidates can be produced based on a combination of potential MVD signs and most significant suffix bins of the MVD. For example, a list of MVD candidates can be generated based on the combination of all possible MVD signs and most significant suffix bins of the MVD. Next, template costs associated with the MVD candidates can be determined respectively. For example, for each MVD candidate in the list, a template cost associated with the MVD candidate can be determined by: (1) determining template samples of the video block; (2) determining a motion vector candidate based on the MVD candidate and the MVP; (3) determining prediction template samples of the video block from a reference frame based on the motion vector candidate; and (4) determining a metric difference (e.g., an SAD, or an SSD) between the template samples and the prediction template samples as a template cost associated with the MVD candidate. Subsequently, the MVD candidates in the list can be sorted based on their respective template costs to generate the reordered MVD candidate list. For example, the MVD candidates can be sorted in the ascending order of their respective template costs to generate the reordered MVD candidate list.

In other words, on the encoder side, template-based MVD prediction scheme 804 may include: (a) producing a list of MVD candidates based on a combination of potential MVD signs and most significant suffix bins of the MVD; (b) determining template costs associated with the MVD candidates in the list, respectively; (c) sorting the MVD candidates based on the template costs to generate the reordered MVD candidate list; (d) determining an MVD index of the MVD in the reordered MVD candidate list; and (e) signaling the MVD index to the decoder.

On the decoder side, template-based MVD prediction scheme 804 may include: (i) applying a template-based MVD reordering scheme to generate a reordered MVD candidate list; and (ii) selecting, based on an MVD index signaled by the encoder, an MVD candidate from the reordered MVD candidate list as an MVD for a motion vector. For example, the MVD can be derived at the reconstruction stage by: (a) producing a list of MVD candidates based on a combination of potential MVD signs and most significant suffix bins of the MVD; (b) determining template costs associated with the MVD candidates in the list, respectively; (c) sorting the MVD candidates based on the template costs to generate the reordered MVD candidate list; and (d) selecting an MVD candidate from the reordered MVD candidate list as the MVD for the motion vector based on an MVD index signaled by the encoder.

In template-based MVD prediction scheme 804, according to a resolution of a reference frame that an MVD candidate is associated with, different motion compensated filters may be applied to generate the prediction template samples of the video block. For example, as shown in FIG. 10, an MVD candidate A is associated with a reference picture having a different resolution from the current video frame (e.g., having a resolution greater than that of the current video frame). Then, a RPR down-sampling filter can be applied to generate the corresponding prediction template samples. In another example, an MVD candidate B in FIG. 10 is associated with another reference picture having a different resolution from the current video frame (e.g., having a resolution smaller than that of the current video frame). Then, a RPR up-sampling filter can be applied to generate the corresponding prediction template samples. On the other hand, MVD candidates C and D in FIG. 10 are associated with reference pictures with the same resolution as the current video frame. Then, default motion compensation (MC) filters (with no up-sampling and no down-sampling) can be applied to generate the corresponding prediction template samples.

Consistent with some aspects of the present disclosure, template-based reference index prediction scheme 806 may be applied to reduce the signaling overhead of reference indices for the RPR. On the encoder side, for a reference frame corresponding to a motion vector, a template-based reference index reordering scheme may be applied to generate a reordered joint list of reference pictures. Then, a reference picture index (also referred to as a reference index for simplicity) of the reference frame in the reordered joint list of reference pictures may be determined and signaled to the decoder.

In some implementations, to apply the template-based reference index reordering scheme to generate the reordered joint list of reference pictures, initially, reference pictures from a first reference picture list and reference pictures from a second reference picture list may be combined into a joint list of reference pictures. Then, motion vector candidates can be generated based on the MVD and MVPs generated from reference pictures in the joint list. Next, template costs associated with the reference pictures in the joint list can be determined based on the motion vector candidates, respectively. For example, for each motion vector candidate associated with a reference picture in the list, a template cost associated with the motion vector candidate can be determined by: (1) determining template samples of the video block; (2) determining prediction template samples of the video block from the reference picture based on the motion vector candidate; and (3) determining a metric difference (e.g., an SAD, or an SSD) between the template samples and the prediction template samples as a template cost associated with the reference picture. Subsequently, the reference pictures in the joint list can be sorted based on their respective template costs to generate the reordered joint list. For example, the reference pictures in the joint list can be sorted according to the ascending order of their respective template costs to generate the reordered joint list.

In some examples, for the inter AMVP mode, the reference pictures in the first reference picture list L0 and the reference pictures in the second reference picture list L1 can be combined to generate a joint list. Then, a group of the motion vector candidates can be generated by the combination of the MVD and the AMVP predictors that are generated from the reference pictures in the joint list. A respective template cost can be calculated for each motion vector candidate associated with a respective reference picture. Afterwards, the joint list is reordered based on the ascending order of the template costs associated with the reference pictures, respectively. The index of the selected reference picture (which is the reference frame associated with the MVD) in the reordered list is signaled in the bitstream. For the bi-prediction AMVP mode, a list of pairs of reference pictures from the first reference picture list L0 and the second reference picture list L1 can be generated. The pairs of reference pictures can be similarly reordered based on respective template costs associated with the pairs of reference pictures. An index of the selected pair of reference pictures (which are the reference frames associated with two MVDs of two motion vectors of the video block, respectively) is signaled to the decoder.

In some other implementations, to apply the template-based reference index reordering scheme to generate the reordered joint list of reference pictures, initially, reference pictures from a first reference picture list and reference pictures from a second reference picture list can be divided into one or more groups of reference pictures. Then, one or more reordered lists of reference pictures can be generated by applying the template-based reference index reordering scheme to each group of reference pictures to generate a corresponding reordered list of reference pictures. Next, the one or more reordered lists of reference pictures can be combined to generate the reordered joint list of reference pictures.

For example, as discussed above, temporal reference pictures with different resolutions may present varying characteristics which may lead to significant quality variations of the prediction samples generated from different pictures. With the consideration of such a phenomenon, a group-based reference index prediction scheme can be applied. Specifically, the reference pictures in the first reference picture list L0 and the reference pictures in the second reference picture list L1 are divided into two groups. The first group includes reference pictures from the list L0 and reference pictures from the list L1 that have the same resolution as the current video frame. The second group includes reference pictures from the list L0 and reference pictures from the list L1 each of which has a resolution different from that of the current video frame. Then, the template-based reference index reordering scheme can be applied to reorder the two groups of reference pictures separately in the ascending order of their respective template costs. Afterwards, the two reordered groups of reference pictures are combined to form a reordered joint list of reference pictures. The index of the selected reference picture (which is the reference frame associated with the motion vector of the video block) in the reordered joint list is signaled from the encoder to the decoder.

The first ordered group of reference pictures (i.e., the reference pictures with the same resolution as the current video frame) may be placed ahead of the second ordered group of reference pictures (i.e., the reference pictures with different resolutions to the current video frame) in the reordered joint list. Alternatively, the second ordered group of reference pictures may be placed ahead of the first ordered group of reference pictures.

In another example, the reference pictures from lists L0 and L1 can be grouped according to their respective resolutions, such that reference pictures with the same resolution can be placed into the same group. Then, the template-based reference index reordering scheme may be applied to each group of reference pictures separately. Afterwards, all the reordered groups of reference pictures can be combined to form the reordered joint list of reference pictures. Different orders may be applied when combining different reordered groups of reference pictures into the reordered joint list. For instance, the reordered groups of reference pictures are combined according to the resolutions of the different groups, such that a reordered group with a smaller resolution difference from the current video frame can be placed ahead of another reordered group with a larger resolution difference from the current video frame.

On the decoder side, template-based reference index prediction scheme 806 may include, for a reference frame corresponding to a motion vector, (i) applying a template-based reference index reordering scheme to generate a reordered joint list of reference pictures, and (ii) selecting, based on a reference picture index signaled by the encoder, a reference picture from the reordered joint list as the reference frame for the motion vector. The reordered joint list of reference pictures may be generated by performing operations like those described above with reference to the encoder side, and the similar description will not be repeated herein.

Consistent with some aspects of the present disclosure, template-based merge index reordering scheme 808 may be applied to reduce the signaling overhead of the merge index. Similar to the inter AMVP mode, a candidate list in the merge mode may include merge candidates that are associated with the temporal reference pictures with different resolutions. Due to the varying statistical characteristics of different RPR reference pictures, template-based merge index reordering scheme 808 can be applied to reduce the signaling overhead.

On the encoder side, for each motion vector corresponding to a respective MVP, template-based merge index reordering scheme 808 may be applied to generate a reordered merge list of merge candidates. For example, the following operations may be performed to generate the reordered merge list of merge candidates, including: (a) producing a list of merge candidates; (b) determining template costs associated with the merge candidates in the list, respectively; and (c) sorting the merge candidates in the list based on the template costs to generate the reordered merge list of merge candidates. Then, a merge index of a merge candidate corresponding to the respective MVP in the reordered merge list may be determined and signaled to the decoder.

In some implementations, an initial merge candidate list can be constructed according to a merge list generation process described above with reference to the inter merge mode to include spatial MVPs, temporal MVPs, non-adjacent MVPs, history-based MVPs, pairwise average MVPs, and zero MVPs as MVP candidates in the list. Next, the MVP candidates in the initial merge candidate list can be reordered according to their template costs. The index of the selected merge candidate (which is an MVP associated with a motion vector of the video block) in the reordered candidate list is signaled from the encoder to the decoder. Like FIG. 10, based on the resolution of the reference picture associated with a corresponding merge candidate, either RPR up-sampling or down-sampling filters or default motion compensated filters may be applied to generate prediction template samples from the reference picture.

On the decoder side, to determine an MVP associated with a motion vector, template-based merge index reordering scheme 808 may be applied to generate a reordered merge list of merge candidates at least by: (a) producing a list of merge candidates; (b) determining template costs associated with the merge candidates in the list, respectively; and (c) sorting the merge candidates in the list based on the template costs to generate the reordered merge list of merge candidates. Then, a merge candidate from the reordered merge list is selected as the MVP for the motion vector based on a merge index signaled by the encoder.

Consistent with some aspects of the present disclosure, template-based GPM split mode reordering scheme 810 disclosed herein can be applied to reduce the signaling overhead of a GPM split mode. For example, there are 64 split modes in the GPM, and a split mode selected from the 64 split modes for each CU is signaled using codewords with a fixed length. In this case, all the split modes are treated with an equal probability. To reduce the signaling overhead of the split mode, template-based GPM split mode reordering scheme 810 can be applied for the RPR.

On the encoder side, a split mode can be selected for the video block from a plurality of split mode candidates. Then, template-based GPM split mode reordering scheme 810 can be applied to determine a split mode index corresponding the selected split mode based on the template of the video block. Specifically, template costs associated with the plurality of split mode candidates can be determined based on the template of the video block, respectively. Afterwards, the split mode candidates can be sorted based on the template costs to generate a reordered split mode candidate list. An index of the selected split mode in the reordered split mode candidate list can be determined as the split mode index.

For example, the video block can be divided into partitions (e.g., two partitions) using the selected split mode. Given the motion vectors for the partitions of the video block (e.g., each partition of the video block having a respective motion vector), prediction template samples of the template can be determined with respect to each split mode candidate. A distortion (e.g., an SAD, SSD, etc.) between the template samples of the template and the prediction template samples of the template is calculated as a template cost for the split mode candidate. As a result, template costs for all the split mode candidates can be determined, respectively. Then, all the split mode candidates can be sorted according to an ascending order of their respective template costs to generate a reordered split mode candidate list (e.g., a split mode candidate with a smaller template cost may be assigned with a smaller index in the list, while another split mode candidate with a larger template cost may be assigned with a larger index in the list). An index of the selected split mode in the reordered split mode candidate list can be treated as the split mode index. In some implementations, a value of the split mode index can be coded with a context model to further reduce the signaling overhead of the split mode index. The split mode index can be signaled to video decoder 30 as a syntax element through a bitstream.

On the decoder side, motion vectors for the partitions of the video block can be determined based on merge indices signaled through the bitstream. Template costs associated with the split mode candidates can be determined based on the template of the video block, respectively. For example, given the motion vectors for the partitions of the video block, prediction template samples of the template can be determined for each split mode candidate (e.g., for each partition of the video block divided by the split mode candidate, corresponding prediction template samples associated with the partition can be determined based on a motion vector of the partition, and the prediction template samples of the template for the split mode candidate may include the corresponding prediction template samples of all the partitions). A distortion (e.g., an SAD, SSD, etc.) between the template samples of the template and the prediction template samples of the template is calculated as a template cost for the split mode candidate. As a result, template costs for all the split mode candidates can be determined. Then, the split mode candidates can be sorted in an ascending order of the template costs to generate a reordered split mode candidate list. Subsequently, a split mode candidate corresponding to the split mode index signaled by video encoder 20 can be selected from the reordered split mode candidate list as the split mode for the video block.

Consistent with some aspects of the present disclosure, to achieve different tradeoffs between performance and complexity, template-based GPM split mode reordering scheme 810 can be enabled or disabled in the video coding based on whether an enabling condition is satisfied. For example, responsive to determining that the enabling condition is satisfied, template-based GPM split mode reordering scheme 810 is enabled in the video encoding and video decoding. Otherwise (responsive to determining that the enabling condition is not satisfied), template-based GPM split mode reordering scheme 810 is disabled in the video encoding and video decoding.

In some implementations, resolutions of reference frames associated with the partitions can be determined. Responsive to the resolutions of the reference frames being identical to a resolution of the current video frame, it is determined that the enabling condition is satisfied. For example, template-based GPM split mode reordering scheme 810 is enabled in the video encoding and video decoding when the two reference frames associated with the two GPM partitions have the same resolution as the current video frame. Template-based GPM split mode reordering scheme 810 is disabled in the video encoding and video decoding when at least a reference frame associated with a GPM partition has a resolution different from that of the video frame.

In some other implementations, when at least a resolution of a reference frame associated with one of the partitions is different from the resolution of the video frame, it is determined that the enabling condition is satisfied. For example, template-based GPM split mode reordering scheme 810 is enabled in the video encoding and decoding when at least one of the two reference frames associated with the two GPM partitions has a resolution different from that of the current video frame.

In some other implementations, template-based GPM split mode reordering scheme 810 is enabled in the video encoding and video decoding no matter whether the reference frames associated with the GPM partitions have the same resolution as the video frame or different resolutions from the video frame. For each GPM partition, based on a resolution of a reference frame of the GPM partition, different motion compensation (MC) filters may be applied to generate uni-prediction template samples corresponding to the GPM partition. For example, when the reference frame of the GPM partition has the same resolution as the current video frame, a default motion compensation filter can be applied to generate the uni-prediction template samples corresponding to the GPM partition. Alternatively, when the resolution of the reference frame is different from that of the current video frame, a RPR up-sampling filter or a RPR down-sampling filter can be applied to generate the uni-prediction template samples corresponding to the GPM partition. For example, operations like those described above with reference to FIG. 10 can be performed to generate the uni-prediction template samples corresponding to the GPM partition using different MC filters, and the similar description will not be repeated herein.

Consistent with some aspects of the present disclosure, each template-based coding scheme 800 described above (e.g., template-based adaptive filtering scheme 802, template-based MVD prediction scheme 804, template-based reference index prediction scheme 806, template-based merge index reordering scheme 808, or template-based GPM split mode reordering scheme 810) can be enabled or disabled in the video coding based on whether an enabling condition is satisfied. A motivation of template-based coding schemes 800 described above is to reduce the signaling costs of the related syntax elements based on the template costs associated with RPR reference pictures and non-RPR reference pictures. However, due to the non-negligible computation costs incurred by the generation of the prediction template samples and the calculation of the corresponding distortions, template-based coding schemes 800 described above may increase the complexity on both the video encoder side and the video decoder side. Additionally, different RPR reference pictures may show different characteristics compared to the current video frame, which may make the reordering less efficient when the RPR reference pictures and non-RPR reference pictures are reordered together. Based on such consideration, each template-based coding scheme 800 described above may be conditionally enabled or disabled in the video encoding and video decoding based on whether an enabling condition is satisfied.

In some implementations, a ratio between (1) a total number of RPR reference pictures in one or more reference lists and (2) a total number of the RPR reference pictures and non-RPR reference pictures in the one or more reference lists can be determined. For example, the one or more reference lists may include the first reference list L0 and the second reference list L1. The RPR reference pictures may be reference pictures from either the first reference list L0 or the second reference list L1 that have different resolutions from the current video frame, whereas the non-RPR reference pictures may be reference pictures from either the first reference list L0 or the second reference list L1 that have the same resolution as the current video frame. If the ratio is greater than a predetermined threshold, it is determined that the enabling condition is satisfied, and template-based coding scheme 800 described above may be enabled in the video encoding and video decoding. Otherwise (e.g., the ratio being not greater than the predetermined threshold), it is determined that the enabling condition is not satisfied, and template-based coding scheme 800 described above may be skipped or disabled in the video encoding and video decoding.

That is, template-based coding scheme 800 described above may be conditionally enabled based on a proportion of the RPR reference pictures in the reference picture lists. Template-based coding scheme 800 is only enabled for the RPR reference pictures when a ratio of the RPR pictures in the reference picture lists to the total number of the reference pictures in the reference picture lists is greater than the predetermined threshold. When the ratio is not greater than the predetermined threshold, template-based coding scheme 800 is not enabled for the RPR reference pictures.

Taking the group-based reference index reordering scheme described above as an example, the reference pictures in the lists L0 and L1 are divided into two groups, where the first group includes reference pictures from the lists L0 and L1 that have the same resolution as the current video frame (e.g., non-RPR reference pictures), and the second group includes reference pictures from the lists L0 and L1 that have resolutions different from the current video frame (e.g., RPR reference pictures). When the ratio of the number of the RPR pictures in the lists L0 and L1 to the total number of the reference pictures in the lists L0 and L1 is greater than the predetermined threshold, template-based reference index reordering scheme 806 is applied to reorder the two groups of reference pictures separately in the ascending order of their respective template costs to generate two reordered groups of reference pictures. That is, template-based reference index reordering scheme 806 is enabled for both the first group of the non-RPR reference pictures and the second group of RPR reference pictures. Afterwards, the two reordered groups of reference pictures are combined to form a reordered joint list.

On the other hand, when the ratio of the number of the RPR pictures in the lists L0 and L1 to the total number of the reference pictures in the lists L0 and L1 is not greater than the predetermined threshold, template-based reference index reordering scheme 806 is only applied to reorder the first group of non-RPR reference pictures to generate a reordered first group of non-RPR reference pictures. The second group of RPR reference pictures may not be reordered. That is, template-based reference index reordering scheme 806 is enabled for the first group of non-RPR reference pictures and disabled for the second group of RPR reference pictures. Afterwards, the reordered first group of non-RPR reference pictures and the second group of RPR reference pictures may be combined together to form the reordered joint list.

In some implementations, each template-based coding scheme 800 may be conditionally enabled based on a temporal layer of the current video frame. When the temporal layer of the video frame is higher than a predetermined temporal layer, it is determined that the enabling condition is satisfied. Specifically, template-based coding scheme 800 is enabled for the RPR reference pictures when the temporal layer (as indicated by a temporal layer index) of the current video frame is higher than the predetermined temporal layer.

It is contemplated that the application of temporal layers enables portions of a bitstream (referred to as temporal layers) to be decoded independently without completely decoding the whole bitstream (e.g., the application of temporal layers enables the bitstream to be decoder partially). This is implemented by dividing the entire video sequences in the bitstream into multiple temporal layers where the video frames in lower temporal layers (i.e., with smaller temporal layer IDs) cannot refer to the video frames in higher temporal layers (i.e., with higher temporal layer IDs). By this way, the video frames in lower temporal layers can be decoded without decoding the video frames in higher temporal layers.

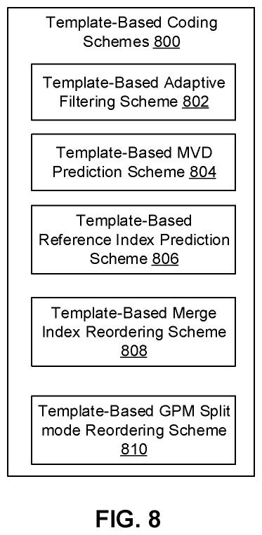

FIG. 11 is a flow chart of an exemplary method 1100 for video coding based on template-based coding schemes in accordance with some implementations of the present disclosure. Method 1100 may be implemented by a processor associated with video encoder 20 or video decoder 30 (e.g., method 1100 may be implemented on the encoder side or the decoder side), and may include steps 1102-1106 as described below. Some of the steps may be optional to perform the disclosure provided herein. Further, some of the steps may be performed simultaneously, or in a different order than shown in FIG. 11.

In step 1102, as shown in FIG. 11, the processor may determine RPR prediction samples for a video block from a video frame of a video. For example, the processor may determine the RPR prediction samples based on one or more reference frames and motion information associated with the video block. The motion information may include at least one or more motion vectors and one or more reference picture indices corresponding to the one or more reference frames, respectively. At least one of the one or more reference frames has a resolution different from a resolution of the video frame.

In some implementations, a uni-prediction scheme or a bi-prediction scheme is applied to determine the RPR prediction samples for the video block. The processor may perform operations like those described above with reference to FIG. 8 to determine the RPR prediction samples, and the similar description will not be repeated herein.

In step 1104, the processor may filter the RPR prediction samples based on a template-based adaptive filter to generate filtered RPR prediction samples for the video block. For example, template-based adaptive filtering scheme 802 described above with reference to FIG. 8 can be applied to generate the filtered RPR prediction samples for the video block, and the similar description will not be repeated herein.

In step 1106, the processor may determine a predictive block including the filtered RPR prediction samples for the video block. On the encoder side, the predictive block may be used to generate a bitstream as described above with reference to FIG. 2. In another example, on the decoder side, a bitstream can be decoded based on the generated predictive block as described above with reference to FIG. 3.

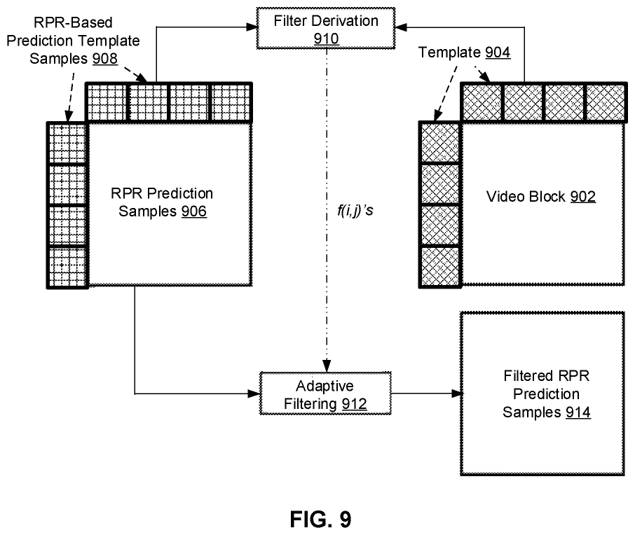

FIGS. 12A and 12B together show a flow chart of an exemplary method 1200 for video encoding based on template-based coding schemes in accordance with some implementations of the present disclosure. Method 1200 may be implemented by a processor associated with video encoder 20, and may include steps 1202-1222 as described below. Some of the steps may be optional to perform the disclosure provided herein. Further, some of the steps may be performed simultaneously, or in a different order than shown in FIGS. 12A and 12B.

In step 1202, as shown in FIG. 12A, the processor may determine one or more motion vectors for a video block from a video frame of a video. For example, if a uni-prediction scheme is applied in the video coding, the processor may determine a motion vector for the video block by performing operations like those described above with reference to motion estimation unit 42 of FIG. 2. Alternatively, if a bi-prediction scheme is applied in the video coding, the processor may determine a first motion vector in a first prediction direction and a second motion vector in a second prediction direction for the video block, by performing operations like those described above with reference to motion estimation unit 42 of FIG. 2. The similar description will not be repeated herein.

In step 1204, as shown in FIG. 12A, the processor may determine one or more reference frames corresponding to the one or more motion vectors for the video block. For example, if a uni-prediction scheme is applied in the video coding, the processor may determine a reference frame corresponding to a motion vector of the video block from either the first reference picture list L0 or the second reference picture list L1. Motion information can be generated to include the motion vector and a reference picture index associated with the reference frame.

Alternatively, if a bi-prediction scheme is applied in the video coding, the processor may determine a first reference frame associated with a first motion vector from the first reference picture list L0 and a second reference frame associated with a second motion vector from the second reference picture list L1 for the video block. Motion information can be generated to include the first motion vector, the second motion vector, a first reference picture index associated with the first reference frame, and a second reference picture index associated with the second reference frame.

In step 1206, as shown in FIG. 12A, the processor may determine RPR prediction samples for the video block based on the one or more motion vectors and the one or more reference frames. The processor may perform operations like those described above with reference to FIG. 8 to determine the RPR prediction samples, and the similar description will not be repeated herein.

In step 1208, as shown in FIG. 12A, the processor may filter the RPR prediction samples based on a template-based adaptive filter to generate filtered RPR prediction samples for the video block. For example, template-based adaptive filtering scheme 802 described above with reference to FIG. 8 can be applied to generate the filtered RPR prediction samples for the video block, and the similar description will not be repeated herein.

In step 1210, as shown in FIG. 12A, the processor may determine a predictive block including the filtered RPR prediction samples for the video block.

In step 1212, as shown in FIG. 12A, the processor may determine one or more MVPs corresponding to the one or more motion vectors, respectively. For example, the processor may determine the one or more MVPs as one or more merge candidates from a merge candidate list.

In step 1214, as shown in FIG. 12A, the processor may determine one or more MVDs corresponding to the one or more motion vectors based on the one or more MVPs, respectively. For example, for each motion vector, a corresponding MVD can be a difference between the motion vector and a corresponding MVP.

Referring to FIG. 12B, in step 1216, the processor may determine one or more MVD indices of the one or more MVDs, respectively. In some implementations, operations like those described above with reference to template-based MVD prediction scheme 804 of FIG. 8 can be performed to determine the one or more indices of the one or more MVDs, respectively. The similar description will not be repeated herein.

In step 1218, as shown in FIG. 12B, the processor may determine one or more reference indices of the one or more reference frames, respectively. For example, for a reference frame corresponding to a motion vector, the processor may apply a template-based reference index reordering scheme to generate a reordered joint list of reference pictures, and determine a reference picture index of the reference frame in the reordered joint list.

In some implementations, operations like those described above with reference to template-based reference index prediction scheme 806 of FIG. 8 can be performed to determine the one or more reference indices of the one or more reference frames, respectively. The similar description will not be repeated herein.

In step 1220, as shown in FIG. 12B, the processor may determine one or more merge indices associated with the one or more MVPs, respectively. In some implementations, operations like those described above with reference to template-based merge index reordering scheme 808 of FIG. 8 can be performed to determine the one or more merge indices. The similar description will not be repeated herein.

In step 1222, as shown in FIG. 12B, the processor may signal the one or more MVD indices, the one or more reference indices, and the one or more merge indices to a decoder.

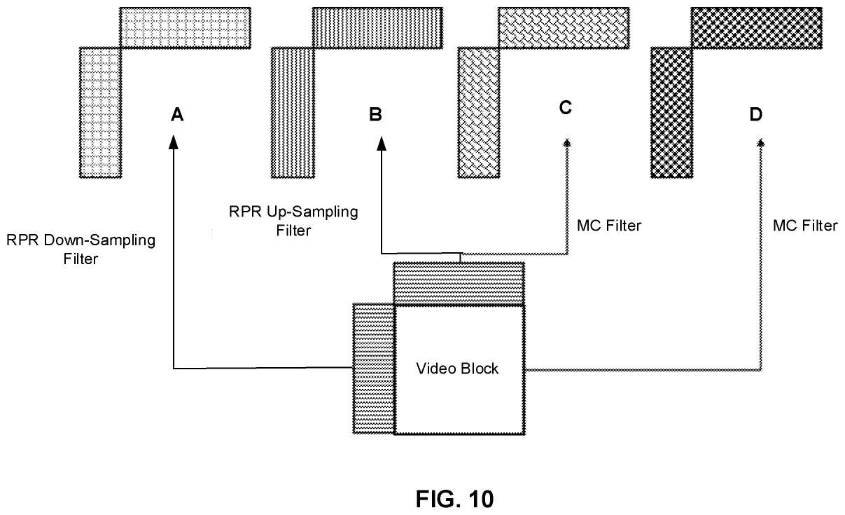

FIG. 13 is a flow chart of an exemplary method 1300 for video decoding based on template-based coding schemes in accordance with some implementations of the present disclosure. Method 1300 may be implemented by a processor associated with video decoder 30, and may include steps 1302-1316 as described below. Some of the steps may be optional to perform the disclosure provided herein. Further, some of the steps may be performed simultaneously, or in a different order than shown in FIG. 13.

In step 1302, as shown in FIG. 13, the processor may receive one or more MVD indices, one or more reference indices, and one or more merge indices from an encoder. For example, the processor may receive the one or more MVD indices, the one or more reference indices, and the one or more merge indices through a bitstream sent by the encoder.

In step 1304, as shown in FIG. 13, the processor may determine one or more MVDs based on the one or more MVD indices, respectively. In some implementations, operations like those described above with reference to template-based MVD prediction scheme 804 of FIG. 8 can be performed to determine the one or more MVDs based on the one or more MVD indices, respectively. The similar description will not be repeated herein.

In step 1306, as shown in FIG. 13, the processor may determine one or more MVPs based on the one or more merge indices, respectively. In some implementations, operations like those described above with reference to template-based merge index reordering scheme 808 of FIG. 8 can be performed to determine the one or more merge indices. The similar description will not be repeated herein.

In step 1308, as shown in FIG. 13, the processor may determine one or more motion vectors based on the one or more MVDs and the one or more MVPs, respectively.

In step 1310, as shown in FIG. 13, the processor may determine one or more reference frames based on the one or more reference indices, respectively. In some implementations, operations like those described above with reference to template-based reference index prediction scheme 806 of FIG. 8 can be performed to determine the one or more reference indices of the one or more reference frames, respectively. The similar description will not be repeated herein.

In step 1312, as shown in FIG. 13, the processor may determine RPR prediction samples for the video block based on the one or more motion vectors and the one or more reference frames. The processor may perform operations like those described above with reference to FIG. 8 to determine the RPR prediction samples, and the similar description will not be repeated herein.

In step 1314, as shown in FIG. 13, the processor may filter the RPR prediction samples based on a template-based adaptive filter to generate filtered RPR prediction samples for the video block. For example, template-based adaptive filtering scheme 802 described above with reference to FIG. 8 can be applied to generate the filtered RPR prediction samples for the video block, and the similar description will not be repeated herein.

In step 1316, as shown in FIG. 13, the processor may determine a predictive block including the filtered RPR prediction samples for the video block.

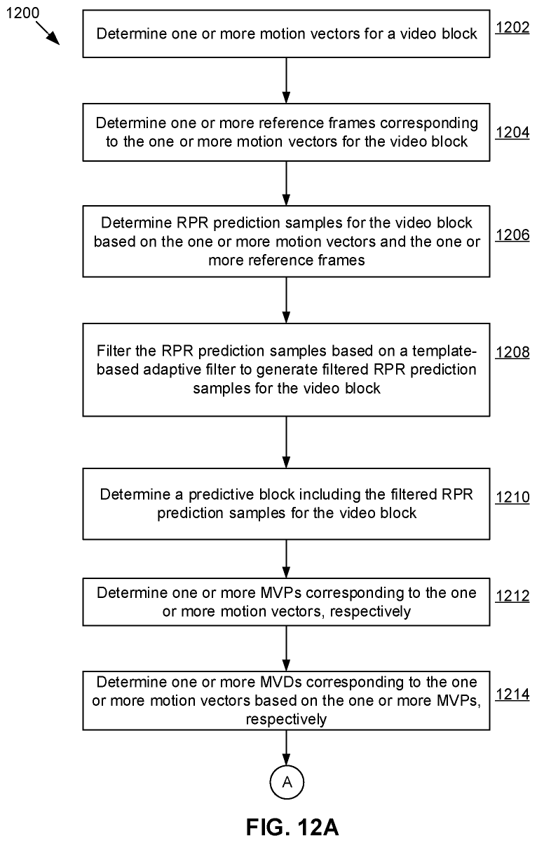

FIG. 15 shows a flow chart of another exemplary method 1500 for video encoding in accordance with some implementations of the present disclosure. Method 1500 may be implemented by a processor associated with video encoder 20, and may include steps 1502-1508 as described below. Some of the steps may be optional to perform the disclosure provided herein. Further, some of the steps may be performed simultaneously, or in a different order than shown in FIG. 15.

In step 1502, the processor may obtain RPR prediction samples for a video block from a video frame based on one or more coding parameters. For example, the one or more coding parameters may include one or more motion vectors for the video block and/or one or more reference frames corresponding to the one or more motion vectors. In another example, the one or more coding parameters may include one or more MVDs corresponding to the one or more motion vectors. The processor may perform operations like those described above with reference to FIG. 8 or FIGS. 12A-12B to determine the RPR prediction samples for the video block, and the similar description will not be repeated herein.

In some implementations, the GPM is applied in the video encoding. A split mode can be selected from a plurality of split mode candidates, and the one or more coding parameters may include the selected split mode. The video block can be divided into partitions (e.g., two partitions) based on the selected split mode. For each partition from the partitions, RPR prediction samples for the partition can be determined based on a motion vector associated with the partition and a reference index associated with the partition, where the reference index indicates a reference frame associated with the partition. For each partition, based on a resolution of the reference frame of the partition, different motion compensation (MC) filters may be applied to generate RPR prediction samples corresponding to the partition, as described above with reference to FIG. 8.

In step 1504, the processor may filter the RPR prediction samples by using a filter to generate filtered RPR prediction samples for the video block. The filter is adaptively determined based on the template of the video block. For example, the filter may be a template-based adaptive filter described above with reference to FIG. 8. The filtered RPR prediction samples may form a predictive block of the video block. In some implementations, the processor may perform operations like those described above with reference to FIG. 8 or FIGS. 12A-12B to generate the filtered RPR prediction samples for the video block, and the similar description will not be repeated herein.

For example, the processor may calculate filter coefficients for the filter by minimizing a difference between template samples of the video block and RPR prediction template samples of the video block. The processor may filter the RPR prediction samples of the video block to form the filtered RPR prediction samples. In some implementations, the filter coefficients may include a scaling factor and an offset.

In step 1506, the processor may process the one or more coding parameters using a template-based coding scheme to generate one or more syntax elements based on the template of the video block. In some implementations, the GPM is applied in the video encoding, and the one or more coding parameters include the selected split mode used in the GPM. The processor may use template-based GPM split mode reordering scheme 810 to determine a split mode index corresponding the selected split mode based on the template of the video block, by performing operations like those described above with reference to FIG. 8.

In some implementations, the one or more coding parameters may include one or more MVDs corresponding to one or more motion vectors, respectively. The processor may apply template-based MVD prediction scheme 804 to generate one or more MVD indices corresponding to the one or more MVDs based on the template of the video, by performing operations like those described above with reference to FIG. 8. The one or more MVD indices corresponding to the one or more MVDs may be example syntax elements signaled through the bitstream to video decoder 30.

For example, for each MVD corresponding to a motion vector, the processor may group a plurality of reference pictures of the video block based on their respective resolutions to form one or more groups, such that each group includes reference pictures from the plurality of reference pictures with a same resolution. The processor may determine, based on the template of the video block, first template costs associated with MVD candidates in each group, respectively. The processor may sort the MVD candidates in each group based on the first template costs to generate a corresponding first reordered group, so that one or more first reordered groups are generated for the one or more groups, respectively. The processor may combine the MVD candidates of the one or more first reordered groups into a first joint group based on a first criterion. The processor may determine an index of the MVD in the first joint group as an MVD index to be signaled to a decoder.

For example, to combine the MVD candidates of the one or more first reordered groups into the first joint group based on the first criterion, the processor may place a first one of the one or more first reordered groups in front of a second one of the one or more first reordered groups in the first joint group, when a resolution of reference pictures in the first one of the one or more first reordered groups is closer to a resolution of the video frame than a resolution of reference pictures in the second one of the one or more first reordered groups. For example, a difference between (a) the resolution of reference pictures in the first one of the one or more first reordered groups and (b) the resolution of the video frame is smaller than a difference between (c) the resolution of reference pictures in the second one of the one or more first reordered groups and (d) the resolution of the video frame.

In some implementations, the one or more coding parameters may include one or more reference frames corresponding to the one or more motion vectors, respectively. The processor may apply template-based reference index prediction scheme 806 to generate one or more reference indices corresponding to the one or more reference frames based on the template of the video block, by performing operations like those described above with reference to FIG. 8. The one or more reference indices corresponding to the one or more reference frames may be example syntax elements signaled through the bitstream to video decoder 30.

For example, for each reference frame corresponding to a motion vector, the processor may group the plurality of reference pictures of the video block based on their respective resolutions to form the one or more groups, such that each group includes reference pictures from the plurality of reference pictures with the same resolution. The processor may determine, based on the template of the video block, second template costs associated with reference picture candidates in each group, respectively. The processor may sort the reference picture candidates in each group based on the second template costs to generate a corresponding second reordered group, so that one or more second reordered groups are generated for the one or more groups, respectively. The processor may combine the reference picture candidates of the one or more second reordered groups into a second joint group based on a second criterion. The processor may determine an index of the reference frame in the second joint group as a reference index to be signaled to the decoder.

For example, to combine the reference picture candidates of the one or more second reordered groups into the second joint group based on the second criterion, the processor may place a first one of the one or more second reordered groups in front of a second one of the one or more second reordered groups in the second joint group, when a resolution of reference pictures in the first one of the one or more second reordered groups is closer to the resolution of the video frame than a resolution of reference pictures in the second one of the one or more second reordered groups.

In some implementations, the one or more coding parameters may include one or more motion vectors for the video block. The processor may apply template-based merge index reordering scheme 808 to generate one or more merge indices corresponding to the one or more motion vectors based on the template of the video block, by performing operations like those described above with reference to FIG. 8. The one or more merge indices may be example syntax elements signaled through the bitstream to video decoder 30.

For example, for each motion vector, the processor may determine, based on the template of the video block, template costs associated with merge candidates, respectively. The processor may sort the merge candidates based on the template costs to generate a reordered merge candidate list. The processor may determine an index of the motion vector in the reordered merge candidate list as a merge index to be signaled to a decoder.

In step 1508, the processor may generate the bitstream based on the filtered RPR prediction samples and the one or more syntax elements. For example, the processor may generate the bitstream by performing operations described above with reference to FIG. 2, and the similar description will not be repeated herein.

In some implementations, before step 1506, the processor may further enable the template-based coding scheme in the video encoding responsive to determining that an enabling condition is satisfied, by performing operations like those described above with reference to FIG. 8.

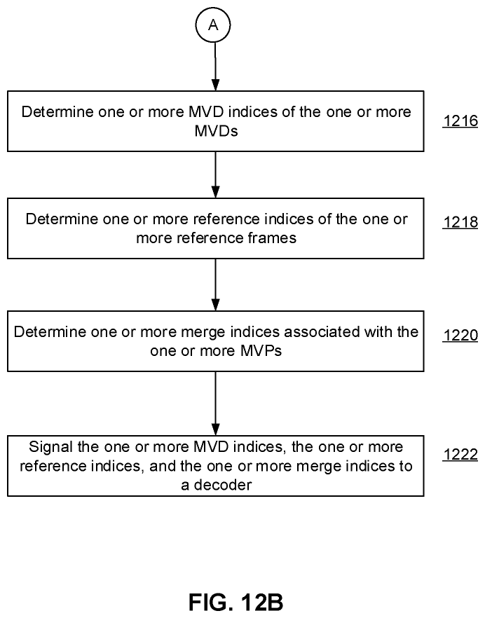

FIG. 16 is a flow chart of another exemplary method 1600 for video decoding in accordance with some implementations of the present disclosure. Method 1600 may be implemented by a processor associated with video decoder 30, and may include steps 1602-1606 as described below. Some of the steps may be optional to perform the disclosure provided herein. Further, some of the steps may be performed simultaneously, or in a different order than shown in FIG. 16.

In step 1602, the processor may apply a template-based coding scheme to derive one or more coding parameters associated with a video block from a video frame based on a template of the video block. For example, the processor may apply the template-based coding scheme to derive the one or more coding parameters based on the template of the video block and one or more syntax elements signaled through a bitstream by video encoder 20. The template-based coding scheme can be template-based MVD prediction scheme 804, template-based reference index prediction scheme 806, template-based merge index reordering scheme 808, or template-based GPM split mode reordering scheme 810.

In some implementations, the GPM is applied in the video decoding. The processor may apply template-based GPM split mode reordering scheme 810 to determine a split mode based on the template of the video block and a split mode index signaled by video encoder 20, by performing operations like those described above with reference to FIG. 8. The split mode index is an example syntax element in the bitstream signaled by video encoder 20. The one or more coding parameters may include the split mode.

In some implementations, the one or more coding parameters may include one or more MVDs corresponding to one or more motion vectors, respectively. The processor may apply template-based MVD prediction scheme 804 to determine the one or more MVDs based on the template of the video block and one or more MVD indices signaled by video encoder 20, by performing operations like those described above with reference to FIG. 8.

For example, the processor may group a plurality of reference pictures of the video block based on their respective resolutions to form one or more groups, such that each group includes reference pictures from the plurality of reference pictures with a same resolution. The processor may determine, based on the template of the video block, first template costs associated with MVD candidates in each group, respectively. The processor may sort the MVD candidates in each group based on the first template costs to generate a corresponding first reordered group, so that one or more first reordered groups are generated for the one or more groups, respectively. The processor may combine the MVD candidates of the one or more first reordered groups into a first joint group based on a first criterion. The processor may select an MVD candidate from the first joint group as an MVD based on an MVD index signaled by the encoder.

For example, to combine the MVD candidates of the one or more first reordered groups into the first joint group based on the first criterion, the processor may place a first one of the one or more first reordered groups in front of a second one of the one or more first reordered groups in the first joint group, when a resolution of reference pictures in the first one of the one or more first reordered groups is closer to a resolution of the video frame than a resolution of reference pictures in the second one of the one or more first reordered groups. For example, a difference between (a) the resolution of reference pictures in the first one of the one or more first reordered groups and (b) the resolution of the video frame is smaller than a difference between (c) the resolution of reference pictures in the second one of the one or more first reordered groups and (d) the resolution of the video frame.

In some implementations, the one or more coding parameters may include one or more reference frames corresponding to the one or more motion vectors, respectively. The processor may apply template-based reference index prediction scheme 806 to determine the one or more reference frames based on the template of the video block and one or more reference indices signaled by video encoder 20, by performing operations like those described above with reference to FIG. 8.

For example, the processor may group a plurality of reference pictures of the video block based on their respective resolutions to form one or more groups, such that each group includes reference pictures from the plurality of reference pictures with the same resolution. The processor may determine, based on the template of the video block, second template costs associated with reference picture candidates in each group, respectively. The processor may sort the reference picture candidates in each group based on the second template costs to generate a corresponding second reordered group, so that one or more second reordered groups are generated for the one or more groups, respectively. The processor may combine the reference picture candidates of the one or more second reordered groups into a second joint group based on a second criterion. The processor may select a reference picture candidate from the second joint group as a reference frame based on a reference index signaled by the encoder.

For example, to combine the reference picture candidates of the one or more second reordered groups into the second joint group based on the second criterion, the processor may place a first one of the one or more second reordered groups in front of a second one of the one or more second reordered groups in the second joint group, when a resolution of reference pictures in the first one of the one or more second reordered groups is closer to the resolution of the video frame than a resolution of reference pictures in the second one of the one or more second reordered groups.

In some implementations, the one or more coding parameters may include one or more motion vectors for the video block. The processor may apply template-based merge index reordering scheme 808 to determine the one or more motion vectors based on the template of the video block and one or more merge indices signaled by video encoder 20, by performing operations like those described above with reference to FIG. 8.

For example, the processor may determine, based on the template of the video block, template costs associated with merge candidates, respectively. The processor may sort the merge candidates based on the template costs to generate a reordered merge candidate list. The processor may select a merge candidate from the reordered merge candidate list as a motion vector based on a merge index signaled by the encoder.

In step 1604, the processor may generate RPR prediction samples for the video block based on the one or more coding parameters. For example, the one or more coding parameters may include one or more motion vectors for the video block and/or one or more reference frames corresponding to the one or more motion vectors. In another example, the one or more coding parameters may include one or more MVDs corresponding to the one or more motion vectors. The processor may perform operations like those described above with reference to FIG. 8 or FIG. 13 to determine the RPR prediction samples for the video block, and the similar description will not be repeated herein.

In some implementations, the GPM is applied in the video decoding. The one or more coding parameters may include the split mode used in the GPM. The video block can be divided into partitions (e.g., two partitions) based on the split mode. For each partition from the partitions, RPR prediction samples for the partition can be determined based on a motion vector associated with the partition and a reference index associated with the partition, where the reference index indicates a reference frame associated with the partition. The RPR prediction samples of all the partitions may form the RPR prediction samples of the video block.

In step 1606, the processor may filter the RPR prediction samples of the video block using a filter to generate filtered RPR prediction samples for the video block. The filter is adaptively determined based on the template of the video block. For example, the filter may be a template-based adaptive filter described above with reference to FIG. 8. The filtered RPR prediction samples may form a predictive block of the video block. In some implementations, the processor may perform operations like those described above with reference to FIG. 8 or FIG. 13 to generate the filtered RPR prediction samples for the video block, and the similar description will not be repeated herein.

In some implementations, before step 1602, the processor may further enable the template-based coding scheme in the video decoding responsive to determining that an enabling condition is satisfied, by performing operations like those described above with reference to FIG. 8.

Some embodiments of this disclosure are to further enhance the inter coding efficiency by applying adaptive enhancement filters on the motion compensated prediction signals of bi-predicted blocks. Some embodiments of the present disclosure are to further enhance the chroma coding efficiency of the motion compensation module that is applied in the ECM. In the following, some related coding tools that are applied in the transform and entropy coding process in the ECM are briefly reviewed. After that, some deficiencies in the existing design of motion compensation are discussed. Finally, the solutions are provided to improve the existing design.

### Motion Compensated Prediction (MCP)

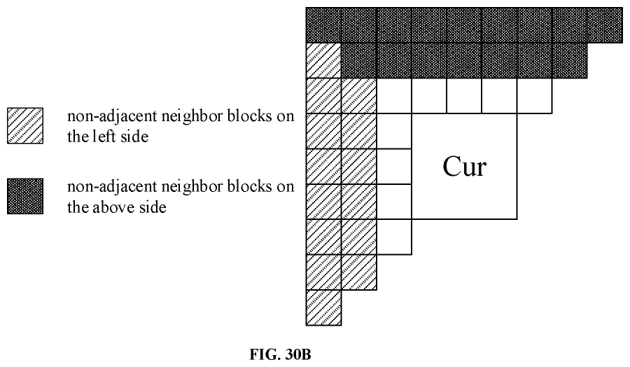

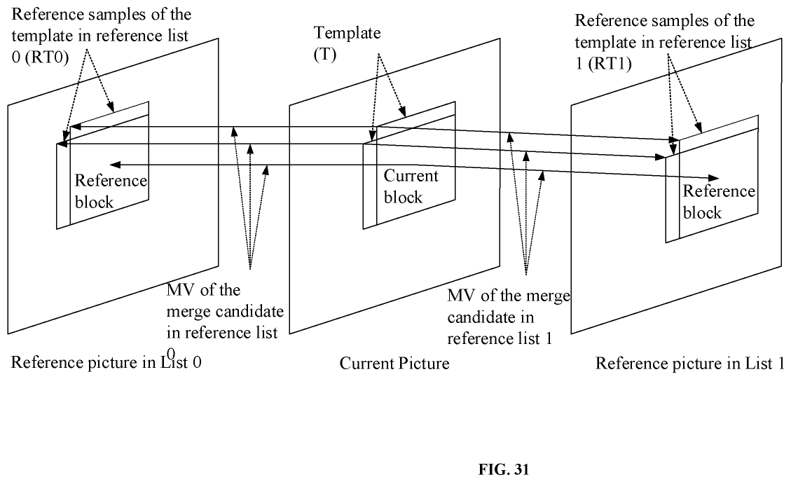

Motion compensated prediction (MCP), which is also known as motion compensation in short, is one of the most widely used video coding techniques in the development of the modern video coding standards. In the MCP, one video frame is partitioned into multiple blocks (which are called prediction unit (PU)). Each PU is predicted from a block in the equal size from one temporal reference picture such that the overhead that is needed to signal the block is significantly reduced. In all the existing video coding standards, each inter PU is associated with a set of motion parameters which consist of one or two MVs and reference picture indices. The inter PUs in a P slice only have one reference picture list while the PUs in a B slice may use up to two reference picture lists. In the MCP, the corresponding inter prediction samples are generated from its corresponding region in the reference picture as identified by the MV and the reference picture index. The MV specifies the horizontal and vertical displacement between the current block and its reference block in the reference picture. FIGS. 30A-30B show one example where dx and dy are the horizontal and vertical values of the MV. In practice, the value of one MV may be in fractional precisions. When one MV has one fractional value, interpolation filters are applied to generate the corresponding prediction samples at fractional sample positions, as illustrated in FIG. 31. In the VVC, it supports MVs with the unit of 1/16 of the distance between two neighboring luma samples for the luma MC and 1/32 of the distance of two neighboring chroma samples for the chroma MC.

### Adaptive Loop Filtering

In the VVC and ECM, adaptive loop filtering (ALF) where one among 25 filters is selected for each 4×4 block based on the direction and activity of local gradients.

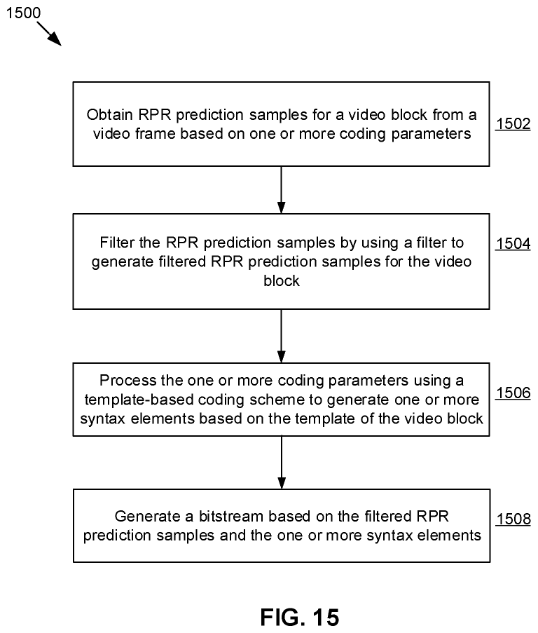

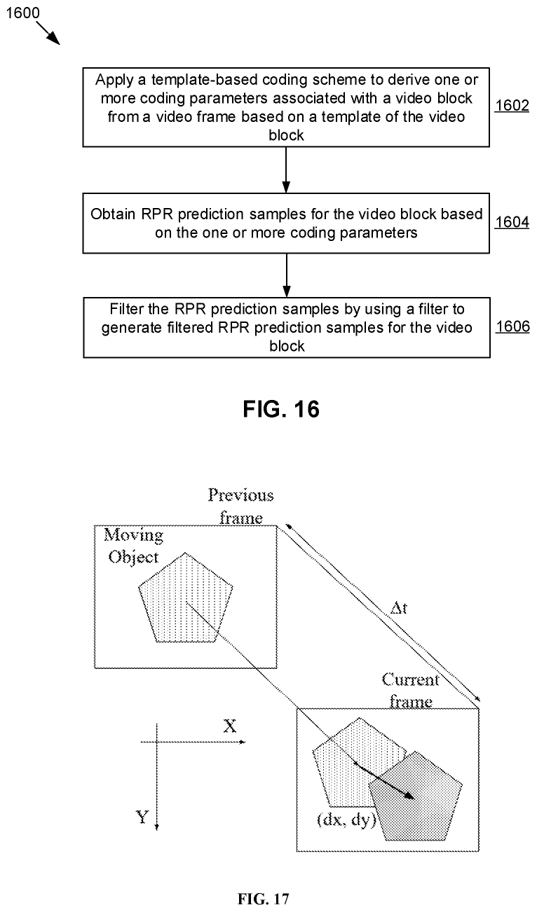

Filter shape: Two diamond filter shapes (as shown in FIGS. 19A-19B) are used. The 7×7 diamond shape is applied for luma component and the 5×5 diamond shape is applied for chroma components.

Block classification: For luma component, each 4×4 block is categorized into one out of 25 classes. The classification index C is derived based on its directionality D and a quantized value of activity Â, as follows:

$$C = 5 D + \hat{A} \qquad ( 4 )$$

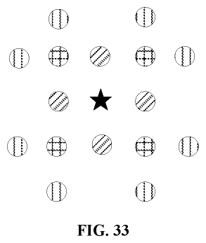

To calculate D and Â, gradients of the horizontal, vertical and two diagonal directions are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert \qquad ( 5 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert$$

where indices i and j refer to the coordinates of the upper left sample within the 4×4 block and R(i,j) indicates a reconstructed sample at coordinate (i,j). To reduce the complexity of block classification, shown in FIG. 33, the subsampled 1-D Laplacian calculation is applied for the gradient calculations in all the directions.

Then, D maximum and minimum values of the gradients of horizontal and vertical directions are set as:

$${g}_{h , v}^{max} = max ( {g}_{h} , {g}_{v} ) {g}_{h , v}^{min} = min ( {g}_{h} , {g}_{v} ) \qquad ( 6 )$$

The maximum and minimum values of the gradient of two diagonal directions are set as:

$${g}_{d 0 , d 1}^{max} = max ( {g}_{d 0} , {g}_{d 1} ) {g}_{d 0 , d 1}^{min} = min ( {g}_{d 0} , {g}_{d 1} ) \qquad ( 7 )$$

To derive the value of the directionality D, these values are compared against each other and with two thresholds t₁ and t₂:

Step 1. If both

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min}$$

are true, D is set to 0.

Step 2. If

$${g}_{h , v}^{max} / {g}_{h , v}^{min} > {g}_{d 0 , d 1}^{max} / {g}_{d 0 , d 1}^{min}$$

inue from Step 3; otherwise continue from Step 4.

Step 3. If

$${g}_{h , v}^{max} > {t}_{2} \cdot {g}_{h , v}^{min} s$$

set to 2; otherwise D is set to 1.

Step 4. If

$${g}_{d 0 , d 1}^{max} > {t}_{2} \cdot {g}_{d 0 , d 1}^{min} s$$

set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) \qquad ( 8 )$$

A is further quantized to the range of 0 to 4, inclusively, and the quantized value is denoted as Â. For chroma components in a picture, no classification method is applied.

### Geometric Transformations of Filter Coefficients and Clipping Values

Before filtering each 4×4 luma block, geometric transformations such as rotation or diagonal and vertical flipping are applied to the filter coefficients f(k,l) and to the corresponding filter clipping values c(k,l) depending on gradient values calculated for the block. This is equivalent to applying these transformations to the samples in the filter support region. The idea is to make different blocks to which ALF is applied more similar by aligning their directionality.

Three geometric transformations, including diagonal, vertical flip and rotation are provided:

$$Diagonal : {f}_{D} ( k , l ) = f ( l , k ) , {c}_{D} ( k , l ) = c ( l , k ) , \qquad ( 9 )$$

$$Vertical flip : {f}_{V} ( k , l ) = f ( k , K - l - 1 ) , {c}_{V} ( k , l ) = c ( k , K - l - 1 )$$

$$Rotation : {f}_{R} ( k , l ) = f ( K - l - 1 , k ) , {c}_{R} ( k , l ) = c ( K - l - 1 , k )$$

where K is the size of the filter and 0≤k, l≤K−1 are coefficients coordinates, such that location (0,0) is at the upper left corner and location (K−1, K−1) is at the lower right corner. The transformations are applied to the filter coefficients f(k,l) and to the clipping values c(k,l) depending on gradient values calculated for that block. The relationship between the transformation and the four gradients of the four directions are summarized in the following Table 8.

TABLE 8

| Gradient values | Transformation |
|---|---|
| gd2 < gd1 and gh < gv | No transformation |
| gd2 < gd1 and gv < gh | Diagonal |
| gd1 < gd2 and gh < gv | Vertical flip |
| gd1 < gd2 and gv < gh | Rotation |

### Filter Process

When ALF is enabled for a CTB, each sample R(i,j) within the CU is filtered, resulting in sample value R′(i,j) as shown below,

$${R}^{′} ( i , j ) = R ( i , j ) + ( ( {\sum }_{k \neq 0} {\sum }_{l \neq 0} f ( k , l ) \times Clip 3 ( R ( i + k , j + l ) - R ( i , j ) , c ( k , l ) ) + 64 ) ≫ 7 ) \qquad ( 10 )$$

where f(k,l) denotes the decoded filter coefficients, K(x,y) is the clipping function and c(k,l) denotes the decoded clipping parameters. The variable k and 1 are between

$$- \frac{L}{2} and \frac{L}{2}$$

where L denotes the filter length. Clip3 (−y,y,x) is the clipping function which clips the input value of x to the range [−y, y]. The clipping operation introduces non-linearity to make ALF more efficient by reducing the impact of neighbor sample values that are too different with the current sample value.

### Local Illumination Compensation

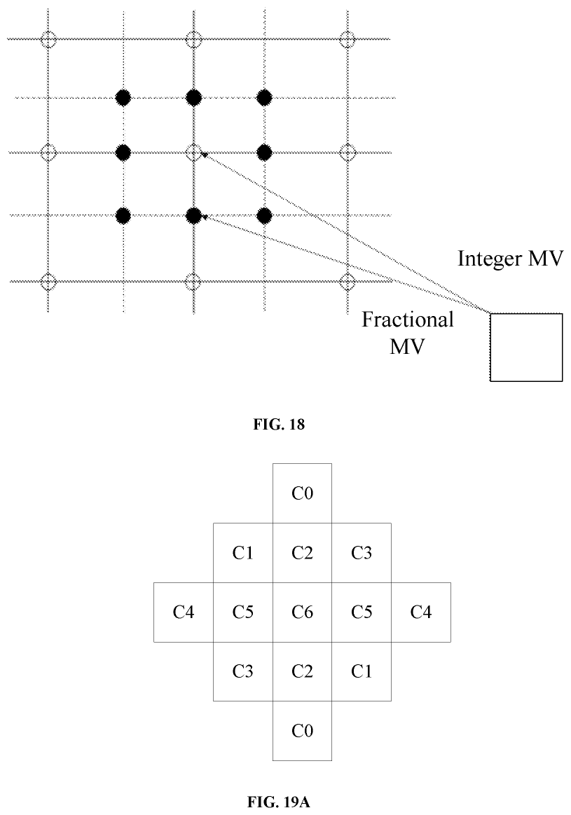

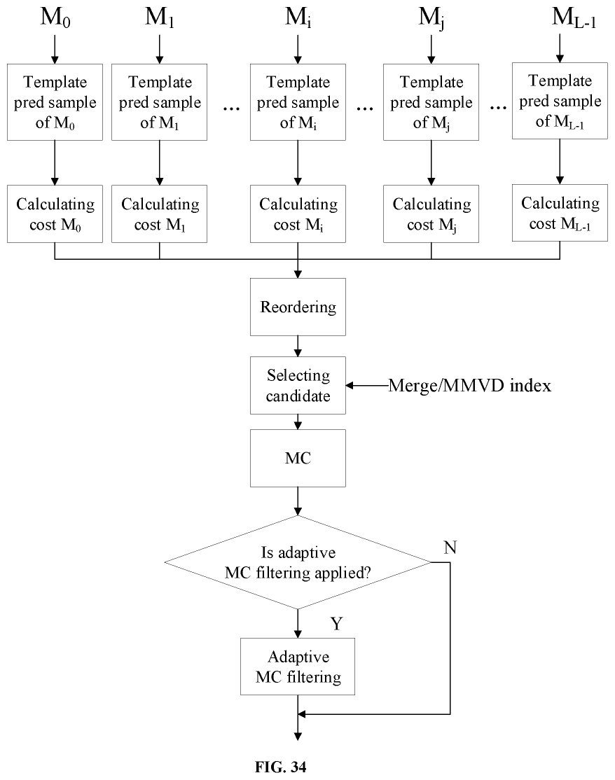

Local illumination compensation (LIC) is a coding tool which was studied during the VVC development, which targets at resolving the local illumination changes that exist temporal neighboring pictures. The LIC is based on a linear model where a scaling factor and an offset are derived for enhancing the prediction samples of a current block. Specifically, the LIC can be mathematically modeled by the following equation:

$$P ( x , y ) = α \cdot {P}_{r} ( x + {v}_{x} , y + {v}_{y} ) + β \qquad ( 11 )$$

where P(x,y) is the prediction signal of the current block at the coordinate (x,y); Pᵣ(x+vₓ,y+v_{y}) is the prediction block generated based on the motion vector (vₓ,v_{y}); α and β are the corresponding scaling factor and offset. FIG. 34 illustrates the LIC process. As shown in FIG. 21, when the LIC is applied for a video block, one linear model (i.e., scaling factor α and the offset β) are derived by minimizing the difference between the neighboring samples of the current block (i.e., the template in FIG. 34) and their corresponding prediction samples (i.e, the template prediction in FIG. 34).

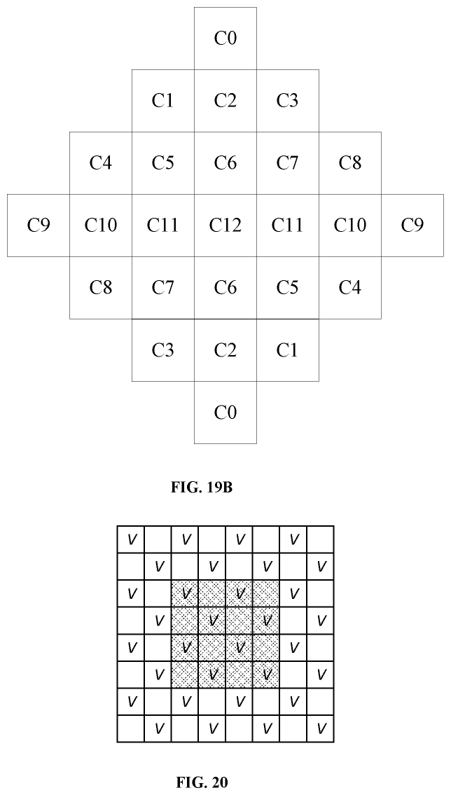

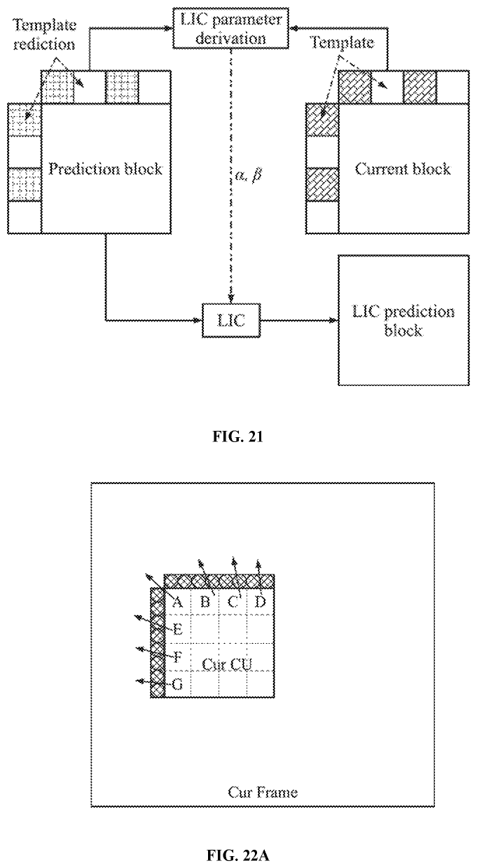

Because the scaling factor and the offset are derived based on the current block and template and its corresponding prediction signal, no signaling overhead of the LIC parameters is required. Additionally, one LIC flag is signaled for one no-merge inter block to indicate whether the LIC mode is enabled for the block or not. For merge inter blocks, the LIC flag is treated as a part of motion information. Specifically, when merge list is built up, the LIC flag is inherited from that of its corresponding neighboring block besides the MVs and the reference indices. Meanwhile, the LIC mode is also applied to affine inter blocks. When the affine mode is applied, one inter block is divided into multiple subblocks and one specific MV is derived for each subblock based on the affine model. Given such design, when the LIC is applied to one affine block, the corresponding LIC parameters are derived based on the motion information of the subblocks on the top and left boundaries of the block; then, the derived LIC model is applied to the prediction samples of the whole block, as shown in FIGS. 22A-22B. Due to the fact that the MVs of each boundary subblock may be different, the prediction signal of the template is also generated on the subblock basis and the prediction samples of each template subblock are generated by using the MV of the corresponding subblock on the boundary of the coding block.

At last, it is mentioned that in the current LIC design, the LIC is only applicable to the uni-predicted inter blocks.

Bi-Prediction with CU-Level Weight

In HEVC, the bi-prediction signal is generated by averaging two prediction signals obtained from two different reference pictures and/or using two different motion vectors. In the VVC, the bi-prediction mode is extended beyond simple averaging to allow weighted averaging of the two prediction signals, i.e.,

$${P}_{b i - p r e d} = ( ( 8 - w ) * {P}_{0} + w * {P}_{1} + 4 ) ≫ 3 \qquad ( 12 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signaled; 2) for a merge CU, the weight index is inherited from one of neighboring blocks based on the merge candidate index. Additionally, in the VVC, for low-delay pictures (i.e., all the reference pictures are prior to the current picture in display order), all 5 weights are used. Otherwise, for non-low-delay pictures (there is at least one reference picture which is after the current picture in display order), only 3 weights (w∈{3,4,5}) are used.

### Overlapped Block Motion Compensation

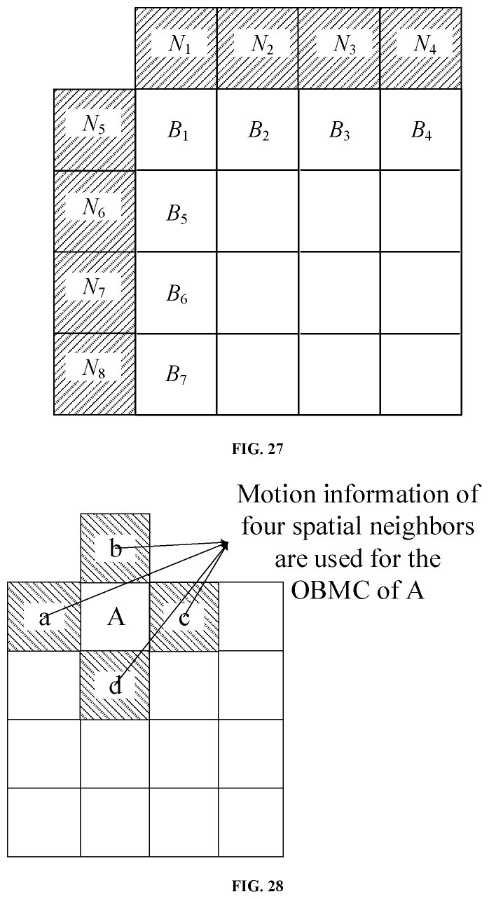

The OBMC is a coding technique to remove the blocking artifact at the MC stage. The basic idea of the OBMC is to use the MVs from the neighbor blocks to perform the motion compensation on the current block and combine the multiple prediction signals using the neighboring MVs to generate the final prediction signal of the CU. For each inter CU, the OBMC is performed for the top and left boundaries of the block. Additionally, when one video block is coded in one sub-block mode (e.g., affine, ATMVP or DMVR), the OBMC is also performed on all the inner boundaries (i.e., top, left, bottom, and right boundaries) of each sub-block. FIG. 28 illustrates the OBMC process that is applied to the CUs without sub-block-level motion compensation. When the OBMC is applied to one sub-block (e.g., the sub-block A in FIG. 15), in addition to the left and top neighbors of one sub-block, the MVs of the neighboring sub-blocks that are to the right and bottom of the current sub-block are also used to derive the prediction signals; then, the four prediction blocks are averaged to generate the final prediction signal of the current sub-block.

In the current ECM software, one template-based OBMC scheme is applied. Specifically, instead of using fixed weights for the combination of multiple motion-compensated hypotheses, the prediction value of CU boundary samples derivation approach is determined according to the template matching costs, including using current block's motion information only, or using neighboring block's motion information as well with one of the blending modes.

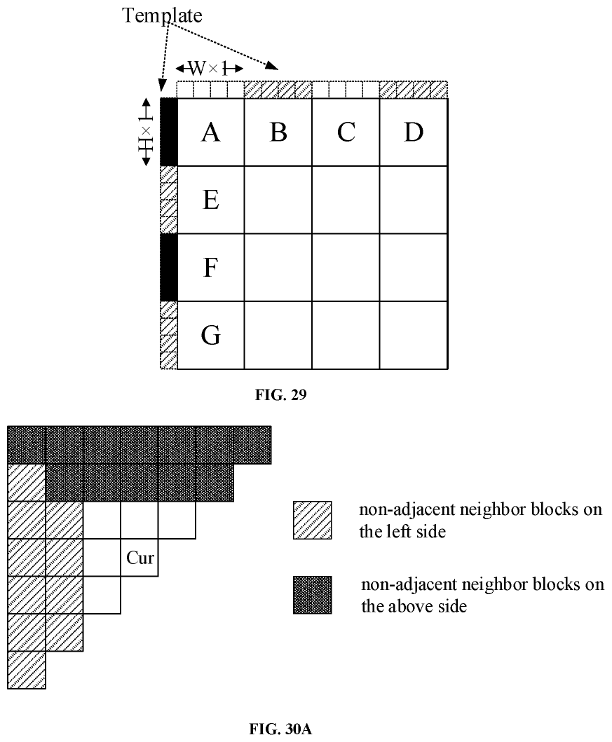

In this scheme for each block with a size of 4×4 at the top CU boundary, the above template size equals to 4×1. If N adjacent blocks have the same motion information, then the above template size is enlarged to 4N×1 since the MC operation can be processed at one time. For each left block with a size of 4×4 at the left CU boundary, the left template size equals to 1×4 or 1×4N (as shown in FIG. 29).

For each 4×4 top block (or N 4×4 blocks group), the prediction value of boundary samples is derived following the steps below.

Take block A as the current block and its above neighboring block AboveNeighbor_A for example. The operation for left blocks is conducted in the same manner.

First, three template matching costs (Cost1, Cost2, Cost3) are measured by SAD between the reconstructed samples of a template and its corresponding reference samples derived by MC process according to the following three types of motion information:

Cost1 is calculated according to A's motion information.

Cost2 is calculated according to AboveNeighbor_A's motion information.

Cost3 is calculated according to weighted prediction of A's and AboveNeighbor_A's motion information with weighting factors as ¾ and ¼ respectively.

Second, choose one approach to calculate the final prediction results of boundary samples by comparing Cost1, Cost2, and Cost 3.

The original MC result using current block's motion information is denoted as Pixel1, and the MC result using neighboring block's motion information is denoted as Pixel2. The final prediction result is denoted as NewPixel.

If Cost1 is minimum, then NewPixel(i,j)=Pixel1(i,j).

If (Cost2+(Cost2>>2)+(Cost2>>3))<=Cost1, then blending mode 1 is used.

For luma blocks, the number of blending pixel rows is 4.

$$NewPixel ( i , 0 ) = ( 26 \times Pixel 1 ( i , 0 ) + 6 \times Pixel 2 ( i , 0 ) + 16 ) ≫ 5$$

$$NewPixel ( i , 1 ) = ( 7 \times Pixel 1 ( i , 1 ) + Pixel 2 ( i , 1 ) + 4 ) ≫ 3$$

$$NewPixel ( i , 2 ) = ( 15 \times Pixel 1 ( i , 2 ) + Pixel 2 ( i , 2 ) + 8 ) ≫ 4$$

$$NewPixel ( i , 3 ) = ( 31 \times Pixel 1 ( i , 3 ) + Pixel 2 ( i , 3 ) + 16 ) ≫ 5$$

For chroma blocks, the number of blending pixel rows is 1.

$$NewPixel ( i , 0 ) = ( 26 \times Pixel 1 ( i , 0 ) + 6 \times Pixel 2 ( i , 0 ) + 16 ) ≫ 5$$

If Cost1<=Cost2, then blending mode 2 is used.

For luma blocks, the number of blending pixel rows is 2.

$$NewPixel ( i , 0 ) = ( 15 \times Pixel 1 ( i , 0 ) + Pixel 2 ( i , 0 ) + 8 ) ≫ 4$$

$$NewPixel ( i , 1 ) = ( 31 \times Pixel 1 ( i , 1 ) + Pixel 2 ( i , 1 ) + 16 ) ≫ 5$$

For chroma blocks, the number of blending pixel rows/columns is 1.

$$NewPixel ( i , 0 ) = ( 15 \times Pixel 1 ( i , 0 ) + Pixel 2 ( i , 0 ) + 8 ) ≫ 4$$

Otherwise, blending mode 3 is used.

For luma blocks, the number of blending pixel rows is 4.

$$NewPixel ( i , 0 ) = ( 26 \times Pixel 1 ( i , 0 ) + 6 \times Pixel 2 ( i , 0 ) + 16 ) ≫ 5$$

$$NewPixel ( i , 1 ) = ( 7 \times Pixel 1 ( i , 1 ) + Pixel 2 ( i , 1 ) + 4 ) ≫ 3$$

$$NewPixel ( i , 2 ) = ( 15 \times Pixel 1 ( i , 2 ) + Pixel 2 ( i , 2 ) + 8 ) ≫ 4$$

$$NewPixel ( i , 3 ) = ( 31 \times Pixel 1 ( i , 3 ) + Pixel 2 ( i , 3 ) + 16 ) ≫ 5$$

For chroma blocks, the number of blending pixel rows is 1.

$$NewPixel ( i , 0 ) = ( 7 \times Pixel 1 ( i , 0 ) + Pixel 2 ( i , 0 ) + 4 ) ≫ 3$$

Adaptive Reordering of Merge Candidates with Template Matching

In the ECM, one reordering tool, which is called adaptive reordering of merge candidates with template matching (ARMC) is applied for the merge modes of inter coding. When the method is applied, merge candidates are adaptively sorted according to template matching (TM) costs. The method is applied to both regular merge mode and affine merge mode.

Specifically, in the ARMC design, an initial merge candidate list is firstly constructed which includes a number of merge candidates, for instance, spatial, TMVPs, non-adjacent, HMVPs, pairwise merge candidates. Then the candidates in the initial list are divided into one or more subgroups. Merge candidates in each subgroup are reordered to generate a reordered merge candidate list according to cost values based on template matching. Then, the index of selected merge candidate in the reordered merge candidate list is signaled from encoder to the decoder.

The template matching cost of a merge candidate during the reordering process is measured by the SAD between samples of a template of the current block and their corresponding reference samples. The template comprises a set of reconstructed samples neighboring to the current block. Reference samples of the template are located by the motion information of the merge candidate. When a merge candidate utilizes bi-directional prediction, the reference samples of the template of the merge candidate are also generated by bi-prediction as shown in FIG. 31.

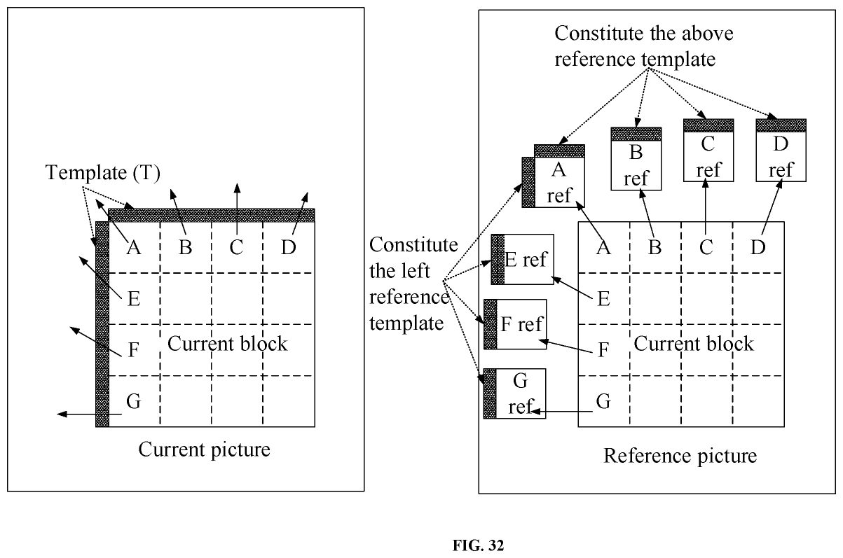

For affine mode, because different subblock may represent varying motion vectors, the prediction samples of the template are generated based on subblock-based motion compensation. Specifically, as illustrated in FIG. 32, assuming a subblock-based affine merge candidate with subblock size equal to Wsub×Hsub, the above template comprises several sub-templates with the size of Wsub×1, and the left template comprises several sub-templates with the size of 1×Hsub. The motion information of the subblocks in the first row and the first column of current block is used to derive the reference samples of each sub-template.

Template Matching Based Merge Mode with MVD

In addition to merge mode, where the implicitly derived motion information is directly used for prediction samples generation of the current CU, the merge mode with motion vector differences (MMVD) is applied to both regular merge mode and affine merge mode. For the signaling, one MMVD flag is signaled right after sending a regular merge flag to specify whether MMVD mode is used for a CU. In the ECM, 16 refinement positions along k×π/8 diagonal angles are defined for the MMVD mode as specified in FIG. 33. Additionally, the first N motion candidates in the candidate list before being reordered are utilized as the base candidates for MMVD and affine MMVD. N is equal to 3 for MMVD, and 1 or 3 depending on the neighboring block affine flags for affine MMVD. Two ways of adding MMVD offsets are allowed when one based candidate is bi-predicted, including the ‘two-side’ and ‘one-side’. In the ‘two-side’ MMVD mode, the same selected MMVD offset (or its opposite) is applied to both L0 and L1 MVs of the candidate depending on whether the relationship of the POCs of the current picture and its reference pictures in L0 and L1. In the ‘one-side’ MMVD mode, the selected MMVD offset is only applied to the MV in one reference picture list (either L0 and L1) while the MV in the other reference list is kept unchanged. Correspondingly, based on the such design, there are in total 16×6×3=288 refinement positions for the MMVD mode. In order to saving the signaling overhead, all the possible 288 refinement positions are reordered based on the SAD cost between the template (one row above and one column left to the current block) and its reference for each refinement position and only the first 36 refinement positions after the reordering are allowed to be selected as indicated by one MMVD index in bitstream.

### AMVP-Merge Mode

In the ECM, one new bidirectional coding mode is introduced, which is composed of an advanced motion vector prediction (AMVP) predictor in one direction and a merge predictor in the other direction. The mode can be enabled to a coding block when the selected merge predictor and the AMVP predictor satisfy the condition that one reference picture from the past and one reference picture from the future relatively to the current picture and the distances from two reference pictures to the current picture are the same. If bilateral matching is enabled, the bilateral matching MV refinement is applied for the merge MV candidate and AMVP MVP as a starting point. Otherwise, if template matching is enabled, template matching MV refinement is applied to the merge predictor or the AMVP predictor depending which has a higher template matching cost.

AMVP part of the mode is signaled as a regular uni-directional AMVP, i.e. reference index and MVD are signaled, and it has a derived MVP index if template matching is used or MVP index is signaled when template matching is disabled.

For AMVP direction LX, X can be 0 or 1, the merge part in the other direction (1−LX) is implicitly derived by minimizing the bilateral matching cost between the AMVP predictor and a merge predictor, i.e., for a pair of the AMVP and a merge motion MVs. For every merge candidate in the merge candidate list which has that other direction (1−LX) motion vector, the bilateral matching cost is calculated using the merge candidate MV and the AMVP MV. The merge candidate with the smallest cost is selected. The bilateral matching refinement is applied to the coding block with the selected merge candidate MV and the AMVP MV as a starting point.

The new bidirectional coding mode is indicated by a flag, if the mode is enabled AMVP direction LX is further indicated by another flag.

When bilateral matching (BM) AMVP-merge mode is used for the current block and template matching is enabled, MVD is not signalled. An additional pair of AMVP-merge MVPs is introduced. The merge candidate list is sorted based on the BM cost in increase order. An index (0 or 1) is signaled to indicate which merge candidate in the sorted merge candidate list to use. When there is only one candidate in merge candidate list, the pair of AMVP MVP and merge MVP without bilateral matching MV refinement is padded.

### Combined Intra-Inter Prediction

In the VVC, when a CU is coded in a merge mode, if the CU contains at least 64 luma samples (that is, a width of CU times a height of the CU is equal to or larger than 64), and

if both the width and the height of the CU are less than 128 luma samples, an additional flag is sent to indicate if a combined intra-inter prediction (CIIP) mode is applied to the current CU. In the CIIP mode, a prediction signal is obtained by combining an inter prediction signal with an intra prediction signal.

The inter prediction signal in the CIIP mode is derived using the same inter prediction process as that applied in the regular merge mode; and the intra prediction signal in the CIP mode is derived following the regular intra prediction process with a planar mode. Then, the intra prediction signal and the inter prediction signal are combined using weighted averaging, where a weight value is calculated depending on coding modes of top and left neighboring blocks of the current CU as follows:

If the top neighboring block is available and is intra coded, then isIntraTop is set to 1, otherwise isIntraTop is set to 0; If the left neighboring block is available and is intra coded, then isIntraLeft is set to 1, otherwise isIntraLeft is set to 0; If (isIntraLeft+isIntraTop) is equal to 2, then the weight value is set to 3; Otherwise, if (isIntraLeft+isIntraTop) is equal to 1, then the weight value is set to 2; Otherwise, the weight value is set to 1. The prediction signal is derived as follows:

$$P r e {d}_{ciip} = ( ( 4 - w t ) * {P}_{inter} + w t * {P}_{intra} + 2 ) ≫ 2$$

where Pᵢₙₜₑᵣ is the inter prediction signal in the CIIP mode, Pᵢₙₜᵣₐ is the intra prediction signal in the CIIP mode, wt is the weight value, and >> represents a right shift operation. Additionally, when the LIC is enabled, the generation of the inter prediction samples for the CIP mode always bypass the LIC process, i.e., the scaling and offset are not applied to adjust the inter prediction samples before the blending of the inter and intra prediction samples.

The MCP plays the key role to ensure the efficiency of inter coding in all the existing video coding standards. With the MCP, the video signal to be coded is predicted from temporally neighboring signal and only the prediction error, the MVs and the reference picture indices are transmitted. As analyzed before, the ALF can effectively increase the quality of reconstructed video, thus improving the performance of inter coding by providing high-quality reference pictures. The LIC can be considered as one enhancement of the regular motion-compensated prediction. Though both two tools can enhance the inter coding efficiency, the quality of temporal prediction still may not be good enough, due to the following reasons

Video signal may be coded with coarse quantization, i.e., high quantization parameter (QP) values. When coarse quantization is applied, the reconstructed picture may contain severe coding artifacts such as blocking artifacts, ringing artifacts, etc. Given that the reconstructed signal of the current picture will be used as reference for temporal prediction, such distortion could reduce the effective of MCP and therefore inter coding efficiency for subsequent pictures.

Though the LIC can efficiently compensate the illumination changes between different pictures, it can only be applied to uni-predicted blocks. It is well known that the combination of multiple prediction blocks can efficiently suppress the coding noise (which is caused by the quantization/dequantization process) that exists in motion compensated signals. Therefore, bi-prediction is generally more compression efficient than uni-prediction, i.e., there are more bi-predicted blocks than uni-predicted blocks. This means that the unidirectional LIC cannot fully exploit the coding gain that the LIC tool can potentially achieve.

According to the existing OBMC design in ECM, the OBMC is always disabled for the inter CUs that are coded with the LIC. Such design is suboptimal in terms of the coding efficiency given that there are also blocking artifacts that exists in-between inter blocks that are coded with and without the LIC being applied. Furthermore, even for the case where the LIC is applied to both of two neighboring blocks, there could be potentially blocking artifacts along the block boundaries of two blocks because the LIC parameters that are applied to the two blocks could be different.

In this disclosure, methods and devices are proposed to improve the efficiency of motion compensation and therefore enhance the quality of temporal prediction. Specifically, it is proposed to apply adaptive filtering at the prediction samples of bi-predicted blocks. To reduce the signaling overhead, the filter coefficients are derived from the neighboring reconstructed samples (i.e., template) of the current block and its corresponding prediction samples. By such way, the energy of prediction residuals is alleviated, thus reducing the overhead of residual signaling.

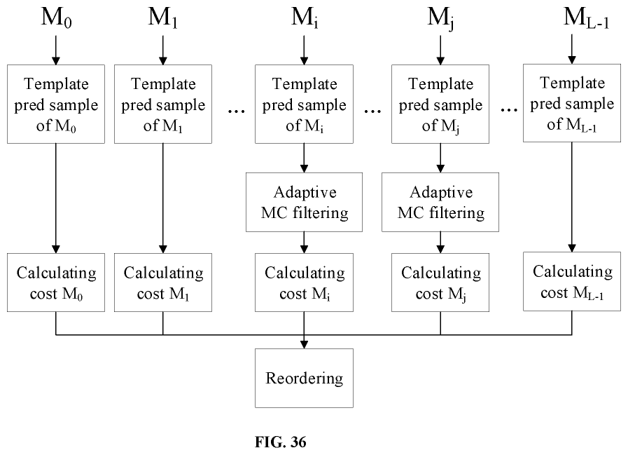

FIG. 36 gives the block diagram of the video encoder when the proposed adaptive bi-prediction filtering is applied. Firstly, similar to the conventional video encoder, the motion estimation and compensation module generates the motion compensated signals by matching the current block to one block (uni-prediction) or two blocks (bi-prediction) in the reference pictures using the optimal MVs. Then, for bi-predicted blocks, the motion compensated samples (both luma and chroma) are provided to the proposed adaptive filters to generate the filtered motion compensated prediction samples of the current block. After that, the prediction signal is subtracted from the original signal to remove temporal redundancy and produce the corresponding residual signal. The transform and quantization are applied to the residual signal which are then entropy-coded and output to bit-stream. To obtain the reconstructed signal, the residual signal is reconstructed by inverse quantization and inverse transform. Then, the reconstructed residual is added to the motion compensated prediction. Further, in-loop filtering processes, e.g., de-blocking, ALF and SAO, are applied to the reconstructed video signal for output. As will be discussed later, the filter coefficients of the proposed adaptive bi-prediction filter are directly derived from the neighboring reconstructed luma and chroma samples at decoder. Additionally, in order to maximize the coding gain of the proposed method, additional syntax may be signaled at a given block level (e.g., CTU, CU, or PU level) to indicate whether the proposed filtering is applied to the current block for motion compensation or not.

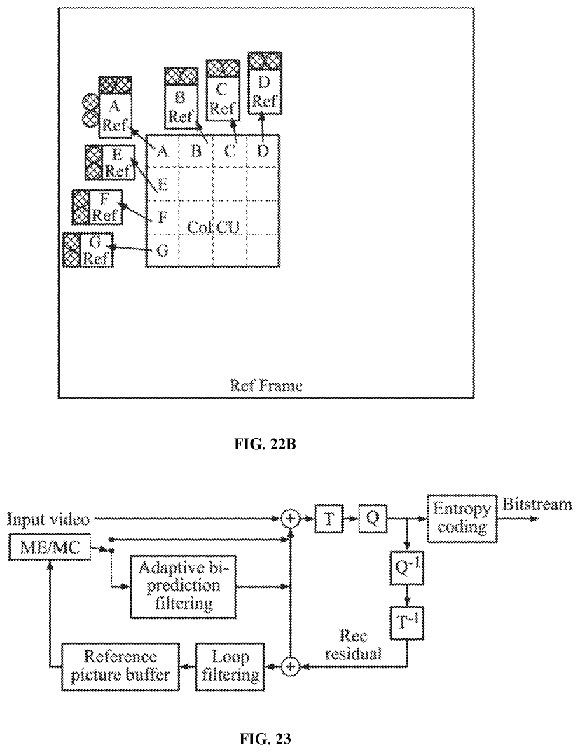

FIG. 24 shows a block diagram of the proposed decoder that receives the bit-stream produced by the encoder in FIG. 36. At the decoder, the bit-stream is first parsed by the entropy decoder. The residual coefficients are then inverse quantized and inverse transformed to obtain the reconstructed residual. For temporal prediction, prediction signal is firstly generated by obtaining the motion compensated block using the signaled prediction information (i.e., MV and reference index). Then, for bi-predicted blocks, it is parsed from the bitstream to determine whether the adaptive filtering is enabled for the block or not. If the adaptive filtering is enabled, the motion compensated luma and chroma signals are further processed by the proposed adaptive filtering; otherwise, the motion compensated chroma signal is not filtered. Then, the motion compensated signal (either filtered or un-filtered) and the reconstructed residual are added together to get the reconstructed video. The reconstructed video may additionally go through loop filtering before being stored in the reference picture store to be displayed and/or to be used to decode future video signal.

### Adaptive Bi-Prediction Filtering Based on Template Bi-Prediction Samples

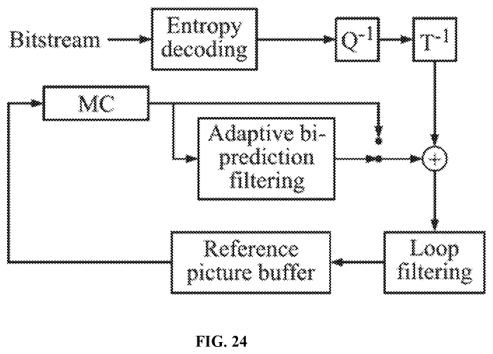

In this section, one adaptive filtering scheme is proposed for bi-prediction where the filter coefficients are derived based on the bi-prediction samples of the template for one bi-predicted block. Specifically, in the proposed scheme, the bi-prediction samples of the template samples are firstly generated according to the motion vectors of the current block; then, least square mean error (LMSE) algorithm is applied to derive the filter parameters by minimizing the difference between the template prediction samples and the template samples. FIG. 25 illustrates the proposed adaptive filtering method based on the bi-prediction samples of the template. As illustrated in FIG. 25, T indicates the template of the current bi-predicted block; T₀ and T₁ are the L0 and L1 prediction samples of the template, which are generated by using the bi-directional motion vectors

$$( {v}_{x}^{0} , {v}_{y}^{0} ) and ( {v}_{x}^{1} , {v}_{y}^{1} )$$

of the current block. Based on the notations, in the proposed scheme, the bi-prediction prediction samples of the template are firstly generated by averaging two uni-directional predictions of the template in L0 and L1, i.e.,

$${T}_{bi} = {w}_{0} * {T}_{0} + {w}_{1} * {T}_{1} \qquad ( 13 )$$

where w₀ and w₁ are the weights applied to the L0 and L1 directions when generating the bi-prediction samples of the current block, which are equal to 0.5 if the BCW is not applied and may be equal to −0.125, 0.375, 0.625 and 1.125 when the BCW is applied. Based on the resulting bi-prediction samples of the template, the LMSE derivation is used to calculate the values of the coefficients of the adaptive filter by minimizing the difference between the template samples and their bi-prediction samples, i.e.,

$$\begin{matrix}{f}^{*} = arg min {\sum }_{x} {\sum }_{y} {\vert T ( x , y ) - {T}_{bi} ( x , y ) \vert}^{2} \\ = arg min {\sum }_{x} {\sum }_{y} [ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} f ( i , j ) \times {T}_{bi} ( x - i , y - j ) ) - \\ {T ( x , y ) ]}^{2}\end{matrix} \qquad ( 14 )$$

where f* indicates the coefficients of the filter that is applied to the corresponding H×L neighboring region of one template prediction sample T_{bi}(x,y), where

$$- \frac{H - 1}{2} \leq i \leq \frac{H - 1}{2} , - \frac{L - 1}{2} \leq j \leq \frac{L - 1}{2} .$$

In practice, various filters with different sizes and shapes may be applied which can provide different trade-offs between coding performance and complexity. A larger filter can make the template prediction samples better approach to the template samples but at the expense of increased computational complexity. Finally, the derived filter coefficients are applied to modify the original bi-prediction signal of the current block as

$${P}_{b i}^{′} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} f ( i , j ) \times {P}_{bi} ( x - i , y - j ) \qquad ( 15 )$$

where P_{bi}(x,y) and P′_{bi}(x,y) are the bi-prediction samples before and after the proposed adaptive filtering is applied. Additionally, to further improve the coding gain, one offset and certain non-linear terms may be introduced when deriving the filter coefficients in the proposed method, which can further reduce the distortion between the template samples and its prediction samples. Specifically, with such modification, the filter coefficient derivation in (14) becomes

$${f}^{*} = arg min {\sum }_{x} {\sum }_{y} {\vert T ( x , y ) - {T}_{b i} ( x , y ) \vert}^{2} = arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} f ( i , j ) \times {T}_{b i} ( x - i , y - j ) ) + o + {\sum }_{k = 2}^{K - 1} n {l}^{k} \times {{T}_{b i} ( x , y )}^{k} - T ( x , y ) ]}^{2} \qquad ( 16 )$$

And, and the filter application in (15) is as

$${P}^{′} ( x , y ) = f ( i , j ) \times P ( x - i , y - j ) + o + {\sum }_{k = 2}^{K - 1} {nl}^{k} \times {{T}_{b i} ( x , y )}^{k} \qquad ( 17 )$$

where o is the offset and nl^{k}'s are the non-linear terms which is represented as the summation of a series of powers (i.e., k=2, . . . , K−1) of one template prediction sample T_{bi}(2x,2y).

In one or more examples, it is proposed to use the linear model (i.e., scaling factor and offset) to derive one two-tap filter to enhance the prediction samples of one bi-predicted block. Specifically, one bi-predictive LIC is proposed which is operated as follows: 1) generating the bi-prediction prediction samples of the template as shown in (13); 2) deriving the scaling factor and the offset using the template samples and their corresponding bi-prediction samples as

$$α = \frac{N \cdot {\sum }_{i = 1}^{N} ( T ( {x}_{i} , {y}_{i} ) \cdot {T}_{b i} ( {x}_{i} , {y}_{i} ) ) - {\sum }_{i = 1}^{N} T ( {x}_{i} , {y}_{i} ) \cdot {\sum }_{i = 1}^{N} {T}_{b i} ( {x}_{i} , {y}_{i} )}{N \cdot {\sum }_{i = 1}^{N} ( T ( {x}_{i} , {y}_{i} ) \cdot {T}_{b i} ( {x}_{i} , {y}_{i} ) ) - {( {\sum }_{i = 1}^{N} {T}_{b i} ( {x}_{i} , {y}_{i} ) )}^{2}} \qquad ( 18 )$$

$$β = \frac{{\sum }_{i = 1}^{N} T ( {x}_{i} , {y}_{i} ) - α \cdot {\sum }_{i = 1}^{N} {T}_{b i} ( {x}_{i} , {y}_{i} )}{N}$$

where α and β are the scaling factor and the offset of the LIC linear model; N is the number of template samples involved in the derivation. After that, the final bi-prediction of the current block is generated as

$${P}_{b i}^{′} ( x , y ) = α \cdot {P}_{b i} ( x , y ) + β \qquad ( 19 )$$

### Adaptive Bi-Prediction Filtering Based on Template Uni-Directional Samples

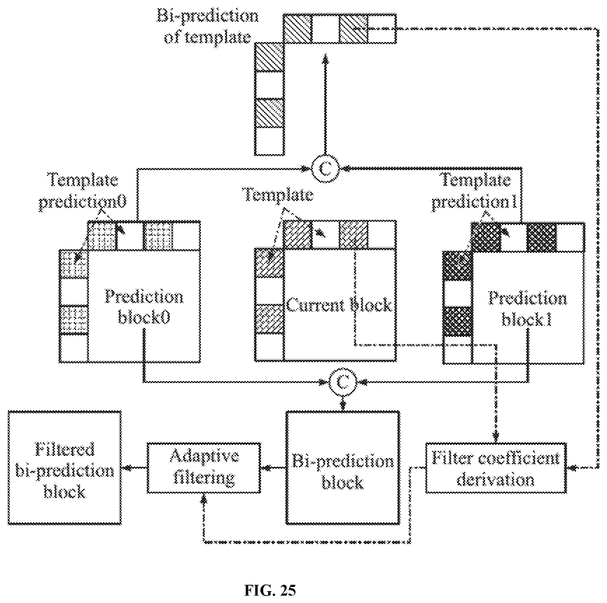

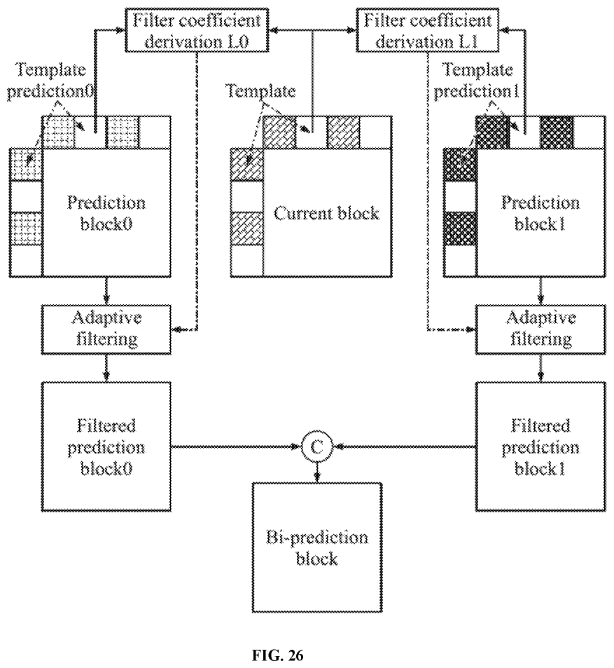

In this section, one adaptive bi-prediction filtering scheme is proposed using the uni-prediction samples of the template for one bi-predicted block. For example, in this method, two adaptive filter operations are applied to the prediction samples of the template in one unilateral manner: two sets of filter coefficients are separately derived and applied to prediction samples in L0 and L1; then, the weighted average of the two filtered uni-prediction samples is formed as the final prediction samples of the current block. FIG. 26 illustrates the proposed scheme. As shown in FIG. 26, based on the L0 and L1 MVs, two uni-predictions T₀ and T₁ of the template are generated. Then, based on the separate minimization of the distortions between T₀ and T, and T₁ and T, two sets of filter parameters f₀ and f₁ can be derived for L0 and L1 directions separately, as described as:

$${f}_{\frac{0}{1}}^{*} = arg min {\sum }_{x} {\sum }_{y} {\vert T ( x , y ) - {T}_{uni}^{\frac{0}{1}} ( x , y ) \vert}^{2} = arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{\frac{0}{1}} ( i , j ) \times {T}_{uni}^{\frac{0}{1}} ( x - i , y - j ) ) - T ( x , y ) ]}^{2} \qquad ( 20 )$$

where N represents the number of template samples that are involved; T is the template sample of the current block;

$${T}_{uni}^{\frac{0}{1}}$$

represents the uni-predictions of the template sample based on the MV (either L0 or L1) of the current block. After that, the two filters are applied to two uni-predictions of the current block separately, which are then combined to generate the final bi-prediction of the current blocks as

$${P}_{b i}^{′} ( x , y ) = {w}_{0} * {P}_{0}^{′} ( x , y ) + {w}_{1} * {P}_{1}^{′} ( x , y ) \qquad ( 21 )$$

where

$${P}_{0}^{′} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{0} ( i , j ) \times {P}_{0} ( x - i , y - j ) \qquad ( 22 )$$

$${P}_{1}^{′} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{1} ( i , j ) \times {P}_{1} ( x - i , y - j )$$

where P₀(x,y) and P₁(x,y) are the two uni-prediction samples of the current block before the proposed adaptive filtering is applied. Similar to (16) and (17), additionally, to further improve the coding gain, offset and non-linear terms can be introduced when deriving the filter coefficients. With such modification, the filter coefficients are derived as

$${f}_{\frac{0}{1}}^{*} = arg min {\sum }_{x} {\sum }_{y} {\vert T ( x , y ) - {T}_{uni}^{\frac{0}{1}} ( x , y ) \vert}^{2} = arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{\frac{0}{1}} ( i , j ) \times {T}_{uni}^{\frac{0}{1}} ( x - i , y - j ) ) + {o}_{\frac{0}{1}} + {\sum }_{k = 2}^{K - 1} {nl}^{k} \times {T}_{uni}^{\frac{0}{1}} - T ( x , y ) ]}^{2} \qquad ( 23 )$$

And, and the filtered uni-prediction samples of the current block are calculated as

$${P}_{0}^{′} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{0} ( i , j ) \times {P}_{0} ( x - i , y - j ) + {o}_{0} {\sum }_{k = 2}^{K - 1} {nl}^{k} \times {{P}_{0} ( x , y )}^{k} \qquad ( 24 )$$

$${P}_{1}^{′} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{1} ( i , j ) \times {P}_{1} ( x - i , y - j ) + {o}_{1} {\sum }_{k = 2}^{K - 1} {nl}^{k} \times {{P}_{1} ( x , y )}^{k}$$

In one or more examples, it is proposed to use the linear model (i.e., scaling factor and offset) to derive one two-tap filter to enhance the two uni-predictions of one bi-predicted block. Specifically, one bi-predictive LIC is proposed which is operated as follows: 1) generating the two uni-predictions of the template; 2) deriving the two sets of scaling factors and the offsets using the template samples and their corresponding uni-prediction samples as

$${α}_{\frac{0}{1}} = \frac{N \cdot {\sum }_{i = 1}^{N} ( T ( {x}_{i} , {y}_{i} ) \cdot {T}_{\frac{0}{1}} ( {x}_{i} , {y}_{i} ) ) - {\sum }_{i = 1}^{N} T ( {x}_{i} , {y}_{i} ) \cdot {\sum }_{i = 1}^{N} {T}_{\frac{0}{1}} ( {x}_{i} , {y}_{i} )}{N \cdot {\sum }_{i = 1}^{N} ( T ( {x}_{i} , {y}_{i} ) \cdot {T}_{\frac{0}{1}} ( {x}_{i} , {y}_{i} ) ) - {( {\sum }_{i = 1}^{N} {T}_{\frac{0}{1}} ( {x}_{i} , {y}_{i} ) )}^{2}} \qquad ( 25 )$$

$${β}_{\frac{0}{1}} = \frac{{\sum }_{i = 1}^{N} T ( {x}_{i} , {y}_{i} ) - α \cdot {\sum }_{i = 1}^{N} {T}_{\frac{0}{1}} ( {x}_{i} , {y}_{i} )}{N}$$

where α₀ and β₀ are the scaling factor and the offset of the LIC linear model for L0 uni-prediction, and α₁ and β₁ are the scaling factor and the offset of the LIC linear model for L1 uni-prediction; N is the number of template samples involved in the derivation. After that, the final bi-prediction of the current block is generated as

$${P}_{b i}^{′} ( x , y ) = {w}_{0} * ( {α}_{0} \cdot {P}_{0} ( x , y ) + {β}_{0} ) + {w}_{1} * ( {α}_{1} \cdot {P}_{0} ( x , y ) + {β}_{1} ) \qquad ( 26 )$$

where w₀ and w₁ are the BCW weight applied to the current block.

Adaptive bi-prediction filtering based recursive uni-directional filtering

In FIG. 26, because the filter coefficients that are applied to the two uni-prediction signals of the template are separately derived, the resulting bi-prediction signal of the template may not be optimal (i.e., the weighted combination of the two filtered uni-prediction signals) when considering the minimization of the distortion between the template samples and their corresponding prediction samples. To resolve such issue, one iterative scheme is proposed to derive the optimal filter coefficients applied to the two uni-prediction signals of the template for one bi-predicted block. The proposed scheme is conducted in one iterative manner which alternatively optimize the prediction filter for one prediction direction while keeping the one in the other prediction direction fixed. Specifically, the derivation procedure of the two uni-prediction filter coefficients is summarized as follows:

Step 1: Given the starting prediction direction L(o), derive the initial filter coefficients

$${f}_{{L}^{( 0 )}}^{( 0 )}$$

for the starting prediction direction by minimizing the distortion between its uni-prediction T_{L}_{⁽⁰⁾} and the template T, i.e.,

$${f}_{{L}^{( 0 )}}^{( 0 )} = arg min {\sum }_{x} {\sum }_{y} {\vert T ( x , y ) - {T}_{{L}^{( 0 )}} ( x , y ) \vert}^{2} = arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{{L}^{( 0 )}}^{( 0 )} ( i , j ) \times {T}_{{L}^{( 0 )}} ( x - i , y - j ) ) - T ( x , y ) ]}^{2} \qquad ( 27 )$$

Step 2: Based on the filter coefficients

$${f}_{{L}^{( 0 )}}^{( 0 )} ,$$

calculate the filtered uni-prediction

$${T}_{{L}^{( 0 )}}^{( 0 )}$$

And set k=1.

$${T}_{{L}^{( 0 )}}^{( 0 )} = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{{L}^{( 0 )}}^{( 0 )} ( i , j ) \times {T}_{{L}^{( 0 )}} ( x - i , y - j ) \qquad ( 28 )$$

Step 3: Select the target prediction direction L^{(k)}=1−L^{(k-1)} and calculate the target template samples of the current block as

$${T}^{( k )} = \frac{T - {w}_{{L}^{( k - 1 )}} * {T}_{{L}^{( k - 1 )}}^{( k - 1 )}}{{w}_{{L}^{( k )}}} \qquad ( 29 )$$

Step 4: Derive the filter coefficients

$${f}_{{L}^{( k )}}^{( k )}$$

for the starting prediction direction L^{(k)} by minimizing the distortion between its uni-prediction T_{L}_{^{(k)}} and the template T^{(k)}, i.e.,

$${f}_{{L}^{( k )}}^{( k )} = arg min {\sum }_{x} {\sum }_{y} {\vert {T}^{( k )} ( x , y ) - {T}_{L ( k )} ( x , y ) \vert}^{2} = arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{{L}^{( k )}}^{( k )} ( i , j ) \times {T}_{L ( k )} ( x - i , y - j ) ) - T ( x , y ) ]}^{2} \qquad ( 30 )$$

Step 5: Based on the filter coefficients

$${f}_{{L}^{( k )}}^{( k )} ,$$

calculate the filtered uni-prediction

$${T}_{{L}^{( k )}}^{( k )}$$

as

$${T}_{{L}^{( k )}}^{( k )} = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{{L}^{( k )}}^{( k )} ( i , j ) \times {T}_{{L}^{( k )}} ( x - i , y - j ) \qquad ( 31 )$$

Step 6: Set k=k+1 and go to Step 3.

The resulting filters are used as the corresponding filters that are applied to two uni-predictions of the current block and the filtered prediction samples are then combined to generate the final bi-prediction of the current blocks as shown in (21) and (22). Similarly, the offset and non-linear items as shown in (23) and (24) can also be applied in the proposed iterative bi-prediction filter derivation scheme. Additionally, in one or more examples, it is proposed to use the linear model (i.e., scaling factor and offset) to derive one two-tap filter by the proposed iterative filter derivation scheme: 1) generating the two uni-predictions of the template; 2) deriving the two sets of scaling factors and the offsets based on the iterative algorithm as shown from Step 1 to Step 6; 3) calculating the final bi-prediction samples of the current block as shown in (26).

In practice, different number of iterations may be applied to the above iterative filter derivation scheme. In general, more iterations will lead to smaller distortion between the template and its prediction signal (i.e., better coding gain) which however comes at the expense of more computational complexity. In the following, different methods are proposed to decide the number of iterations that is applied in the proposed algorithm. In one method, it is proposed to use one fixed number of iterations (i.e., 3) at both encoder and decoder. In the second method, it is proposed to give the encoder the freedom to select the specific number of iterations and signal the corresponding value to decoder. When such method is applied, new syntax element(s) may be added in sequence parameter set (SPS), picture parameter set (PPS), picture header, slice header, or even coding block level to indicate the value of number of the applied iterations. In the third method, it is proposed to adaptively determine the value of number of iterations that is applied to one block according to its statistics. e.g., sample variation, motion vector difference and extra. In one or more examples, it is proposed to use the difference between the original L0 and L1 prediction samples of one bi-predicted block as the criterion to select the number of iterations that is applied. For instance, when the difference (i.e., sum absolute difference (SAD), sum squared difference (SSD) and other metrices) between the two prediction samples is larger than one threshold, larger number of iterations is applied to the block; otherwise (i.e. the difference is smaller than the threshold), smaller number of iterations is applied.

At the last but not the least, different initial prediction direction can be applied in the proposed scheme. In one method, it is proposed to always use L0 as the initial prediction direction in the proposed method. In another method, it is proposed to use L1 as the initial prediction direction. In the third method, it is proposed to select the initial prediction direction based on the slice type, prediction structure and QP of the slice that the current block belongs to. For example, it can use L0 as the initial prediction direction for non-low-delay pictures and use L1 as the initial prediction direction for low delay pictures.

wSignaling of the adaptive motion compensated filtering

In practice, various signaling schemes may be applied to indicate the usage of the proposed adaptive motion compensated filtering for bi-predicted inter blocks. In one embodiment of the disclosure, for explicit inter modes (i.e., AMVP modes), it is proposed to signal one control flag to explicitly indicate whether the adaptive motion compensated filtering is applied to the current block or not. When the flag is one, it indicates that the adaptive filtering is applied to the motion compensated prediction samples while the corresponding filter coefficients are derived from the template samples using one of the above methods as discussed above. Otherwise, when the flag is zero, it indicates that the adaptive filtering is not applied to the current block. On the other side, for merge modes, it is proposed to inherit its control flag from its corresponding selected merge candidate (as indicated by the merge index) besides to the other motion information (e.g., MVs, reference indices and extra).

### Multi-Template Adaptive Motion Compensated Filtering

As illustrated above, when the proposed adaptive motion compensated filtering is applied, both the template samples above and left to the current block (when they are available) are used to derive the filter coefficients of the block. This may not be always optimal due to the varying correlation between the current block and its top/left neighbors. To solve such issue, two additional adaptive filtering modes are proposed: in the first mode (which is called as top-only filtering mode), only the neighboring samples that are above the current block (i.e., the top template) are used to derive the filter coefficients; in the second mode (which is called as left-only filtering mode), only the neighboring samples that are left to the current block (i.e., the left template) are used to derive the filter coefficients of the current block. For the signaling, one flag may be firstly signaled to indicate whether the default filtering mode (i.e., using both top and left neighboring samples) is applied. When the flag is false (i.e., the default filtering mode is not applied), another flag may be signaled to indicate which mode (either top-only or left-only mode) is applied to the current block. In one method, the proposed two additional multi-template filtering modes are applied to all the inter blocks. In another method, the proposed two additional multi-template filtering modes are only applied to the AMVP inter blocks. In yet another method, the proposed two additional multi-template filtering modes are only applied to the AMVP inter blocks that are uni-predicted.

Additionally, in specific example, it is proposed to apply the proposed multi-template modes to the existing LIC design, where the proposed adaptive motion compensated filtering degenerates to 2-tap filter (i.e., one scaling and one offset).

### Adaptive Motion Compensated Filtering Based on Non-Adjacent Spatial Neighbors

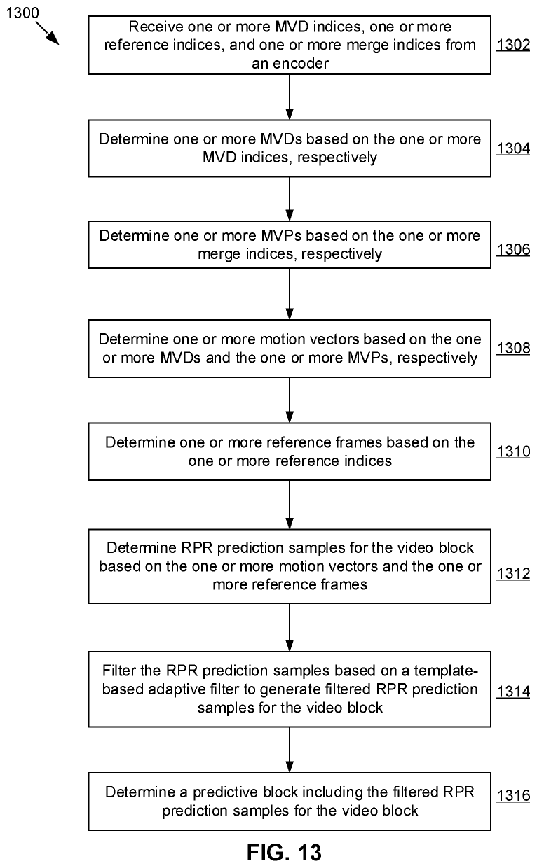

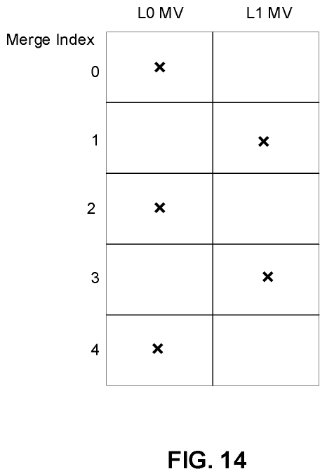

In some embodiments, the blocks around the current block are defined as neighboring blocks to the current block. As shown in FIGS. 17A and 17B, those blank neighboring blocks without shading are adjacent neighboring blocks, and those neighboring blocks having shading are non-adjacent neighboring blocks. In the above methods, the coefficients of the proposed motion compensated filters are always derived from the reconstructed samples that are adjacent to the current coding block (i.e., direct top and left neighbors). Such scheme could be efficient when the current block is highly correlated with its adjacent spatial neighbors. However, in real coding scenarios, due to the existence of coding noises (e.g., the ones caused by the quantization/dequantization and the blocking artifacts introduced at motion compensation stage), the current block may be more correlated with the samples in the reconstructed regions that are not adjacent to the current block. Based on such consideration, in this section, one adaptive motion compensated filtering scheme based on non-adjacent neighbors is proposed. With the scheme, samples in the non-adjacent regions can be utilized to derive the coefficients of the adaptive motion compensated filtering. Different methods may be applied to locate the non-adjacent reconstructed samples for the derivation of the filter coefficients. In one or more embodiments, non-adjacent neighboring blocks may be scanned from left area and above area of the current block. The scanning distance may be defined as the number of at least one scanning block size to the left or on top of the current block.

As shown in FIG. 30A, either on top of or left to the current block, multiple rows (columns) of non-adjacent neighboring blocks may be scanned. The distance shown in FIG. 30A represents the number of the at least one scanning block size from each candidate position to the current block, each scanning block size representing a unit of the distance. For example, the area with “distance 2” on the left side of the current block indicates that the candidate neighboring blocks located in this area are 2 scanning block sizes away from the current block. Based on such pattern, different scanning block sizes may be applied:

In one method, as shown in FIG. 30A, the non-adjacent neighboring blocks at each distance may have the same block size as the current block. Note that when such method is applied, the granularity of block scanning is adaptively adjusted according to the partition granularity of the current block, that is, the larger coding block has more chances to utilize the farther non-adjacent reconstructed samples for calculating the coefficients of the adaptive filter.

In another method, the non-adjacent neighboring blocks that may be accessed for the filter coefficient derivation may be defined based on a fixed block, e.g., 4×4, 8×8.

In the third method, one combined method may be applied to define the scan pattern. For instance, for small blocks, one fixed scanning block (Ws×Hs) size may be applied, where Ws and Hs are the width and height of the fixed scanning block size; otherwise, for big blocks, the scanning block size is defined as the current block size. Specifically, let xStep and yStep indicate the width and height of the scanning block size, their corresponding values are xStep=max(Ws, width) and yStep=max(Hs, height), where width and height are the width and height of the current block.

To indicate the usage of non-adjacent neighbors for filter derivation, a spatial candidate list may be formed by including both the adjacent neighbor (i.e., direct top and left spatial neighboring reconstruction samples) and non-adjacent neighboring blocks. For the signaling, one flag can be firstly signaled to indicate the usage of the spatial candidate list. And, when the flag is equal to one (i.e., the candidate list is selected), one index can be signaled from encoder to decoder to specify which spatial candidate is selected for deriving the filter coefficients. Additionally, template-based reordering scheme can be applied to reduce the overhead of signaling the index. Specifically, by the scheme, the distortions, between the template samples of the current block (i.e., the reconstructed neighboring samples above and left to the current block) and the prediction samples of the template samples that are generated using the motion and the filter coefficients of each candidate in the list, can be calculated and used to sort the spatial candidates in the list according to the ascending order of the template distortion; then, the corresponding index of the selected candidate will be signaled based on the reordered list with appropriate context models.

In another method, it is proposed to directly add the new non-adjacent neighbors and adjacent neighbors associated with their corresponding adaptive filter coefficients into the existing merge candidate list (i.e., spatial MVPs, TMVPs, non-adjacent MVPs, HMVPs, pairwise merge candidates and zero candidates). By such scheme, the usage of the proposed non-adjacent/adjacent neighbors for the adaptive filtering can be indicated through the index of the existing merge mode. Similarly, the template-based reordering scheme may be applied to reduce the signaling overhead of the merge index.

In one embodiment of the disclosure, all the inter blocks are allowed to be considered as reference for the proposed filter coefficient inheritance. In another embodiment of the disclosure, the inter blocks that are coded with SbTMVP and GPM modes are excluded from being used as reference in the proposed filter coefficient inheritance scheme.

Additionally or alternatively, in some examples, it is proposed to apply the proposed non-adjacent spatial neighbors to the existing LIC design, where the proposed adaptive motion compensated filtering degenerates to 2-tap filter (i.e., one scaling and one offset). Specifically, based on the motion information of the current block (either uni-prediction or bi-prediction), the method uses the motion information to generate the corresponding prediction signals of the selected non-adjacent block, which are then used to derive the corresponding LIC parameters by minimizing the difference between the reconstructed samples of the non-adjacent block and its corresponding prediction.

In all the above methods, different methods may be applied to generate the filter coefficients of one inter blocks that are then used to filter the prediction samples of future inter blocks. In the first method, it is proposed to generate one single set of filter coefficients for each inter block. Specifically, when the block is uni-predicted (i.e., being predicted from one reference list L0/L1), its filter coefficients are directly derived based on its reconstruction samples and its uni-prediction samples. When the block is bi-predicted (i.e., being predicted from both reference lists L0 and L1), then the final bi-prediction samples are firstly generated based on the weighted average of the L0 and L1 prediction samples. After that, one single set of filter coefficients can be derived by minimizing the difference between the reconstruction samples and the bi-prediction samples of the block. Similarly, once the filter coefficients of one non-adjacent/adjacent block is referred by the current block, the prediction samples (uni-prediction or bi-prediction samples as per the motion of the referred block) are firstly generated which are then further modified based on the corresponding filter coefficients.

In another method, it is proposed to generate two set of filter coefficients, one for L0 and the other for L1, for each inter block that is bi-predicted. And various derivation schemes, such as the ones proposed in “adaptive bi-prediction filter derivation based on uni-directional samples” and “adaptive bi-prediction filter derivation based on recursive uni-direction samples”, may be applied which targets at minimizing the distortion between the reconstructed samples and the L0 and L1 prediction samples of the current bi-predicted block.

In yet another method, it is proposed to directly store the coefficients of the inter blocks which applies the adaptive filtering when generating its prediction samples. Therefore, there is no need to further derive the filter coefficients after the reconstruction when the method is applied, given that they are already calculated when generating the prediction samples of the blocks. However, the expense of the method is that instead of all preceding inter blocks, only the blocks where the adaptive filtering is applied are allowed to be used as reference for the prediction filtering process of the current block. This may reduce the total usage of the proposed scheme, therefore lower the overall coding performance.

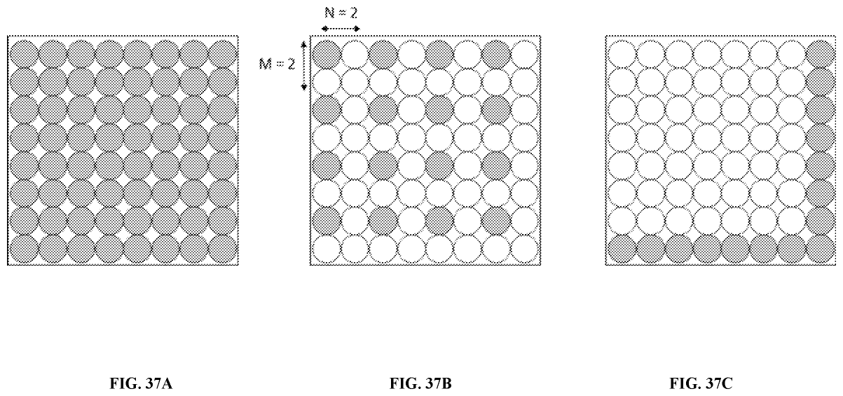

In the above discussion, the adaptive filter coefficients of adjacent/non-adjacent inter CUs are derived using the prediction samples and the reconstruction samples of the CUs. As shown before, the filter coefficients are derived based on linear regression which aims at minimizing the energy of the difference between the prediction and reconstruction samples. In practice, to achieve various performance/complexity tradeoff, different methods may be applied to select the samples positions inside one inter CU for deriving its adaptive filter. As shown in FIG. 37A, in one method, it is proposed to consider all the prediction and reconstruction samples within one inter CU for the derivation of its adaptive filter coefficients. In another method, one sub-sampling scheme may be applied to choose the corresponding sample positions (e.g., every N-th sample in horizontal direction and every M-th sample in vertical direction as shown in FIG. 37B and then only the prediction and reconstruction samples at the selected positions are used for the filter derivation. In yet another method, as shown in FIG. 37C, it is proposed to only use the prediction and reconstruction samples located at the bottom and right boundaries for the filter derivation. To switch between different filter derivation methods, syntax elements may be signaled to indicate which set of filter coefficients are used. For instance, in one specific example, it is proposed to allow the filter coefficients are derived from either all the prediction/reconstruction samples of one adjacent/non-adjacent inter CU (as shown in FIG. 37A) or the prediction/reconstruction samples at the bottom and right boundaries of one adjacent/non-adjacent inter CU (as shown in FIG. 37C). Correspondingly, when the proposed adaptive filter is selected (e.g., through merge mode), one extra flag is further signal to indicate what samples positions within the selected adjacent/non-adjacent neighboring blocks are used for deriving the corresponding filter coefficients.

In all the above methods, the filter coefficients of the adjacent/non-adjacent neighboring blocks are directly used for the current CU. Such scheme may not be always optimal due to the fact that the correlation between the prediction and reconstruction samples of the neighboring CU may be far different from that of the current CU. Therefore, to further improve its performance, one adaptive offset adjustment scheme is proposed herein to further be applied on top of the proposed adaptive motion compensated filtering scheme. Specifically, assuming the inherited filter coefficients f_{i,j} and offset σ of the adjacent/non-adjacent neighbor, the offset for the adaptive filter of the current CU is calculated as

$$totalDiff = \sum ( {P}_{r e c} - ( {\sum }_{i , j} {f}_{i , j} * {P}_{p r e d} + σ ) )$$

$${σ}^{′} = σ + t o t a l D iff / N$$

where P_{rec} and P_{pred} are the reconstruction samples and the prediction samples from the template (i.e., direct neighboring positions) of the current CU, N is the total number of samples in the template. σ and σ′ are the offset before and after the adjustment. In one method, it is proposed to always apply the above offset adjustment in the proposed adjacent/non-adjacent adaptive filtering scheme, i.e., the offset of the filter coefficients of the selected neighbor blocks is always adjusted before it is applied to the current CU. In another method, one flag is signaled when the adaptive filtering is applied to indicate whether the offset needs to be adjusted. When the flag is false, it means the filter coefficients inherited from the adjacent/non-adjacent block are directly applied for the current CU; otherwise, when the flag is true, it means the offset of the filter coefficient is adjusted before the filter is applied to the motion compensated samples of the current CU.

### Adaptive Motion Compensated Filtering Based on History Filter Coefficients

In the above non-adjacent neighbor-based scheme, the filter coefficients are derived from the reconstructed regions that are far from the current block, which requires additional on-chip memory to store those non-adjacent reconstruction samples. This is relatively costly to practical hardware codec implementations. Therefore, in order to reduce the implementation cost, one history based adaptive motion compensated filtering method is proposed. In the method, the filter coefficients of one previously coded block is stored in one table and can be used for filtering of the motion compensated samples of future blocks. In some embodiments, the table may be a candidate filter list. The table with multiple sets of filter coefficients can be maintained and synchronized at both encoding and decoding process. Whenever one inter block is coded, the set of filter coefficients can be derived based on its reconstruction samples and its prediction samples, which is then added to the last entry of the table as one new candidate. To maintain the table size, one first-in-first-out (FIFO) rule can be used wherein redundancy check can be applied to check whether there is an identical candidate in the table as the new candidate. If it is the case, the identical candidate will be removed from the table and all the other candidates are moved forward and the new candidate is added at the last entry. In the case that the table is full and there is no identical candidate in the table, the first candidate will be removed from the table and the new candidate is added at the last. Then, the candidate sets of the filter coefficients can be selected for the filtering of the motion compensated samples of future coding blocks. For signaling, when the history-based filter coefficient derivation is selected, one index can be signaled to indicate which candidate set in the table will be used for deriving the filter coefficients of the current block. In another embodiment, to reduce the number of filter coefficient derivation, it is proposed to only include the filter coefficients of the coding blocks where the adaptive motion compensated filtering is selected into the table.

Additionally or alternatively, in some examples, it is proposed to apply the proposed history-based filter derivation scheme to the existing LIC design, where the proposed adaptive motion compensated filtering degenerates to 2-tap filter. Specifically, in the case, each candidate in the table is composed of two parameters, i.e., one scaling and one offset, which can be selected by one inter coding block to adjust its prediction samples.

In another method, it is proposed to directly add the new candidates associated with historical filter coefficients into the existing merge candidate list (i.e., spatial MVPs, TMVPs, non-adjacent MVPs, HMVPs, pairwise merge candidates and zero candidates). By such scheme, the usage of the proposed historical filter coefficients can be indicated through the index of the existing merge mode. Similar to before, the template-based reordering scheme may be applied to reduce the signaling overhead of the merge index.

### Combination of the Adaptive Motion Compensated Filtering and the OBMC

In this section, methods are provided to apply the proposed adaptive motion compensated filtering method to the OBMC process. Specifically, in some example methods, beside the motion vectors of neighboring blocks, it is proposed to also consider the LIC parameters of each neighboring block to its corresponding motion compensated prediction samples when conducting the OBMC process of the current block. To facilitate the description, in the below, regular inter prediction without sub-block partition is used as the example to illustrate the proposed method. For example, let P_{obmc}(x,y) denotes the blended prediction sample at coordinate (x,y) after combining the prediction signal of the current CU with multiple prediction signal based on the MVs of its spatial neighbors. P_{cur}(x,y) denotes the prediction sample at coordinate (x,y) of the current CU; Pₜₒₚ(x,y) and P_{left}(x,y) denote the prediction samples at the same position of the current CU but using the MVs of the left and right neighbors of the CU, respectively. In some embodiments, as shown in equation (32), P_{obmc}(x,y) may be the weighted average of P_{cur}(x,y), Pₜₒₚ(x,y) and P_{left}(x,y).

$${P}_{o b m c} ( x , y ) = {w}_{c u r} * {P}_{c u r} ( x , y ) + {w}_{top} * {P}_{top} ( x , y ) + {w}_{left} * {P}_{left} ( x , y ) \qquad ( 32 )$$

Additionally, for the purpose of illustration, it is assumed that the adaptive motion compensated filtering is applied to the current block and its spatial top and left neighbors and the applied filters are one tap filter (i.e., one scaling factor and offset) with filter coefficients α_{cur} and β_{cur} for the current block, αₜₒₚ and βₜₒₚ for the top neighboring block and α_{left} and β_{left} for the left neighboring block. The proposed scheme firstly generates the prediction samples of the current block as illustrated as

$${P}_{c u r} ( x , y ) = {α}_{c u r} \cdot {P}_{cur}^{org} ( x , y ) + {β}_{c u r} \qquad ( 33 )$$

where P^{org}_{cur}(x,y) are the original prediction samples of the current block using its motion vector without the filtering applied. Then, the boundary prediction samples of the current CU will be updated using the MVs of its top and left causal neighbors. Firstly, the top neighboring block of the current block is firstly checked. If the block is one inter block, its MVs and filter coefficients (i.e., αₜₒₚ and βₜₒₚ) will be assigned to the current block to generate the prediction signal Pₜₒₚ(x,y) at collocated position of the current block as.

$${P}_{top} ( x , y ) = {α}_{top} \cdot {P}_{top}^{org} ( x , y ) + {β}_{top} \qquad ( 34 )$$

where P^{org}ₜₒₚ(x,y) are the original prediction samples of the current block using the motion vector of the top neighboring block without the filtering applied. After that, the same procedure is followed to generate the corresponding prediction samples based on the motion vector and the LIC parameters of the left neighboring blocks as

$${P}_{left} ( x , y ) = {α}_{left} \cdot {P}_{left}^{o r g} ( x , y ) + {β}_{left} \qquad ( 35 )$$

where P^{org}_{left}(x,y) are the original prediction samples of the current block using the motion vector of the left neighboring block without the filtering applied. Finally, the three prediction signals are combined according to the template-based OBMC blending process (as illustrated in section “overlapped block motion compensation”) to generate the final prediction samples of the current block.

When the current block is coded with one sub-block mode (e.g., affine, ATMVP and DMVR), the proposed motion-compensated filtering based OBMC can also be applied to the internal OBMC of the sub-blocks inside the current CU. Specifically, when such scheme is applied, the same filtering processes as illustrated in equations (32) to (34) can be applied to generate the corresponding prediction samples of each sub-block using its top, left, bottom and right neighboring sub-blocks. However, instead of the LIC parameters of the spatial neighboring blocks, the filter coefficients of the current CU will be always applied for the prediction sample derivation of the internal OBMC process.

In order to achieve different complexity/performance tradeoff, two methods are proposed herein when the proposed motion compensated filtering OBMC is applied. In one method, it is proposed to only apply the filtering based OBMC to the prediction samples on the CU boundaries but not the prediction samples of the sub-blocks inside the CU (i.e., the internal OBMC). In such case, for the internal OBMC, only the neighboring motion vectors of the neighboring blocks of each sub-block are considered to generate its OBMC predication samples. In another method, it is proposed to apply the filtering based OBMC to the prediction samples on the CU boundaries as well as the prediction samples along the sub-block boundaries of the sub-blocks inside the CU.

Additionally, in equation (33) and (34), the adaptive filter parameters of the neighboring block are applied to generate the corresponding prediction samples for the OBMC process of the current block. Due to the filter derivation of the neighboring block, such design may cause complexity increase for hardware/software implementation. To reduce the complexity, in one embodiment of the disclosure, instead of using the filter parameters of neighboring blocks, it is proposed to use the filter parameters of the current block when generating the OBMC prediction samples from neighboring block. Specifically, when the current block is coded with the adaptive motion compensated filter being enabled, then the filter coefficients of the current block will be applied to modify the OBMC prediction samples generated from the motion information of each neighboring block. Otherwise, if the adaptive motion compensated filtering is not applied to the current block, then the adaptive motion compensated filtering is not applied to the OBMC process of generating the prediction samples of any neighboring block even if the neighboring block applies the adaptive motion compensated filtering for its own.

Additionally, in specific example, it is proposed to apply the above methods to the existing LIC design. Specifically, for all the method discussed above, the adaptive motion compensated filtering process degenerates to 2-tap filter, i.e., one scaling factor plus one offset.

Combination of adaptive motion compensated filtering with template matching based inter tools

As discussed in “BACKGROUND” section, several template-matching based techniques are introduced in the ECM to reduce the saving overhead of merge mode. For instance, in the ARMC, the candidates in the initial merge candidate list are sub-grouped and the candidates in each sub-group are reordered based on the cost between the template samples and their corresponding prediction samples (i.e., reference samples). By such way, the candidates with better MVs (i.e., less template costs) are associated with the smaller merge indices. Similarly, in the MMVD modes, template costs are utilized to reorder all the possible MMVD refinement positions and only a number of top positions after reordering are allowed to be selected by encoder/decoder. In this disclosure, methods are proposed to apply the proposed adaptive motion compensated filtering to the cost calculation of the template matching based schemes.

In the first method, when the adaptive motion-compensated filtering is applied to one merge candidate, it is proposed to always bypass the adaptive motion compensated filtering when calculating its template cost. However, if the candidate is selected (e.g., as indicated by the merge index), the adaptive motion compensated filtering is still applied to generate the prediction samples of the block. To illustrate the above method, as shown in FIG. 34, it assumes there are L merge candidates, i.e., M0, M1, . . . , ML−1; additionally, without generality, it assumes merge candidates Mi and Mj apply the adaptive motion compensated filtering while the other merge candidates do not apply the adaptive motion compensated filtering. By the method, the adaptive compensated filtering will be always bypassed when calculating the difference of the template samples and the corresponding template prediction samples using the motions of the L merge candidates during the template-based reordering process. However, depending on whether Mi or Mj is finally selected, the adaptive motion compensated filtering can be still applied to generate the final prediction samples of the block.

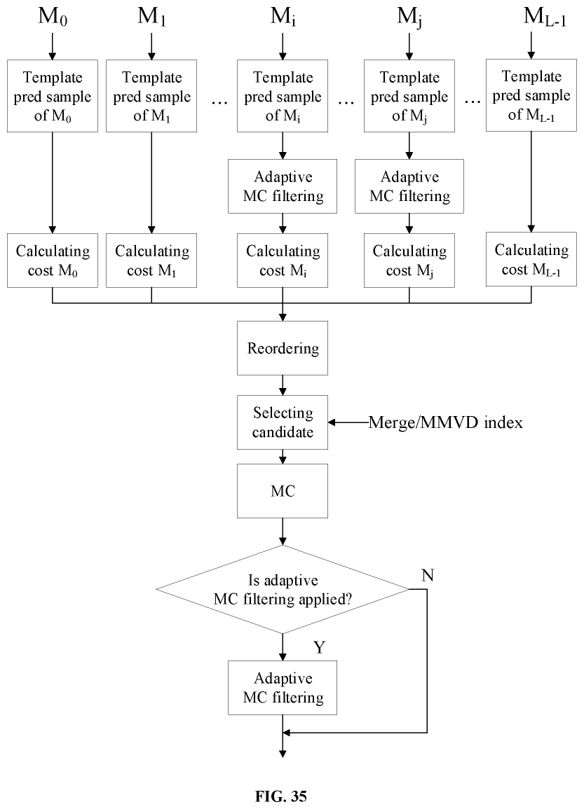

In the second method, it is proposed to apply the adaptive motion-compensated filtering to both the calculation of template costs and the generation of the prediction samples of the block. As illustrated in FIG. 35, different from the first method, the adaptive motion-compensated filtering is applied to adjust the template prediction samples of Mi are Mj before their corresponding costs are calculated. Moreover, during the reordering process, different adaptive filtering method can be applied to adjust the prediction samples of the template when one merge candidate is bi-predicted. In one method (Method #1), it is proposed to use the method as discussed in section “Adaptive bi-prediction filtering based on template bi-prediction samples” to generate the template prediction samples of each bi-predicted merge candidate. Specifically, in the proposed scheme, the bi-prediction samples of the template samples are firstly generated according to the L0 and L1 MVs of the merge candidate; then, one adaptive filter is derived and applied to the bi-predicted template prediction samples, as indicated in (17). In the second method (Method #2), it is proposed to use the method as discussed in section “Adaptive bi-prediction filtering based on template uni-directional samples” to generate the template prediction samples of each bi-predicted merge candidate. Specifically, in this method, the template prediction samples in L0 and L1 are firstly generated using the MVs in L0 and L1 respectively; then, two adaptive filters are derived and applied to the L0 and L1 prediction samples of the template in one unilateral manner which are then combined to generate the final prediction samples of the template as indicated in (21) and (22). In the third method (Method #3), it is proposed to use the method as discussed in section “Adaptive bi-prediction filtering based on recursive uni-directional filtering” to generate the template prediction samples of each bi-predicted merge candidate. Specifically, by such scheme, the template prediction samples in L0 and L1 are firstly generated using the MVs in L0 and L1 respectively; then, two filters are iteratively derived applied to the two uni-prediction prediction samples of the template which are then combined to generate the final prediction samples of the template. In practice, different adaptive filtering schemes may be applied to different template matching scheme which may result in different coding efficiency/complexity tradeoff. In one specific example, it is proposed to apply Method #3 to the ARMC mode and the regular MMVD mode and Method #2 to affine MMVD mode.

Additionally, in a specific example, it is proposed to apply the above methods to the existing LIC design. Specifically, for all the method discussed above, the adaptive motion compensated filtering process degenerates to 2-tap filter, i.e., one scaling factor plus one offset.

### Combination of the Adaptive Motion Compensated Filtering and the AMVP-Merge Mode

As discussed earlier, in the AMVP-merge mode, the merge candidate corresponding to one given AMVP part is implicitly determined by minimizing the bilateral matching cost between the AMVP part and the merge part. For every merge candidate in the merge candidate list, the bilateral matching cost is calculated using the merge candidate MV and the AMVP MV The merge candidate with the smallest cost is selected for the AMVP MV. Additionally, when the bilateral matching is enabled, the bilateral matching refinement is applied to the coding block with the selected merge candidate MV and the AMVP MV as a starting point; otherwise, if the template matching is enabled, the template matching refinement is applied to the coding block with the selected merge candidate MV and the AMVP MV as a starting point. As analyzed earlier, the proposed adaptive motion compensated filtering is capable of compensating the illumination variation between the prediction block and the current block. Therefore, the bilateral matching, which aims at measuring the average illumination different between two blocks, may not be efficient to evaluate the effectiveness of one merge candidate when the adaptive motion compensated filtering is applied to the candidate. Based on such consideration, in one embodiment of the disclosure, a given AMVP MV, when there is one or more than one merge candidates in its corresponding merge candidate list, it is proposed to utilize template matching cost to select the merge candidate associated with the AMVP MV. Specifically, in such case, for every merge candidate in the merge candidate list, the template matching cost is calculated using the merge candidate MV and the AMVP MV Additionally, for the merge candidates that are associated with adaptive motion compensated filtering, the filtering process is applied when calculating the corresponding template cost. FIG. 36 gives one example to illustrate such method. In another embodiment, it is proposed to always still apply the bilateral matching cost to select the merge candidate for each AMVP MV no matter whether there is or not any merge candidate is associated with adaptive motion compensated filtering.

Additionally, in a specific example, it is proposed to apply the above methods to the existing LIC design. Specifically, for all the method discussed above, the adaptive motion compensated filtering process degenerates to 2-tap filter, i.e., one scaling factor plus one offset.

### Combination of the Adaptive Motion Compensated Filtering and the CIIP

As discussed before, in the existing CIP design, the inter prediction samples are always generated merely based on the corresponding motion before the blending of the inter and intra prediction samples. In one embodiment of the disclosure, further improve the coding performance, it is proposed to also apply the proposed adaptive motion compensated filtering process to generate the corresponding CIIP inter prediction samples. Specifically, in case the merge candidate that is used for the inter part is associated with the adaptive motion compensated filtering (e.g., as through merge inheritance), then the adaptive motion compensated filtering will be applied to modify the motion compensated prediction samples that are generated based on its MVs. In the above method, the adaptive motion compensated filtering is always invoked for the generation of the inter prediction samples of the CIP when it is enabled for one current block. Such design may introduce non-negligible encoding/decoding complexity. To control the computational complexity, in another embodiment of the disclosure, it is proposed to only enable the adaptive motion compensated filtering for the CIP blocks when the current picture is one low-delay picture where the POCs of all the reference pictures are no larger than that of the current picture. In another embodiment of the disclosure, it is proposed to only enable the adaptive motion compensated filtering for the CIIP blocks when the current picture is one low-delay picture and the POC distance between the current picture and the first reference picture in list L0 is equal to 1.

Additionally, in specific example, it is proposed to apply the above methods to the existing LIC design. Specifically, for all the method discussed above, the adaptive motion compensated filtering process degenerates to 2-tap filter, i.e., one scaling factor plus one offset.

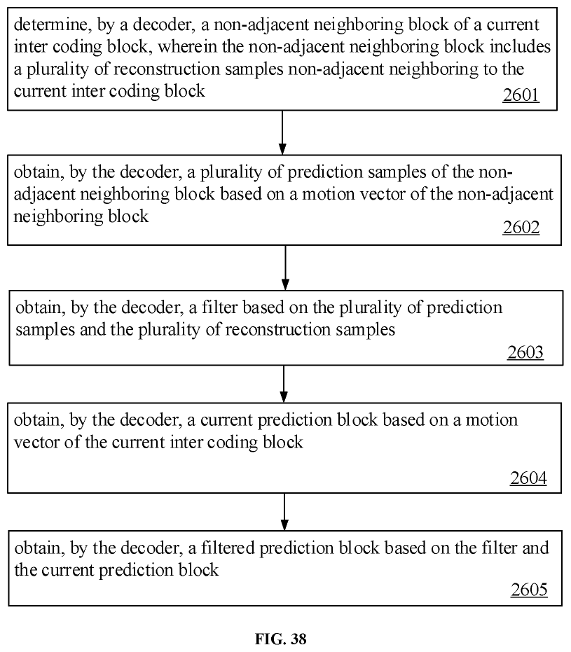

FIG. 38 is a flowchart illustrating a method for video decoding according to an example of the present disclosure. The method may be implemented by a decoder for decoding an inter coding block. In Step 2601, the method includes determining, by a decoder, a non-adjacent neighboring block of a current inter coding block, wherein the non-adjacent neighboring block includes a plurality of reconstruction samples non-adjacent neighboring to the current inter coding block. Due to the existence of coding noises, the current inter coding block may be more correlated with the samples in the reconstructed regions that are not adjacent to the current block. Based on such consideration, the adaptive motion compensated filtering scheme may be performed based on reconstruction samples non-adjacent neighboring to the current inter coding block. In some embodiments, non-adjacent neighboring blocks may be scanned from a left area and an above area of the current inter coding block. In Step 2602, the method includes obtaining, by the decoder, a plurality of prediction samples of the non-adjacent neighboring block based on a motion vector of the non-adjacent neighboring block. In Step 2603, the method includes obtaining, by the decoder, a filter based on the plurality of prediction samples and the plurality of reconstruction samples. In some embodiments, the non-adjacent neighboring block is uni-predicted (i.e., being predicted from one reference list L0/L1), its filter coefficients are directly derived based on its reconstruction samples and its uni-prediction samples. In some other embodiments, the non-adjacent neighboring block is bi-predicted (i.e., being predicted from both reference lists L0 and L1), then the final bi-prediction samples are firstly generated based on the weighted average of the L0 and L1 prediction samples. In Step 2604, obtaining, by the decoder, a current prediction block based on a motion vector of the current inter coding block. In Step 2605, obtaining, by the decoder, a filtered prediction block based on the filter and the current prediction block. The current prediction block of the current inter coding block is modified based on filter coefficients of the filter derived based on the plurality of prediction samples and the plurality of reconstruction samples.

In some examples, obtaining the plurality of prediction samples of the non-adjacent neighboring block based on the motion vector of the non-adjacent neighboring block includes: obtaining, from a reference list L0 or L1, the plurality of prediction samples of the non-adjacent neighboring block.

In some examples, obtaining the plurality of prediction samples of the non-adjacent neighboring block based on the motion vector of the non-adjacent neighboring block includes: obtaining, from a reference list L0, a plurality of first prediction samples of the non-adjacent neighboring block; and obtaining, from a reference list L1, a plurality of second prediction samples of the non-adjacent neighboring block.

In some examples, obtaining the filter based on the plurality of prediction samples and the plurality of reconstruction samples includes: obtaining the plurality of prediction samples of the non-adjacent neighboring block based on the first prediction samples and the second predictions of the plurality of the reconstruction samples; and obtaining one filter by minimizing difference between the plurality of prediction samples and the plurality of reconstruction samples of the non-adjacent neighboring block, wherein obtaining the current prediction block based on a motion vector of the current inter coding block includes: obtaining, from a reference list L0, a first current prediction block based on a motion vector of the current inter coding block; obtaining, from a reference list L1, a second current prediction block based on a motion vector of the current inter coding block; and obtaining the current prediction block based on the first current prediction block and the second current prediction block, wherein obtaining the filtered prediction block based on the filter and the current prediction block includes: obtaining the filtered prediction block by applying the one filter to the current prediction block.

In some examples, obtaining the filter based on the plurality of prediction samples and the plurality of reconstruction samples includes: obtaining a first filter by minimizing difference between the plurality of first prediction samples and the plurality of reconstruction samples; obtaining a second filter by minimizing difference between the plurality of second prediction samples and the plurality of reconstruction samples; wherein obtaining the filtered prediction block based on the filter and the current prediction block includes: obtaining, respectively from reference lists L1 and list L0, a first current prediction block and a second current prediction block based on motion vectors of the current inter coding block; and obtaining a first filtered prediction block by applying the first filter to the first current prediction block; obtaining a second filtered prediction block by applying the second filter to the second current prediction block; and obtaining the filtered prediction block based on the first filtered prediction block and the second filtered prediction block.

In some examples, obtaining the filter based on the plurality of prediction samples and the plurality of reconstruction samples: calculating a plurality of target reconstruction samples based on the plurality of reconstruction samples, and a previously filtered prediction of the plurality of reconstruction samples; obtaining coefficients for a current filter by minimizing differences between a current prediction of the plurality of reconstruction samples and the plurality of target reconstruction samples; and calculating a filtered prediction of the plurality of reconstruction samples by applying the current filter to the current prediction.

In some examples, the method further include: in response to receiving a first index signaled by an encoder, determining, by the decoder, the non-adjacent neighboring block in a candidate list according to the first index.

In some examples, the candidate list is reordered based on calculating distortions of a plurality of neighboring reconstruction samples of the current inter coding block by using motion information and a filter associated with each non-adjacent neighboring block candidate.

In some examples, the candidate list is generated by incorporating non-adjacent neighboring block candidates associated with corresponding adaptive filter coefficients into an existing merge candidate list.

In some examples, the existing merge candidate list includes a candidate list of spatial Motion Vector Prediction (MVP), Temporal Motion Vector Prediction (TMVP), non-adjacent MVPs, History based Motion Vector Prediction (HMVP), pairwise merge candidates, or zero candidates.

In some examples, the method further include: in response to receiving a second index signaled by the encoder, determining, by the decoder, using the candidate list to determine the non-adjacent neighboring block in the candidate list.

In some examples, a non-adjacent neighboring block candidate coded with a sub-block-based temporal motion vector prediction (SbTMVP) mode or a geometric partitioning mode (GPM) mode is excluded from the candidate list.

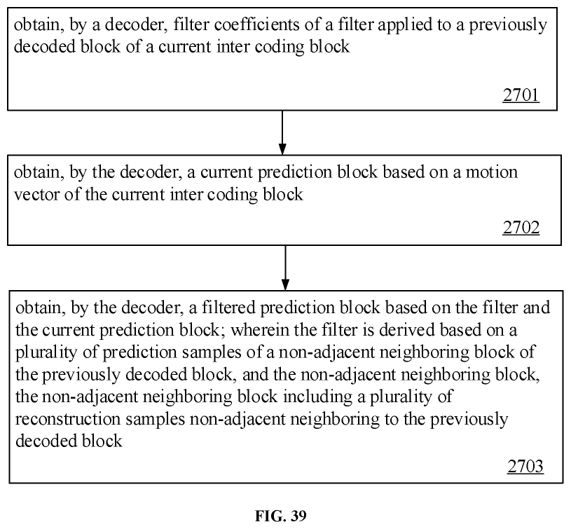

FIG. 39 is a flowchart illustrating a method for video decoding according to an example of the present disclosure. The method may be implemented by a decoder for decoding an inter coding block. In Step 2701, the method includes obtaining, by a decoder, filter coefficients of a filter applied to a previously decoded block of a current inter coding block. Filter coefficients of the previously decoded block are used for performing adaptive filtering for the current inter coding block. In Step 2702, the method includes obtaining, by the decoder, a current prediction block based on a motion vector of the current inter coding block. In Step 2703, the method includes obtaining, by the decoder, a filtered prediction block based on the filter and the current prediction block; wherein the filter is derived based on a plurality of prediction samples of a non-adjacent neighboring block of the previously decoded block, and the non-adjacent neighboring block, the non-adjacent neighboring block including a plurality of reconstruction samples non-adjacent neighboring to the previously decoded block. The filter to be applied to the current prediction block is the one derived when applying adaptive filtering for the previous decoded block, so that there is no need to derive the filter coefficients after the reconstruction for the current inter coding block.

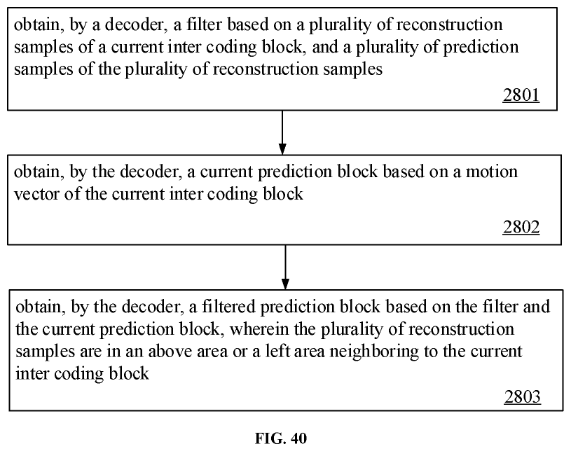

FIG. 40 is a flowchart illustrating a method for video decoding according to an example of the present disclosure. The method may be implemented by a decoder for decoding an inter coding block. In Step 2801, the method includes obtaining, by a decoder, a filter based on a plurality of reconstruction samples of a current inter coding block, and a plurality of prediction samples of the plurality of reconstruction samples. In Step 2802, the method includes obtaining, by the decoder, a current prediction block based on a motion vector of the current inter coding block. In Step 2803, the method includes obtaining, by the decoder, a filtered prediction block based on the filter and the current prediction block, wherein the plurality of reconstruction samples are in an above area or a left area neighboring to the current inter coding block. Due to the varying correlation between the current inter coding block and its top/left neighbors, two additional adaptive filtering modes are proposed: in the first mode (which is called as top-only filtering mode), only the neighboring samples that are above the current inter coding block (i.e., the top template) are used to derive the filter coefficients; in the second mode (which is called as left-only filtering mode), only the neighboring samples that are left to the current inter coding block (i.e., the left template) are used to derive the filter coefficients of the current block.

In some examples, the method further includes in response to receiving a first flag that indicates whether the plurality of reconstruction samples are in the above area or the left area of the current inter coding block, determining, by the decoder, the plurality of reconstruction samples according to the first flag.

In some examples, the method further includes: before receiving the first flag, receiving, by the decoder, a second flag indicating that the plurality of reconstruction samples are in one of the above area or the left area of the current inter coding block.

In some examples, the current inter coding block is to be decoded according to an Advanced Motion Vector Prediction (AMVP) mode.

In some examples, obtaining, by the decoder, a current prediction block based on a motion vector of the current inter coding block includes: obtaining, from a reference list L0 or L1, a current prediction block based on the motion vector of the current inter coding block.

In some examples, filter coefficients of the filter include: a scaling factor and an offset.

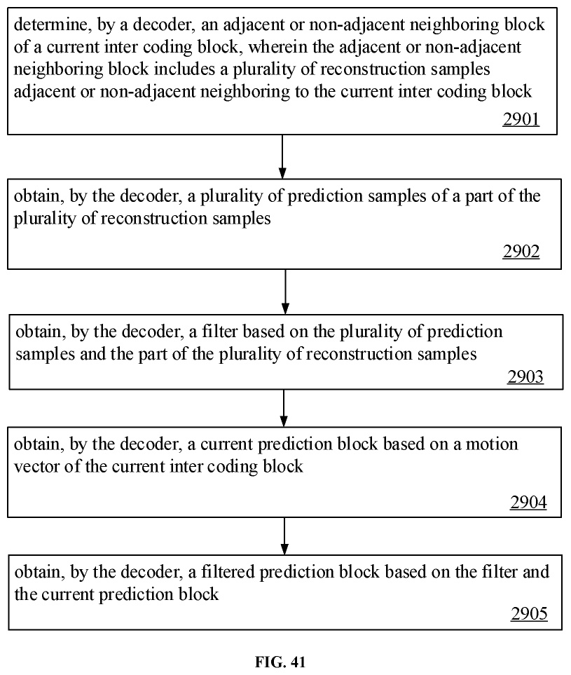

FIG. 41 is a flowchart illustrating a method for video decoding according to an example of the present disclosure. The method may be implemented by a decoder for decoding an inter coding block. In Step 2901, the method includes determining, by a decoder, an adjacent or non-adjacent neighboring block of a current inter coding block, wherein the adjacent or non-adjacent neighboring block includes a plurality of reconstruction samples adjacent or non-adjacent neighboring to the current inter coding block. In Step 2902, the method includes obtaining, by the decoder, a plurality of prediction samples of a part of the plurality of reconstruction samples. In some embodiments, to achieve various performance/complexity tradeoff, different methods may be applied to select the part of the plurality of reconstruction samples for deriving the adaptive filter. In Step 2903, the method includes obtaining, by the decoder, a filter based on the plurality of prediction samples and the part of the plurality of reconstruction samples. For example, as shown in FIG. 24 A-C, different sub-sampling schemes may be applied to choose the corresponding sample positions of the part of the plurality of reconstruction samples for deriving the adaptive filter. In Step 2904, the method includes obtaining, by the decoder, a current prediction block based on a motion vector of the current inter coding block. In Step 2905, the method includes obtaining, by the decoder, a filtered prediction block based on the filter and the current prediction block.

In some examples, the part of the plurality of reconstruction samples includes: reconstruction samples in a bottom boundary of the adjacent or non-adjacent neighboring block; reconstruction samples in a right boundary of the adjacent or non-adjacent neighboring block; or reconstruction samples at sample positions selected based on a sub-sampling scheme in the adjacent or non-adjacent neighboring block.

In some examples, the sample positions selected based on a sub-sampling scheme includes: every N-th sample in a horizontal direction, and every M-th sample in a vertical direction, wherein N and M are integers≥2.

In some examples, the method further includes: receiving, by the decoder, a first syntax element indicating whether a part of the plurality of reconstruction samples are used for deriving the filter; or receiving, by the decoder, a second syntax element indicating sample positions of the part of the plurality of reconstruction samples.

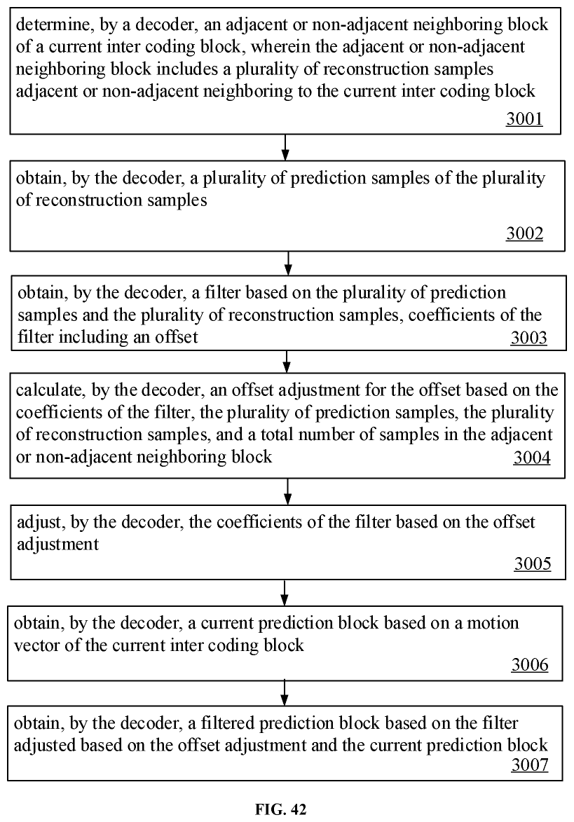

FIG. 42 is a flowchart illustrating a method for video decoding according to an example of the present disclosure. The method may be implemented by a decoder for decoding an inter coding block. In Step 3001, the method includes determining, by a decoder, an adjacent or non-adjacent neighboring block of a current inter coding block, wherein the adjacent or non-adjacent neighboring block includes a plurality of reconstruction samples adjacent or non-adjacent neighboring to the current inter coding block. In Step 3002, the method includes obtaining, by the decoder, a plurality of prediction samples of the plurality of reconstruction samples. In Step 3003, the method includes obtaining, by the decoder, a filter based on the plurality of prediction samples and the plurality of reconstruction samples, coefficients of the filter including an offset. Due to the fact that the correlation between the prediction and reconstruction samples of the neighboring CU may be far different from that of the current CU, an adaptive offset adjustment scheme may be further used to modify the coefficients of the filter. In Step 3004, the method includes calculating, by the decoder, an offset adjustment for the offset based on the coefficients of the filter, the plurality of prediction samples, the plurality of reconstruction samples, and a total number of samples in the adjacent or non-adjacent neighboring block. In Step 3005, the method includes adjusting, by the decoder, the coefficients of the filter based on the offset adjustment. In Step 3006, the method includes obtaining, by the decoder, a current prediction block based on a motion vector of the current inter coding block. In Step 3007, the method includes obtaining, by the decoder, a filtered prediction block based on the filter adjusted based on the offset adjustment and the current prediction block.

In some examples, the method further includes receiving, by the decoder, a flag indicating that the offset of the filter needs to be adjusted.

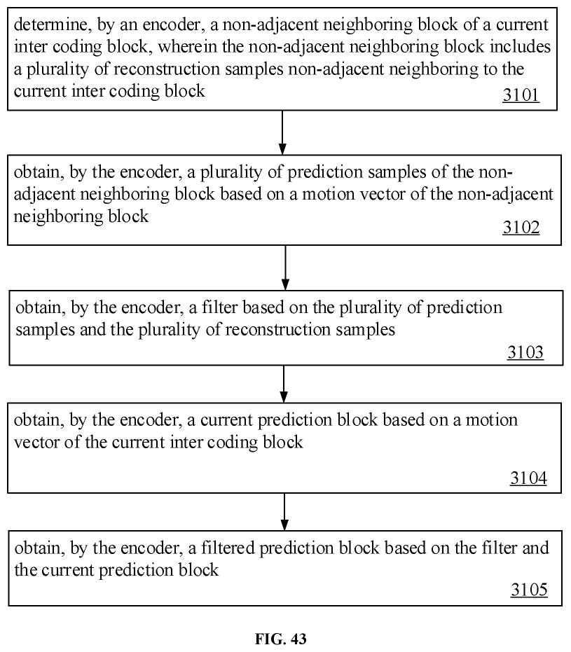

FIG. 43 is a flowchart illustrating a method for video encoding according to an example of the present disclosure. The method may be implemented by an encoder for encoding an inter coding block. In Step 3101, the method includes determining, by an encoder, a non-adjacent neighboring block of a current inter coding block, wherein the non-adjacent neighboring block includes a plurality of reconstruction samples non-adjacent neighboring to the current inter coding block. Due to the existence of coding noises, the current inter coding block may be more correlated with the samples in the reconstructed regions that are not adjacent to the current block. Based on such consideration, the adaptive motion compensated filtering scheme may be performed based on reconstruction samples non-adjacent neighboring to the current inter coding block. In some embodiments, non-adjacent neighboring blocks may be scanned from a left area and an above area of the current inter coding block. In Step 3102, the method includes obtaining, by the encoder, a plurality of prediction samples of the non-adjacent neighboring block based on a motion vector of the non-adjacent neighboring block. In Step 3103, the method includes obtaining, by the encoder, a filter based on the plurality of prediction samples and the plurality of reconstruction samples. In some embodiments, the non-adjacent neighboring block is uni-predicted (i.e., being predicted from one reference list L0/L1), its filter coefficients are directly derived based on its reconstruction samples and its uni-prediction samples. In some other embodiments, the non-adjacent neighboring block is bi-predicted (i.e., being predicted from both reference lists L0 and L1), then the final bi-prediction samples are firstly generated based on the weighted average of the L0 and L1 prediction samples. In Step 3104, obtaining, by the encoder, a current prediction block based on a motion vector of the current inter coding block. In Step 3105, obtaining, by the encoder, a filtered prediction block based on the filter and the current prediction block. The current prediction block of the current inter coding block is modified based on filter coefficients of the filter derived based on the plurality of prediction samples and the plurality of reconstruction samples.

In some examples, obtaining the plurality of prediction samples of the non-adjacent neighboring block based on the motion vector of the non-adjacent neighboring block includes: obtaining, from a reference list L0 or L1, the plurality of prediction samples of the non-adjacent neighboring block.

In some examples, obtaining the plurality of prediction samples of the non-adjacent neighboring block based on the motion vector of the non-adjacent neighboring block includes: obtaining, from a reference list L0, a plurality of first prediction samples of the non-adjacent neighboring block; and obtaining, from a reference list L1, a plurality of second prediction samples of the non-adjacent neighboring block.

In some examples, obtaining the filter based on the plurality of prediction samples and the plurality of reconstruction samples includes: obtaining the plurality of prediction samples of the non-adjacent neighboring block based on the first prediction samples and the second predictions of the plurality of the reconstruction samples; and obtaining one filter by minimizing difference between the plurality of prediction samples and the plurality of reconstruction samples of the non-adjacent neighboring block, wherein obtaining the current prediction block based on a motion vector of the current inter coding block includes: obtaining, from a reference list L0, a first current prediction block based on a motion vector of the current inter coding block; obtaining, from a reference list L1, a second current prediction block based on a motion vector of the current inter coding block; and obtaining the current prediction block based on the first current prediction block and the second current prediction block, wherein obtaining the filtered prediction block based on the filter and the current prediction block includes: obtaining the filtered prediction block by applying the one filter to the current prediction block.

In some examples, obtaining the filter based on the plurality of prediction samples and the plurality of reconstruction samples includes: obtaining a first filter by minimizing difference between the plurality of first prediction samples and the plurality of reconstruction samples; obtaining a second filter by minimizing difference between the plurality of second prediction samples and the plurality of reconstruction samples; wherein obtaining the filtered prediction block based on the filter and the current prediction block includes: obtaining, respectively from reference lists L1 and list L0, a first current prediction block and a second current prediction block based on motion vectors of the current inter coding block; and obtaining a first filtered prediction block by applying the first filter to the first current prediction block; obtaining a second filtered prediction block by applying the second filter to the second current prediction block; and obtaining the filtered prediction block based on the first filtered prediction block and the second filtered prediction block.

In some examples, obtaining the filter based on the plurality of prediction samples and the plurality of reconstruction samples: calculating a plurality of target reconstruction samples based on the plurality of reconstruction samples, and a previously filtered prediction of the plurality of reconstruction samples; obtaining coefficients for a current filter by minimizing differences between a current prediction of the plurality of reconstruction samples and the plurality of target reconstruction samples; and calculating a filtered prediction of the plurality of reconstruction samples by applying the current filter to the current prediction.

In some examples, the method further include: signaling, by the encoder, a first index to indicate a decoder to determine the non-adjacent neighboring block in a candidate list according to the first index.

In some examples, the candidate list is reordered based on calculating distortions of a plurality of neighboring reconstruction samples of the current inter coding block by using motion information and a filter associated with each non-adjacent neighboring block candidate.

In some examples, the candidate list is generated by incorporating non-adjacent neighboring block candidates associated with corresponding adaptive filter coefficients into an existing merge candidate list.

In some examples, the existing merge candidate list includes a candidate list of spatial Motion Vector Prediction (MVP), Temporal Motion Vector Prediction (TMVP), non-adjacent MVPs, History based Motion Vector Prediction (HMVP), pairwise merge candidates, or zero candidates.

In some examples, the method further include: signaling, by the encoder, a second index to indicate a decoder to use the candidate list to determine the non-adjacent neighboring block in the candidate list.

In some examples, a non-adjacent neighboring block candidate coded with a sub-block-based temporal motion vector prediction (SbTMVP) mode or a geometric partitioning mode (GPM) mode is excluded from the candidate list.

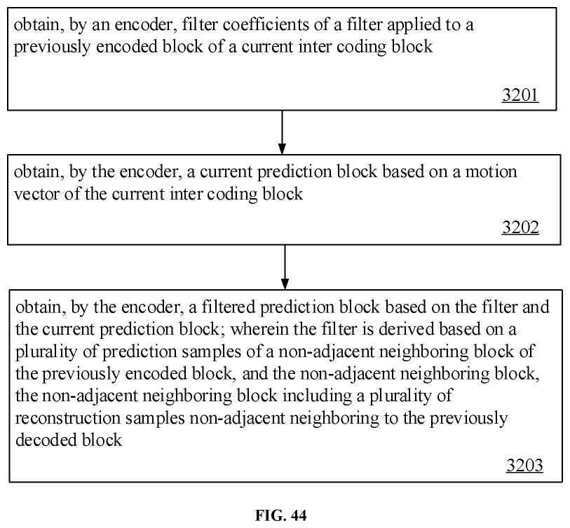

FIG. 44 is a flowchart illustrating a method for video encoding according to an example of the present disclosure. The method may be implemented by an encoder for encoding an inter coding block. In Step 3201, the method includes obtaining, by an encoder, filter coefficients of a filter applied to a previously encoded block of a current inter coding block. Filter coefficients of the previously decoded block are used for performing adaptive filtering for the current inter coding block. In Step 3202, the method includes obtaining, by the encoder, a current prediction block based on a motion vector of the current inter coding block. In Step 3203, the method includes obtaining, by the encoder, a filtered prediction block based on the filter and the current prediction block; wherein the filter is derived based on a plurality of prediction samples of a non-adjacent neighboring block of the previously encoded block, and the non-adjacent neighboring block, the non-adjacent neighboring block including a plurality of reconstruction samples non-adjacent neighboring to the previously encoded block. The filter to be applied to the current prediction block is the one derived when applying adaptive filtering for the previous decoded block, so that there is no need to derive the filter coefficients after the reconstruction for the current inter coding block.

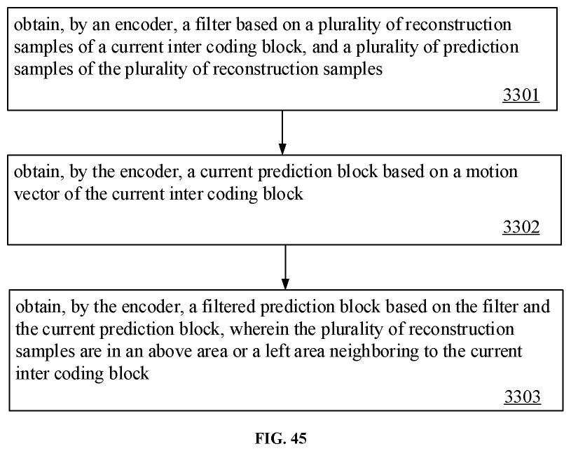

FIG. 45 is a flowchart illustrating a method for video encoding according to an example of the present disclosure. The method may be implemented by an encoder for encoding an inter coding block. In Step 3301, the method includes obtaining, by the encoder, a filter based on a plurality of reconstruction samples of a current inter coding block, and a plurality of prediction samples of the plurality of reconstruction samples. In Step 3302, the method includes obtaining, by the encoder, a current prediction block based on a motion vector of the current inter coding block. In Step 3303, the method includes obtaining, by the encoder, a filtered prediction block based on the filter and the current prediction block, wherein the plurality of reconstruction samples are in an above area or a left area neighboring to the current inter coding block. Due to the varying correlation between the current inter coding block and its top/left neighbors, two additional adaptive filtering modes are proposed: in the first mode (which is called as top-only filtering mode), only the neighboring samples that are above the current inter coding block (i.e., the top template) are used to derive the filter coefficients; in the second mode (which is called as left-only filtering mode), only the neighboring samples that are left to the current inter coding block (i.e., the left template) are used to derive the filter coefficients of the current block.

In some examples, the method further includes signaling, by the encoder, a first flag to indicate whether the plurality of reconstruction samples are in the above area or the left area of the current inter coding block.

In some examples, the method further includes: signaling, by the encoder, a second flag indicating that the plurality of reconstruction samples are in one of the above area or the left area of the current inter coding block.

In some examples, the current inter coding block is to be encoded according to an Advanced Motion Vector Prediction (AMVP) mode.

In some examples, obtaining, by the encoder, a current prediction block based on a motion vector of the current inter coding block includes: obtaining, from a reference list L0 or L1, a current prediction block based on the motion vector of the current inter coding block.

In some examples, filter coefficients of the filter include: a scaling factor and an offset.

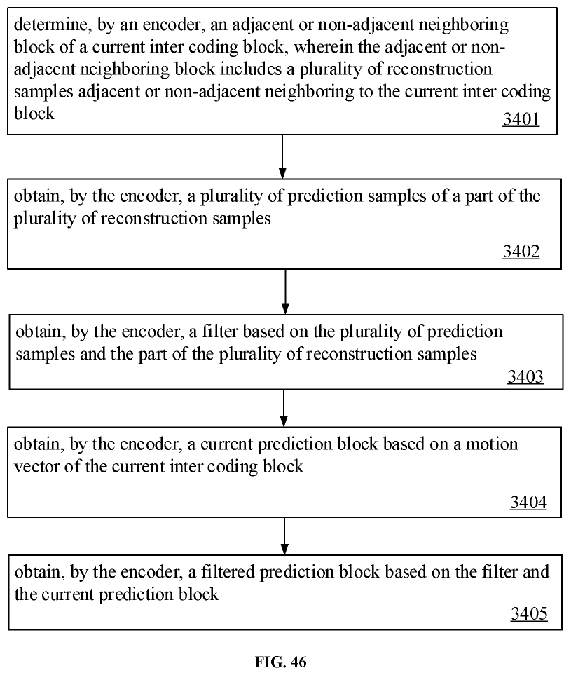

FIG. 46 is a flowchart illustrating a method for video encoding according to an example of the present disclosure. The method may be implemented by an encoder for encoding an inter coding block. In Step 3401, the method includes determining, by an encoder, an adjacent or non-adjacent neighboring block of a current inter coding block, wherein the adjacent or non-adjacent neighboring block includes a plurality of reconstruction samples adjacent or non-adjacent neighboring to the current inter coding block. In Step 3402, the method includes obtaining, by the encoder, a plurality of prediction samples of a part of the plurality of reconstruction samples. In some embodiments, to achieve various performance/complexity tradeoff, different methods may be applied to select the part of the plurality of reconstruction samples for deriving the adaptive filter. In Step 3403, the method includes obtaining, by the encoder, a filter based on the plurality of prediction samples and the part of the plurality of reconstruction samples. For example, as shown in FIG. 24 A-C, different sub-sampling schemes may be applied to choose the corresponding sample positions of the part of the plurality of reconstruction samples for deriving the adaptive filter. In Step 3404, the method includes obtaining, by the encoder, a current prediction block based on a motion vector of the current inter coding block. In Step 3405, the method includes obtaining, by the encoder, a filtered prediction block based on the filter and the current prediction block.

In some examples, the part of the plurality of reconstruction samples includes: reconstruction samples in a bottom boundary of the adjacent or non-adjacent neighboring block; reconstruction samples in a right boundary of the adjacent or non-adjacent neighboring block; or reconstruction samples at sample positions selected based on a sub-sampling scheme in the adjacent or non-adjacent neighboring block.

In some examples, the sample positions selected based on a sub-sampling scheme includes: every N-th sample in a horizontal direction, and every M-th sample in a vertical direction, wherein N and M are integers≥2.

In some examples, the method further includes: signaling, by the encoder, a first syntax element indicating whether a part of the plurality of reconstruction samples are used for deriving the filter; or signaling, by the encoder, a second syntax element indicating sample positions of the part of the plurality of reconstruction samples.

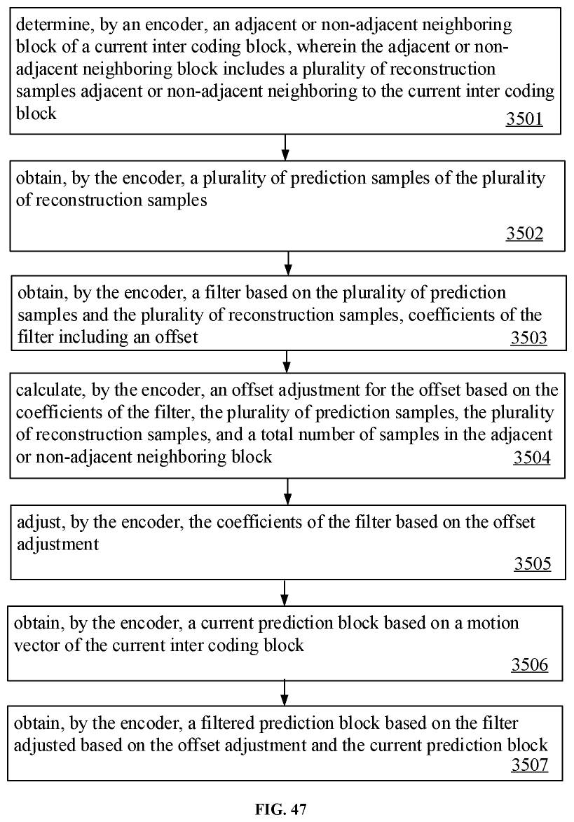

FIG. 47 is a flowchart illustrating a method for video encoding according to an example of the present disclosure. The method may be implemented by an encoder for encoding an inter coding block. In Step 3501, the method includes determining, by an encoder, an adjacent or non-adjacent neighboring block of a current inter coding block, wherein the adjacent or non-adjacent neighboring block includes a plurality of reconstruction samples adjacent or non-adjacent neighboring to the current inter coding block. In Step 3502, the method includes obtaining, by the encoder, a plurality of prediction samples of the plurality of reconstruction samples. In Step 3503, the method includes obtaining, by the encoder, a filter based on the plurality of prediction samples and the plurality of reconstruction samples, coefficients of the filter including an offset. Due to the fact that the correlation between the prediction and reconstruction samples of the neighboring CU may be far different from that of the current CU, an adaptive offset adjustment scheme may be further used to modify the coefficients of the filter. In Step 3504, the method includes calculating, by the encoder, an offset adjustment for the offset based on the coefficients of the filter, the plurality of prediction samples, the plurality of reconstruction samples, and a total number of samples in the adjacent or non-adjacent neighboring block. In Step 3505, the method includes adjusting, by the encoder, the coefficients of the filter based on the offset adjustment. In Step 3506, the method includes obtaining, by the encoder, a current prediction block based on a motion vector of the current inter coding block. In Step 3507, the method includes obtaining, by the encoder, a filtered prediction block based on the filter adjusted based on the offset adjustment and the current prediction block.

In some examples, the method further includes signaling, by the encoder, a flag indicating that the offset of the filter needs to be adjusted.

In some examples, there is provided an apparatus for video coding. The apparatus includes a processor 2520 and a memory 2540 configured to store instructions executable by the processor; where the processor, upon execution of the instructions, is configured to perform any method as illustrated in FIGS. 38-47.

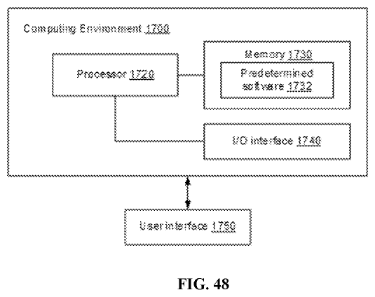

FIG. 48 shows a computing environment 1700 coupled with a user interface 1750. The computing environment 1700 can be part of a data processing server. The computing environment 1700 includes a processor 1720, a memory 1730, and an Input/Output (I/O) interface 1740.

The processor 1720 typically controls overall operations of the computing environment 1700, such as the operations associated with display, data acquisition, data communications, and image processing. The processor 1720 may include one or more processors to execute instructions to perform all or some of the steps in the above-described methods. Moreover, the processor 1720 may include one or more modules that facilitate the interaction between the processor 1720 and other components. The processor may be a Central Processing Unit (CPU), a microprocessor, a single chip machine, a Graphical Processing Unit (GPU), or the like.

The memory 1730 is configured to store various types of data to support the operation of the computing environment 1700. The memory 1730 may include predetermined software 1732. Examples of such data includes instructions for any applications or methods operated on the computing environment 1700, video datasets, image data, etc. The memory 1730 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1740 provides an interface between the processor 1720 and peripheral interface modules, such as a keyboard, a click wheel, buttons, and the like. The buttons may include but are not limited to, a home button, a start scan button, and a stop scan button. The I/O interface 1740 can be coupled with an encoder or decoder. In an embodiment, there is also provided a non-transitory computer-readable storage medium comprising a plurality of programs, for example, in the memory 1730, executable by the processor 1720 in the computing environment 1700, for performing the above-described methods and/or storing a bitstream generated by the encoding method described above or a bitstream to be decoded by the decoding method described above. In one example, the plurality of programs may be executed by the processor 1720 in the computing environment 1700 to receive (for example, from the video encoder 20 in FIG. 2) a bitstream or data stream including encoded video information (for example, video blocks representing encoded video frames, and/or associated one or more syntax elements, etc.), and may also be executed by the processor 1720 in the computing environment 1700 to perform the decoding method described above according to the received bitstream or data stream. In another example, the plurality of programs may be executed by the processor 1720 in the computing environment 1700 to perform the encoding method described above to encode video information (for example, video blocks representing video frames, and/or associated one or more syntax elements, etc.) into a bitstream or data stream, and may also be executed by the processor 1720 in the computing environment 1700 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

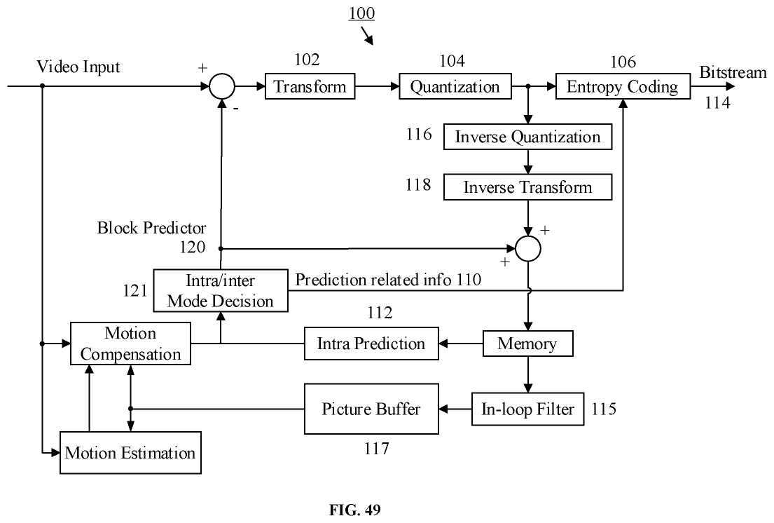

Like HEVC, VVC is built upon the block-based hybrid video coding framework. FIG. 49 is a block diagram illustrating a block-based video encoder in accordance with some implementations of the present disclosure. In the encoder 100, the input video signal is processed block by block, called coding units (CUs). The encoder 100 may be the video encoder 20 as shown in FIG. 1A. In VTM-1.0, a CU can be up to 128×128 pixels. However, different from the HEVC which partitions blocks only based on quad-trees, in VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure.

For each given video block, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes.

After spatial and/or temporal prediction, an intra/inter mode decision circuitry 121 in the encoder 100 chooses the best prediction mode, for example based on the rate-distortion optimization method. The block predictor 120 is then subtracted from the current video block; and the resulting prediction residual is de-correlated using the transform circuitry 102 and the quantization circuitry 104. The resulting quantized residual coefficients are inverse quantized by the inverse quantization circuitry 116 and inverse transformed by the inverse transform circuitry 118 to form the reconstructed residual, which is then added back to the prediction block to form the reconstructed signal of the CU. Further, in-loop filtering 115, such as a deblocking filter, a sample adaptive offset (SAO), and/or an adaptive in-loop filter (ALF) may be applied on the reconstructed CU before it is put in the reference picture store of the picture buffer 117 and used to code future video blocks. To form the output video bitstream 114, coding mode (inter or intra), prediction mode information, motion information, and quantized residual coefficients are all sent to the entropy coding unit 106 to be further compressed and packed to form the bit-stream.

For example, a deblocking filter is available in AVC, HEVC as well as the now-current version of VVC. In HEVC, an additional in-loop filter called SAO is defined to further improve coding efficiency. In the now-current version of the VVC standard, yet another in-loop filter called ALF is being actively investigated, and it has a good chance of being included in the final standard.

These in-loop filter operations are optional. Performing these operations helps to improve coding efficiency and visual quality. They may also be turned off as a decision rendered by the encoder 100 to save computational complexity.

It should be noted that intra prediction is usually based on unfiltered reconstructed pixels, while inter prediction is based on filtered reconstructed pixels if these filter options are turned on by the encoder 100.

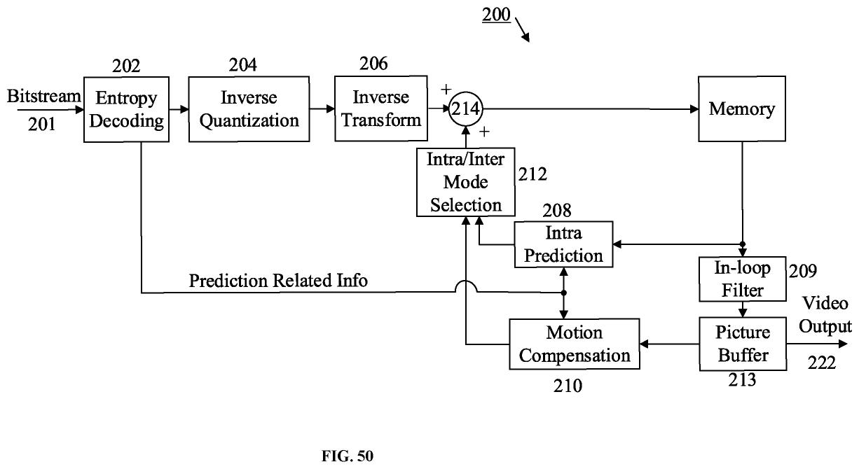

FIG. 50 is a block diagram illustrating a block-based video decoder 200 which may be used in conjunction with many video coding standards. This decoder 200 is similar to the reconstruction-related section residing in the encoder 100 of FIG. 49. The block-based video decoder 200 may be the video decoder 30 as shown in FIG. 1A. In the decoder 200, an incoming video bitstream 201 is first decoded through an Entropy Decoding 202 to derive quantized coefficient levels and prediction-related information. The quantized coefficient levels are then processed through an Inverse Quantization 204 and an Inverse Transform 206 to obtain a reconstructed prediction residual. A block predictor mechanism, implemented in an Intra/inter Mode Selector 212, is configured to perform either an Intra Prediction 208, or a Motion Compensation 210, based on decoded prediction information. A set of unfiltered reconstructed pixels are obtained by summing up the reconstructed prediction residual from the Inverse Transform 206 and a predictive output generated by the block predictor mechanism, using a summer 214.

The reconstructed block may further go through an In-Loop Filter 209 before it is stored in a Picture Buffer 213 which functions as a reference picture store. The reconstructed video in the Picture Buffer 213 may be sent to drive a display device, as well as used to predict future video blocks. In situations where the In-Loop Filter 209 is turned on, a filtering operation is performed on these reconstructed pixels to derive a final reconstructed Video Output 222.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 1720); and the non-transitory computer-readable storage medium or the memory 1730 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 1730, executable by the processor 1720 in the computing environment 1700, for performing the above-described methods. For example, the computer program product may include the non-transitory computer-readable storage medium.

In an embodiment, the computing environment 1700 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for video decoding, comprising:
applying, by a decoder, a template-based coding scheme to derive one or more coding parameters associated with a video block of a video frame based on a template of the video block;
obtaining, by the decoder, reference-picture-resampling (RPR) prediction samples for the video block based on the one or more coding parameters; and
filtering, by the decoder, the RPR prediction samples using a filter to generate filtered RPR prediction samples for the video block, wherein the filter is adaptively determined based on the template of the video block.

2. The method of claim 1, further comprising:
enabling the template-based coding scheme in the video decoding responsive to determining that an enabling condition is satisfied.

3. The method of claim 2, wherein:
determining that the enabling condition is satisfied comprises:
determining a ratio between a total number of RPR reference pictures in one or more reference lists and a total number of the RPR reference pictures and non-RPR reference pictures in the one or more reference lists; and
determining that the ratio is greater than a predetermined threshold; or
determining that the enabling condition is satisfied comprises:
determining that a temporal layer of the video frame is higher than a predetermined temporal layer.

4. The method of claim 2, wherein a Geometry Partition Mode (GPM) is applied in the video decoding,
wherein the one or more coding parameters comprise a split mode used in the GPM, and
wherein applying the template-based coding scheme to derive the one or more coding parameters comprises applying, based on the template of the video block, a template-based GPM split mode reordering scheme to determine the split mode from a reordered split mode candidate list.

5. The method of claim 4, wherein applying, based on the template of the video block, the template-based GPM split mode reordering scheme to determine the split mode from the reordered split mode candidate list comprises:
determining, based on the template of the video block, template costs associated with split mode candidates, respectively;
sorting the split mode candidates based on the template costs to generate the reordered split mode candidate list; and
selecting a split mode candidate from the reordered split mode candidate list as the split mode based on a split mode index signaled by an encoder.

6. The method of claim 4, wherein obtaining the RPR prediction samples for the video block based on the one or more coding parameters comprises:
dividing the video block into partitions based on the split mode; and
for each partition of the partitions, determining RPR prediction samples for the partition based on a motion vector associated with the partition and a reference index associated with the partition.

7. The method of claim 6, wherein determining that the enabling condition is satisfied comprises:
determining that resolutions of reference frames associated with the partitions are identical to a resolution of the video frame; or
determining that at least a resolution of a reference frame associated with one of the partitions is different from a resolution of the video frame.

8. The method of claim 2, wherein:
the one or more coding parameters comprise one or more motion vector differences (MVDs) corresponding to one or more motion vectors, respectively, and applying the template-based coding scheme to derive the one or more coding parameters comprises applying, based on the template of the video block, a template-based MVD prediction scheme to determine the one or more MVDs corresponding to one or more MVD indices signaled by a video encoder;
or the one or more coding parameters comprise one or more reference frames corresponding to the one or more motion vectors, respectively, and applying the template-based coding scheme to derive the one or more coding parameters comprises applying, based on the template of the video block, a template-based reference index prediction scheme to determine the one or more reference frames corresponding to one or more reference indices signaled by the video encoder.

9. The method of claim 8, wherein:
applying, based on the template of the video block, the template-based MVD prediction scheme to determine the one or more MVDs corresponding to the one or more MVD indices signaled by the video encoder comprises:
grouping a plurality of reference pictures of the video block based on their respective resolutions to form one or more groups, such that each group includes reference pictures from the plurality of reference pictures with a same resolution;
determining, based on the template of the video block, first template costs associated with MVD candidates in each group respectively;
sorting the MVD candidates in each group based on the first template costs to generate a corresponding first reordered group, so that one or more first reordered groups are generated for the one or more groups respectively;
combining the MVD candidates of the one or more first reordered groups into a first joint group based on a first criterion; and
selecting an MVD candidate from the first joint group as an MVD based on an MVD index signaled by the video encoder; or
applying, based on the template of the video block, the template-based reference index prediction scheme to determine the one or more reference frames corresponding to the one or more reference indices signaled by the video encoder comprises:
grouping the plurality of reference pictures of the video block based on their respective resolutions to form the one or more groups, such that each group includes reference pictures from the plurality of reference pictures with the same resolution;
determining, based on the template of the video block, second template costs associated with reference picture candidates in each group respectively;
sorting the reference picture candidates in each group based on the second template costs to generate a corresponding second reordered group, so that one or more second reordered groups are generated for the one or more groups respectively;
combining the reference picture candidates of the one or more second reordered groups into a second joint group based on a second criterion; and
selecting a reference picture candidate from the second joint group as a reference frame based on a reference index signaled by the video encoder.

10. The method of claim 9, wherein:
combining the MVD candidates of the one or more first reordered groups into the first joint group based on the first criterion comprises:
placing a first one of the one or more first reordered groups in front of a second one of the one or more first reordered groups in the first joint group, when a resolution of reference pictures in the first one of the one or more first reordered groups is closer to a resolution of the video frame than a resolution of reference pictures in the second one of the one or more first reordered groups; or
combining the reference picture candidates of the one or more second reordered groups into the second joint group based on the second criterion comprises:
placing a first one of the one or more second reordered groups in front of a second one of the one or more second reordered groups in the second joint group, when the resolution of reference pictures in the first one of the one or more second reordered groups is closer to the resolution of the video frame than the resolution of reference pictures in the second one of the one or more second reordered groups.

11. The method of claim 2, wherein:
the one or more coding parameters comprise one or more motion vectors for the video block, and applying the template-based coding scheme to derive the one or more coding parameters comprises applying, based on the template of the video block, a template-based merge index reordering scheme to determine the one or more motion vectors corresponding to one or more merge indices signaled by a video encoder.

12. The method of claim 11, wherein: applying, based on the template of the video block, the template-based merge index reordering scheme to determine the one or more motion vectors corresponding to the one or more merge indices signaled by the video encoder comprises:
determining, based on the template of the video block, template costs associated with merge candidates, respectively;
sorting the merge candidates based on the template costs to generate a reordered merge candidate list; and
selecting a merge candidate from the reordered merge candidate list as a motion vector based on a merge index signaled by the video encoder.

13. The method of claim 1, wherein filtering, by the decoder, the RPR prediction samples using the filter to generate the filtered RPR prediction samples for the video block comprises:
calculating filter coefficients for the filter by minimizing a difference between template samples of the video block and RPR prediction template samples of the video block; and
filtering the RPR prediction samples of the video block using the filter to generate the filtered RPR prediction samples.

14. The method of claim 13, wherein the filter coefficients comprise a scaling factor and an offset.

15. The method of claim 1, wherein a chroma format of the video block is 4:0:0, 4:2:0, 4:2:2, or 4:4:4.

16. A method for video encoding, comprising:
obtaining, by an encoder, reference-picture-resampling (RPR) prediction samples for a video block of a video frame based on one or more coding parameters;
filtering, by the encoder, the RPR prediction samples using a filter to generate filtered RPR prediction samples for the video block, wherein the filter is adaptively determined based on the template of the video block;
processing, by the encoder, the one or more coding parameters using a template-based coding scheme to generate one or more syntax elements based on the template of the video block; and
generating, by the encoder, a bitstream based on the filtered RPR prediction samples and the one or more syntax elements.

17. The method of claim 16, wherein a chroma format of the video block is 4:0:0, 4:2:0, 4:2:2, or 4:4:4.

18. An apparatus for video coding, comprising:
a memory; and
a processor coupled to the memory and configured to perform a method for video decoding or a method for video encoding,
wherein the method for video decoding comprises:
applying a template-based coding scheme to derive one or more coding parameters associated with a video block of a video frame based on a template of the video block;
obtaining reference-picture-resampling (RPR) prediction samples for the video block based on the one or more coding parameters; and
filtering the RPR prediction samples using a filter to generate filtered RPR prediction samples for the video block, wherein the filter is adaptively determined based on the template of the video block;
wherein the method for video encoding comprises:
obtaining reference-picture-resampling (RPR) prediction samples for a video block of a video frame based on one or more coding parameters;
filtering the RPR prediction samples using a filter to generate filtered RPR prediction samples for the video block, wherein the filter is adaptively determined based on the template of the video block;
processing the one or more coding parameters using a template-based coding scheme to generate one or more syntax elements based on the template of the video block; and
generating a bitstream based on the filtered RPR prediction samples and the one or more syntax elements.

19. A method for storing a bitstream, comprising:
generating the bitstream by using the method according to claim 16; and
storing the bitstream.

20. The method of claim 19, wherein a chroma format of the video block is 4:0:0, 4:2:0, 4:2:2, or 4:4:4.
